(19) United States
(12) Patent Application Publication
(10) Pub. No.: US 2025/0234347 A1
(43) Pub. Date: Jul. 17, 2025

(54) TECHNIQUES FOR HANDLING OVERLAPPING UPLINK TRANSMISSIONS ASSOCIATED WITH DIFFERENT TIMING ADVANCE GROUPS

(71) Applicant: QUALCOMM INCORPORATED, San Diego, CA (US)

(72) Inventors: Shaozhen Guo, Beijing (CN); Mostafa Khoshnevisan, San Diego, CA (US); Jing Sun, San Diego, CA (US); Xiaoxia Zhang, San Diego, CA (US)

(21) Appl. No.: 18/841,359

(22) PCT Filed: Apr. 1, 2022
(86) PCT No.: PCT/CN2022/084786

§ 371 Date: Aug. 23, 2024

(51) Int. Cl. H04W 72/1268; H04W 72/0446

(52) U.S. Cl. CPC H04W 72/1268; H04W 72/0446

(57) ABSTRACT

Methods, systems, and devices for wireless communications are described. In some aspects, a user equipment (UE) may receive first control signaling from a first transmission and reception point (TRP) scheduling a first uplink transmission from the UE to the first TRP and may receive second control signaling from a second TRP scheduling a second uplink transmission from the UE to the second TRP. The first TRP and the second TRP may be associated with different timing advance groups (TAGs) and the UE and the multiple TRPs may employ a transmission rule-based procedure according to which the UE and the multiple TRPs are able to resolve any potential overlapping between uplink transmissions associated with the first TAG and uplink transmissions associated with the second TAG based on one or both of logical time and actual time.

### CROSS REFERENCE

The present application is a 371 national stage filing of International PCT Application No. PCT/CN2022/084786 by Guo et al. entitled “TECHNIQUES FOR HANDLING OVERLAPPING UPLINK TRANSMISSIONS ASSOCIATED WITH DIFFERENT TIMING ADVANCE GROUPS,” filed Apr. 1, 2022, which is assigned to the assignee hereof, and which is expressly incorporated by reference in its entirety herein.

### FIELD OF TECHNOLOGY

The following relates to wireless communications, including techniques for handling overlapping uplink transmissions associated with different timing advance groups (TAGs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE may communicate with multiple transmission and reception points (TRPs) and, in some operation modes, the UE and the multiple TRPs may lack a mechanism for resolving overlap between uplink transmissions.

### SUMMARY

The described techniques relate to improved methods, systems, devices, and apparatuses that support techniques for handling overlapping uplink transmissions associated with different timing advance groups (TAGs). For example, the described techniques provide for a transmission rule-based procedure according to which a user equipment (UE) and multiple transmission and reception points (TRPs) are able to resolve any potential overlapping between uplink transmissions associated with a first TAG and uplink transmissions associated with a second TAG based on one or both of logical time and actual time. For example, in accordance with the transmission rule-based procedure, the UE and the multiple TRPs may determine which scheduled uplink transmissions are to be performed by the UE and what level of multiplexing or dropping may occur among the scheduled uplink transmissions. The transmission rule-based procedure may include a first transmission rule and a second transmission rule and the UE may apply the first transmission rule and the second transmission rule sequentially to resolve the potential overlapping based on one or both of logical time and actual time.

### BRIEF DESCRIPTION OF THE DRAWINGS

FIGS. 1 and 2 show examples of wireless communications systems that support techniques for handling overlapping uplink transmissions associated with different timing advance groups (TAGs) in accordance with one or more aspects of the present disclosure.

FIG. 3 shows examples of scheduling diagrams that support techniques for handling overlapping uplink transmissions associated with different TAGs in accordance with one or more aspects of the present disclosure.

FIG. 4 shows examples of transmission rule-based procedures that support techniques for handling overlapping uplink transmissions associated with different TAGs in accordance with one or more aspects of the present disclosure.

FIGS. 5 through 11 show examples of transmission rule-based procedures that support techniques for handling overlapping uplink transmissions associated with different TAGs in accordance with one or more aspects of the present disclosure.

FIG. 12 shows an example of a carrier aggregation technique that supports techniques for handling overlapping uplink transmissions associated with different TAGs in accordance with one or more aspects of the present disclosure.

FIGS. 13 and 14 show block diagrams of devices that support techniques for handling overlapping uplink transmissions associated with different TAGs in accordance with one or more aspects of the present disclosure.

FIG. 15 shows a block diagram of a communications manager that supports techniques for handling overlapping uplink transmissions associated with different TAGs in accordance with one or more aspects of the present disclosure.

FIG. 16 shows a diagram of a system including a device that supports techniques for handling overlapping uplink transmissions associated with different TAGs in accordance with one or more aspects of the present disclosure.

FIGS. 17 and 18 show block diagrams of devices that support techniques for handling overlapping uplink transmissions associated with different TAGs in accordance with one or more aspects of the present disclosure.

FIG. 19 shows a block diagram of a communications manager that supports techniques for handling overlapping uplink transmissions associated with different TAGs in accordance with one or more aspects of the present disclosure.

FIG. 20 shows a diagram of a system including a device that supports techniques for handling overlapping uplink transmissions associated with different TAGs in accordance with one or more aspects of the present disclosure.

FIGS. 21 through 26 show flowcharts illustrating methods that support techniques for handling overlapping uplink transmissions associated with different TAGs in accordance with one or more aspects of the present disclosure.

### DETAILED DESCRIPTION

In some wireless communications systems, a user equipment may communicate with multiple transmission and reception points (TRPs) on a same serving cell and, in some operation modes, the UE may receive downlink control information (DCI) from each TRP that schedules communication between the UE and that TRP. For example, the UE may receive a first DCI message from a first TRP scheduling a first uplink transmission from the UE to the first TRP and may receive a second DCI message from a second TRP scheduling a second uplink transmission from the UE to the second TRP. In some deployment scenarios, the first TRP and the second TRP may be associated with different control resource set (CORESET) pool indices and associated with different timing advance groups (TAGs). For example, the first TRP may be associated with a first CORESET pool index and a first TAG and the second TRP may be associated with a second CORESET pool index and a second TAG. In such deployment scenarios, the first uplink transmission and the second uplink transmission may overlap based on one or both of logical time (e.g., scheduled time) and actual time (e.g., observed or measured time). The UE and the multiple TRPs, however, may lack a mutually understood or configured procedure according to which the UE and the multiple TRPs are able to resolve any potential overlapping between uplink transmissions associated with the first TAG and uplink transmissions associated with the second TAG based on one or both of logical time and actual time.

In some implementations of the present disclosure, the UE and the multiple TRPs may employ a transmission rule-based procedure according to which the UE and the multiple TRPs are able to resolve any potential overlapping between uplink transmissions associated with the first TAG and uplink transmissions associated with the second TAG based on one or both of logical time and actual time. For example, in accordance with the transmission rule-based procedure, the UE and the multiple TRPs may determine which scheduled uplink transmissions are to be performed by the UE and what level of multiplexing or dropping may occur among the scheduled uplink transmissions. The transmission rule-based procedure may include a first transmission rule or step and a second transmission rule or step and the UE may apply the first transmission rule and the second transmission rule sequentially to resolve the potential overlapping based on one or both of logical time and actual time.

In some implementations, the transmission rule-based procedure may include a first transmission rule associated with resolving overlapping between uplink transmissions based on logical time and a second transmission rule associated with resolving overlapping between uplink transmissions based on actual time. In some other implementations, the transmission rule-based procedure may include a multi-stage first transmission rule associated with resolving overlapping uplink transmissions based on logical time within a same TAG and resolving overlapping uplink transmissions based on logical time across different TAGs and a second transmission rule associated with resolving overlapping uplink transmissions based on actual time. In some other implementations, the transmission rule-based procedure may include a first transmission rule associated with resolving overlapping uplink transmissions based on logical time within a same TAG and a second transmission rule associated with resolving overlapping uplink transmissions based on actual time. In some other implementations, the transmission rule-based procedure may include a first transmission rule associated with resolving overlapping uplink transmissions based on actual time across different TAGs and a second transmission rule associated with resolving overlapping uplink transmissions based on logical time.

Particular implementations of the subject matter described in this disclosure can be implemented to realize one or more of the following potential advantages. For example, in accordance with implementing the rule-based procedure to resolve any overlapping between scheduled uplink transmissions based on one or both of logical time and actual time, the UE and the multiple TRPs may avoid ambiguity as to which of the scheduled uplink transmissions the UE is to actually perform and as to what level of multiplexing or dropping the UE may use. As such, the UE and the multiple TRPs may experience a greater likelihood for successful communication as a result of achieving aligned expectations regarding which uplink transmissions the UE is to perform (as the multiple TRPs may refrain from monitoring for one or more uplink transmissions that the UE determines to drop). Further, and as a result of such a greater likelihood for successful communication, the UE and the multiple TRPs may experience greater reliability and lower signaling overhead, which may support higher data rates, greater spectral efficiency, and greater system capacity, among other benefits.

Aspects of the disclosure are initially described in the context of wireless communications systems. Aspects of the disclosure are additionally illustrated by and described with reference to scheduling diagrams, transmission rule-based procedures, and carrier aggregation techniques. Aspects of the disclosure are further illustrated by and described with reference to apparatus diagrams, system diagrams, and flowcharts that relate to techniques for handling overlapping uplink transmissions associated with different TAGs.

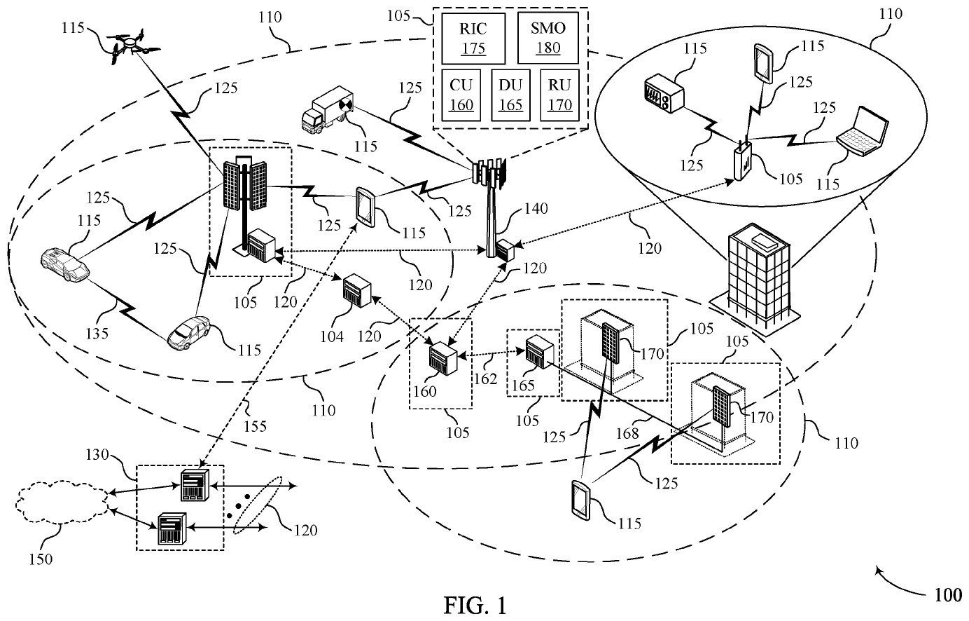

FIG. 1 shows an example of a wireless communications system 100 that supports techniques for handling overlapping uplink transmissions associated with different TAGs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for handling overlapping uplink transmissions associated with different TAGs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5 GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Devices, such as UEs 115 and network entities 105, may track, recognize, measure, or otherwise experience multiple timelines associated with different time domains. Such different time domains may include a logical time domain (e.g., a timeline based on logical time) and an actual time domain (e.g., a timeline based on actual time). A logical time domain may refer to a time domain in which communications are scheduled assuming or expecting that various timing differences are a default value (e.g., zero). For example, logical time may mean that downlink-to-downlink timing differences between component carriers, uplink-to-uplink timing differences across different TAGs, and an uplink timing advance (TA) are assumed or expected to be zero. An actual time domain may refer to a time domain that is actually observed by a UE 115 or a network entity 105. For example, actual time may mean that values observed or measured by a UE 115 are assumed or expected for downlink-to-downlink timing differences between component carriers, uplink-to-uplink timing differences across different TAGs, and an uplink TA. As such, logical time (e.g., a logical time domain) may be referred to herein as scheduled time (e.g., a scheduled time domain) and actual time (e.g., an actual time domain) may be referred to herein as observed time (e.g., an observed time domain).

In some aspects, a device may use logical time for one or both of an uplink control information (UCI) multiplexing rule and a UCI dropping rule for overlapping uplink channels. For example, for PUCCH overlapping groups, a UE procedure for reporting multiple UCI types may apply assuming a set of (e.g., all) uplink component carriers are timing aligned (e.g., assuming no downlink timing difference across downlink carriers and no TA differences across uplink carriers). Such a procedure may be applicable to a case in which a UE 115 has overlapping resources for physical uplink control channel (PUCCH) transmissions or for PUCCH and physical uplink shared channel (PUSCH) transmissions and each PUCCH transmission is over a single slot without repetition. For example, if a UE 115 is scheduled to transmit multiple overlapping PUCCHs in a slot or overlapping PUCCH(s) and PUSCH(s) in a slot, the UE 115 may be configured to multiplex different UCI types in one PUCCH, and at least one of the multiple overlapping PUCCHs or PUSCHs is in response to a DCI format detection by the UE 115, the UE 115 multiplexes a set of (e.g., all) corresponding UCI types if a set of conditions are met.

In some aspects, a device may use (e.g., assume or expect to use) actual time for a multiplexing timeline. For a multiplexing timeline, and for a UE procedure for reporting multiple UCI types, a UE 115 may expect that a first symbol S₀ among a group of overlapping PUCCHs and PUSCHs in the slot satisfies a set of timeline conditions and whether or not the first symbol S₀ among a group of overlapping PUCCHs and PUSCHs in the slot satisfies the timeline conditions accounts for one or more TAs and one or more downlink timing differences. In other words, for example, the UE 115 may expect that a first symbol S₀ of an earliest PUCCH or PUSCH, among a group of overlapping PUCCHs and PUSCHs in a slot, satisfies a set of timeline conditions. The set of timeline conditions may include S₀ not being before a symbol with a cyclic prefix starting after an upper limit time value associated with a process release after a last symbol of any corresponding semi-persistent scheduling (SPS) physical downlink shared channel (PDSCH) release. The set of timeline conditions may additionally, or alternatively, include there being no aperiodic CSI report multiplexed in a PUSCH in the group of overlapping PUCCHs and PUSCHs and S₀ not being before a symbol with a cyclic prefix starting after a time value after a last value of a physical downlink control channel (PDCCH) with the DCI format scheduling the PUSCH and any PDCCH scheduling a PDSCH or SPS PDSCH release with corresponding HARQ-ACK information in an overlapping PUCCH in the slot.

In some aspects, a device may use logical time for slot format and directional conflict resolution (e.g., if, in logical time, an uplink transmission is scheduled for a slot or symbol of a slot that is configured as a downlink slot or symbol in accordance with a slot format, a UE 115 may refrain from performing the uplink transmission). For example, for slot format (e.g., for a slot format check cross-component carrier slot format indicator (SFI)) and for a UE procedure for determining a slot format, if an SFI in a cell indicates a slot format for the same or another cell, the indication assumes the cells may be time aligned (e.g., no downlink timing differences across downlink carriers and no TA differences across uplink carriers). In some aspects, “time aligned” may be for alignment between different understandings of time domain aspects in the wireless communications system 100 across different devices (e.g., across different operators or companies supporting the wireless communications system 100).

For a set of symbols of a slot, a UE 115 may not expect to detect a DCI format 2_0 with an SFI-index field value indicating the set of symbols of the slot as uplink and to detect a DCI format 1_0, DCI format 1_1, or DCI format 0_1 indicating to the UE 115 to receive PDSCH or CSI-RS in the set of symbols of the slot. For a set of symbols of a slot, a UE 115 may not expect to detect a DCI format 2_0 with an SFI-index field value indicating the set of symbols in the slot as downlink and to detect a DCI format 0_0, DCI format 0_1, a DCI format 1_0, DCI format 1_1, DCI format 2_3, or a random access response (RAR) uplink grant indicating the UE 115 to transmit PUSCH, PUCCH, physical random access channel (PRACH), or SRS in the set of symbols of the slot.

In some aspects, a determination relating to whether a synchronization signal (SS) or physical broadcast channel (PBCH) block or CSI-RS reception includes at least one symbol from a set of symbols may account for one or more downlink timing differences and one or more TAs. For example, for comparison of SSB or radio resource management (RRM) against a dynamic uplink grant, and for unpaired spectrum operation for a UE 115 on a cell in a frequency band of FR1, and if the scheduling restrictions due to RRM measurements are not applicable, if the UE 115 detects a DCI format 0_0, DCI format 0_1, DCI format 1_0, DC format 1_1, or DC format 2_3 indicating to the UE 115 to transmit a set of symbols, the UE is not required to perform RRM measurements based on an SS or PBCH block or CSI-RS reception on a different cell in the frequency band if the SS or PBCH block or CSI-RS reception includes at least one symbol from the set of symbols.

For overlapping channels for a dropping rule, a procedure may apply assuming a set of (e.g., all) uplink component carriers are timing aligned (e.g., no TA differences across uplink carriers). For example, if a UE 115 is scheduled to transmit a PUCCH over a first number of slots (and if the first number is greater than 1) and the UE 115 is scheduled to transmit a PUSCH over a second number of slots, and the PUCCH transmission would overlap with the PUSCH transmission in one or more slots, and one or more conditions for multiplexing the UCI in the PUSCH are satisfied in the overlapping slots, the UE 115 may transmit the PUCCH and may not transmit the PUSCH in the overlapping slots. If a UE 115 is scheduled to transmit a first PUSCH that includes semi-persistent CSI reports and a second PUSCH that includes an uplink shared channel and the first PUSCH transmission overlaps in time with the second PUSCH transmission, the UE 115 may not transmit the first PUSCH and may transmit the second PUSCH. The UE 115 may expect that the first and second PUSCH transmissions satisfy the above timing conditions for PUSCH transmissions that overlap in time if at least one of the first or second PUSCH transmissions is in response to a DCI format detection by the UE 115.

In some aspects, a UE 115 may perform UCI multiplexing or prioritization before considering any limitations for UE transmission. For example, if a UE 115 determines overlapping for PUCCH or PUSCH, or both, transmissions of different priority indexes other than PUCCH transmissions with sidelink HARQ-ACK reports before considering limitations for UE transmission, including repetitions, if any, the UE 115 first resolves the overlapping for PUCCH or PUSCH, or both, transmissions of smaller priority index. Accordingly, if a transmission of a first PUCCH of larger priority index scheduled by a DCI format in a PDCCH reception would overlap in time with a repetition of a transmission of a second PUSCH or a second PUCCH of smaller priority index, the UE 115 may cancel or drop the repetition of a transmission of the second PUSCH or the second PUCCH before the first symbol that would overlap with the first PUCCH transmission. Further, if a transmission of a first PUSCH of larger priority index scheduled by a DCI format in a PDCCH reception would overlap in time with a repetition of the transmission of a second PUCCH of smaller priority index, the UE 115 may cancel or drop the repetition of the transmission of the second PUCCH before the first symbol that would overlap with the first PUSCH transmission.

In some aspects, the overlapping may be applicable before or after resolving overlapping among channels of larger priority index, if any. In some aspects, any remaining PUCCH or PUSCH, or both, transmission after overlapping resolution may be subjected to the limitations for UE transmission. In some aspects, the UE 115 may expect that the transmission of the first PUCCH or the first PUSCH, respectively, may not start before T_{proc,2} after a last symbol of the corresponding PDCCH reception. In some aspects, T_{proc,2} may be the PUSCH preparation time for a corresponding UE processing capability assuming d_{2,1}=d₁, and d₁ may be determined by a reported UE capability. In some aspects, a UE 115 may multiplex UCIs with same priority index in a PUCCH or a PUSCH before considering limitations for UE transmissions. A PUCCH or a PUSCH may be assumed to have a same priority index as a priority index of UCIs a UE 115 multiplexes in the PUCCH or the PUSCH.

In some wireless communications systems, a UE 115 may communicate with multiple TRPs on a same serving cell and, in some operation modes, the UE 115 may receive DCI from each TRP that schedules communication between the UE and that TRP. For example, the UE 115 may receive a first DCI message from a first TRP scheduling a first uplink transmission from the UE 115 to the first TRP and may receive a second DCI message from a second TRP scheduling a second uplink transmission from the UE 115 to the second TRP. In some deployment scenarios, the first TRP and the second TRP may be associated with different CORESET pool indices and associated with different TAGs. For example, the first TRP may be associated with a first CORESET pool index and a first TAG and the second TRP may be associated with a second CORESET pool index and a second TAG. In such deployment scenarios, the first uplink transmission and the second uplink transmission may overlap based on one or both of logical time (i.e., scheduled time) and actual time (i.e., observed or measured time). The UE 115 and the multiple TRPs, however, may lack a mutually understood or configured procedure according to which the UE 115 and the multiple TRPs are able to resolve any potential overlapping between uplink transmissions associated with the first TAG and uplink transmissions associated with the second TAG based on one or both of logical time and actual time.

In some implementations, the UE 115 and the multiple TRPs may employ a transmission rule-based procedure according to which the UE 115 and the multiple TRPs are able to resolve any potential overlapping between uplink transmissions associated with the first TAG and uplink transmissions associated with the second TAG based on one or both of logical time and actual time. For example, in accordance with the rule-based procedure, the UE 115 and the multiple TRPs may determine which scheduled uplink transmissions are to be performed by the UE 115 and what level of multiplexing or dropping may occur among the scheduled uplink transmissions. The transmission rule-based procedure may include a first transmission rule and a second transmission rule and the UE 115 may apply the first transmission rule and the second transmission rule sequentially to resolve the potential overlapping based on one or both of logical time and actual time.

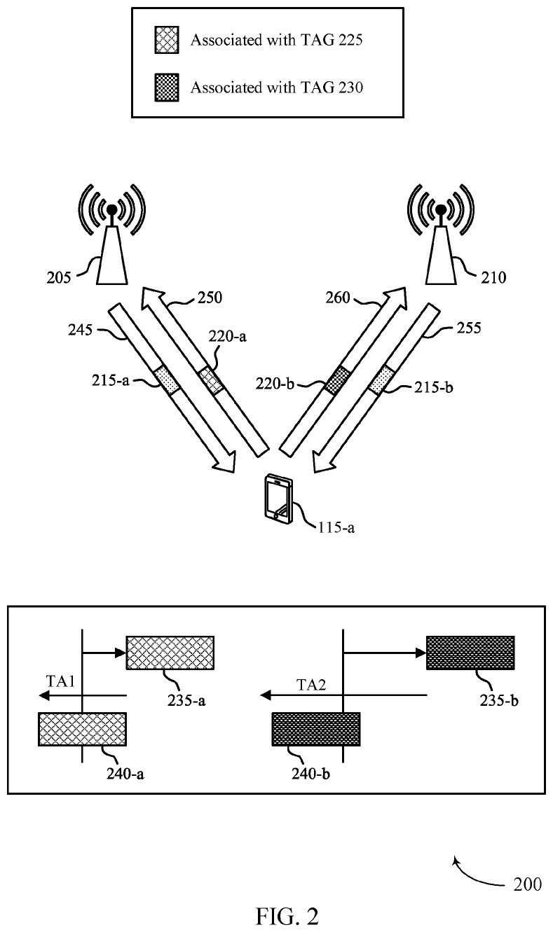

FIG. 2 shows an example of a wireless communications system 200 that supports techniques for handling overlapping uplink transmissions associated with different TAGs in accordance with one or more aspects of the present disclosure. The wireless communications system 200 may implement or be implemented to realize aspects of the wireless communications system 100. For example, a UE 115-a may communicate with a TRP 205 and a TRP 210. The UE 115-a may be an example of a UE 115 as illustrated by and described with reference to FIG. 1 and the TRP 205 and the TRP 210 may be examples of TRPs as described with reference to FIG. 1, such as TRPs associated with one or more network entities 105. In some implementations, the UE 115-a, the TRP 205, and the TRP 210 may employ a transmission rule-based procedure to resolve overlap between scheduled uplink transmissions based on one or both of logical time and actual time.

For example, in multi-TRP operation, a serving cell may schedule the UE 115-a from multiple TRPs (such as the TRP 205 and the TRP 210), which may support greater coverage, greater reliability, and higher data rates. Multi-TRP operation may be associated with different operation modes, including a single-DCI operation mode and a multi-DCI operation mode. For both single-DCI and multi-DCI operation modes, uplink and downlink operation between the UE 115-a and the multiple TRPs may be controlled (such as by the serving cell or by one or both of the TRP 205 and the TRP 210) by physical layer signaling or MAC layer signaling, or both, within a configuration provided by RRC layer signaling.

In a single-DCI operation mode, the UE 115-a may receive scheduling for communication with both the TRP 205 and the TRP 210 from a same DCI. For example, the UE 115-a may receive a DCI message from the TRP 205 and the DCI message may schedule communication between the UE 115-a and the TRP 205 as well as between the UE 115-a and the TRP 210. In a multi-DCI operation mode, the UE 115-a may receive scheduling for communication with the TRP 205 and the TRP 210 independently. For example, the UE 115-a may receive a first DCI message from the TRP 205 via a control signaling message 215-a on a downlink 245 scheduling an uplink transmission 220-a from the UE 115-a to the TRP 205 on an uplink 250 and may receive a second DCI message from the TRP 210 via a control signaling message 215-b on a downlink 255 scheduling an uplink transmission 220-b from the UE 115-a to the TRP 210 on an uplink 260. Generally, the UE 115-a may receive one or more control signaling messages 215-a from the TRP 205 scheduling one or more uplink transmissions 220-a from the UE 115-a to the TRP 205 and may receive one or more control signaling messages 215-b from the TRP 210 scheduling one or more uplink transmissions 220-b from the UE 115-a to the TRP 210. As described herein, one or more control signaling messages 215-a and one or more control signaling messages 215-b may include one or more RRC messages, one or more DCI messages, one or more MAC control elements (MAC-CEs), or any combination thereof.

In some aspects, multi-DCI based multi-TRP operation may be configured for a BWP or component carrier if two CORESET pool index values (such as two CORESETPoolIndex parameter values) are configured for the CORESETs in the BWP or component carrier, where a default value (such as a default value of 0) may be assumed if a CORESETPoolIndex parameter is not provided for a CORSET in the BWP or component carrier. As described herein, a CORESETPoolIndex value may be referred to as a control set index, a control resource index, a control resource set index, a resource pool index, or a control resource set pool index, among other examples.

In some aspects, the wireless communications system 200 may support one or more serving cells and each serving cell may be associated with one TAG. In other words, in such aspects in which each serving cell is associated with one TAG, one timing advance (TA) value may be used for communication on that serving cell. A TA command, which may be denoted as T_{A}, for a TAG may indicate an adjustment of a current TA value (e.g., an N_{TA_old} value) to a new TA value (e.g., an N_{TA_new} value) by index values of T_{A}=0, 1, 2, . . . , 63. For a subcarrier-spacing (SCS) of 2^{μ}*15 kHz, a new TA value may be defined in accordance with Equation 1.

$${N}_{TA \_ new} = {N}_{TA \_ old} + \frac{( {T}_{A} - 31 ) * 16 * 64}{{2}^{μ}} \qquad ( 1 )$$

The UE 115-a may receive an indication of a T_{A} value via a MAC-CE associated with a tag-Id field (indicating a TAG-Id parameter) of a ServingCellConfig information element and the MAC-CE may include two bits indicating a TAG identifier (ID) (corresponding to the tag-Id field) and six bits for indicating the TA command (such as the index value T_{A}). A ServingCellConfig parameter also may include a tdd-UL-DL-ConfigurationDedicated field associated with a TDD-UL-DL-ConfigDedicated parameter and an initialDownlinkBWP field indicating a BWP-DownlinkDedicated parameter. Each serving cell may be configured with one or multiple BWPs. The BWP-DownlinkDedicated parameter may include or indicate apdcch-Config field associated with a SetupRelease (PDCCH-Config) parameter.

The PDCCH-Config parameter may include or indicate a controlResourceSetToAddModListSizeExt field (such as a controlResourceSetToAddModListSizeExt-v1610 field), a ControlResourceSet field associated with a controlResourceSetToReleaseListSizeExt parameter (such as a controlResourceSetToReleaseListSizeExt-r16 parameter), and a ControlResourceSetld field (such as a ControlResourceSetld-r16 field). The ControlResourceSet field may include a coresetPoolIndex field (such as a coresetPoolIndex-r16 field) and a controlResourceSetId field (such as a controlResourceSetId-v1610 field). Each BWP may be associated with one or multiple coresetPoolIndex fields or values. If a BWP is associated with multiple coresetPoolIndex fields or values, the BWP is associated with multi-DCI, multi-TRP operation.

In some deployment scenarios, the wireless communications system 200 may support two TA values for uplink multi-DCI, multi-TRP operation on a same serving cell. For example, the ServingCellConfig information element may include a tag-Id1 field (indicating a TAG-Id1 parameter) and a tag-Id2 field (indicating a TAG-Id2 parameter). In some aspects, the TAG-Id1 parameter may indicate or correspond to a TAG 225 and the TAG-Id2 parameter may indicate or correspond to a TAG 230. In accordance with the wireless communications system 200 supporting two TA values for multi-DCI, multi-TRP operation on a same serving cell, different CORESETs may be associated with or otherwise link to different TAGs. For example, a ControlResourceSet field may correspond or point to the tag-Id1 field or the tag-Id2 field and an associated CORESET may likewise be associated with or link to the indicated TAG.

In some examples, for instance, the TRP 205 may transmit the control signaling message 215-a over one or more resources (e.g., one or more physical downlink control channel (PDCCH) resources) of a first CORESET associated with a first CORESETPoolIndex value and the TAG 225 and the TRP 210 may transmit the control signaling message 215-b over one or more resources (e.g., one or more PDCCH resources) of a second CORSET associated with a second CORESETPoolIndex value and the TAG 230. As such, in examples in which the control signaling message 215-a schedules the uplink transmission 220-a and the control signaling message 215-b schedules the uplink transmission 220-b, the UE 115-a may perform the uplink transmission 220-a in accordance with a first TA value (e.g., a TAT) associated with the TAG 225 and may perform the uplink transmission 220-b in accordance with a second TA value (e.g., a TA2) associated with the TAG 230. Generally, the first TA value (e.g., the TAT) may define a time-domain offset between a downlink transmission 235-a and a corresponding or associated uplink transmission 240-a and the second TA value (e.g., the TA2) may define a time-domain offset between a downlink transmission 235-b and a corresponding or associated uplink transmission 240-b.

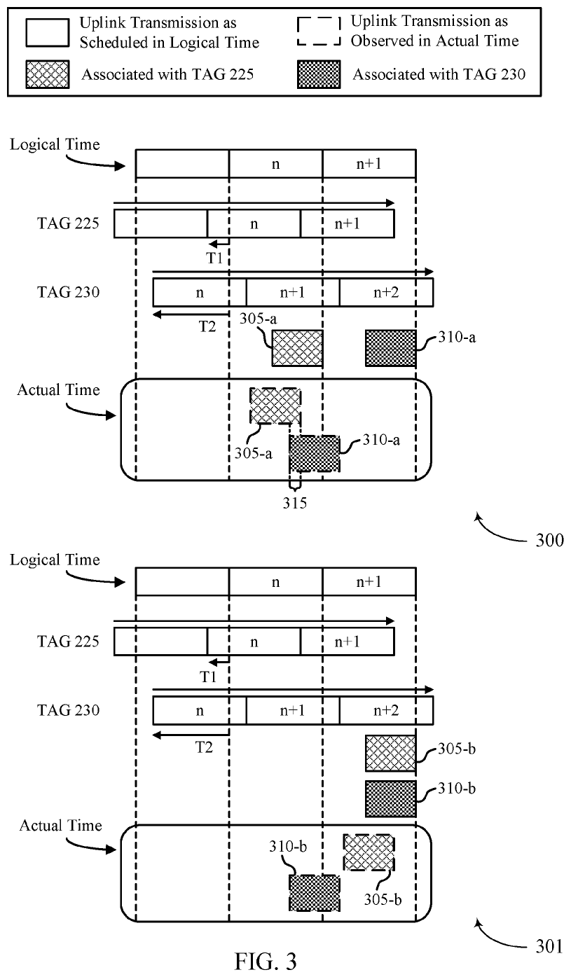

In scenarios in which two TAs are configured for at least one component carrier (e.g., a component carrier configured with multiple CORESETPoolIndex values), for example, the UE 115-a may use different TAs for uplink transmissions (e.g., PUSCH transmissions, PUCCH transmissions, SRS transmissions, or any combination thereof) toward different TRPs (e.g., the TAT associated with the TAG 225 for the TRP 205 and the TA2 associated with the TAG 230 for the TRP 210). As such, and with consideration to the presence of different timelines associated with logical time and actual time, some scheduled uplink transmissions may overlap in various ways. For example, non-overlapping uplink transmissions based on logical time may be overlapping based on actual time due to different TAs for the uplink transmissions. Alternatively, overlapping uplink transmissions based on logical time may be non-overlapping based on actual time due to different TAs for the uplink transmissions. In some systems, however, the UE 115-a, the TRP 205, and the TRP 210 may lack a configured or mutually understood rule or procedure for resolving or handling such potential overlaps for uplink transmissions associated with different TAGs on a same serving cell. Additional details relating to such a potential overlapping between uplink transmissions are illustrated by and described with reference to FIG. 3.

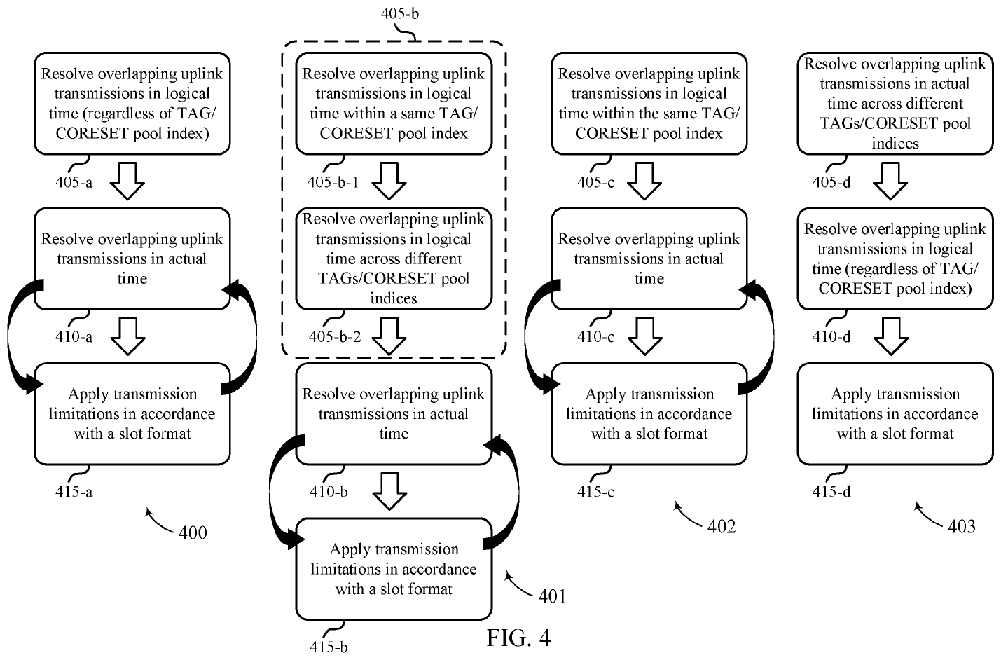

In some implementations, the UE 115-a, the TRP 205, and the TRP 210 may employ a configured or mutually understood transmission rule-based procedure according to which the UE 115-a determines how or whether to multiplex, drop, or trim one or more scheduled uplink transmissions to resolve potential overlapping based on one or both of logical time and actual time and according to which the TRP 205 and the TRP 210 are able to identify or expect the multiplexing, dropping, or trimming performed by the UE 115-a. The transmission rule-based procedure may include a quantity of one or more steps, each step associated with an application of a different transmission rule or a different stage of a same transmission rule, and the one or more steps may be associated with one or more specific orderings. For example, the transmission rule-based procedure may generally or collectively refer to a number of different options, each option associated with a specific sequence or ordering of one or more steps and transmission rules. Additional details relating to such various options for the transmission rule-based procedure according to which the UE 115-a, the TRP 205, and the TRP 210 may resolve any potential overlapping between uplink transmissions based on logical time and actual time are illustrated by and described with reference to FIG. 4.

FIG. 3 shows examples of scheduling diagrams 300 and 301 that support techniques for handling overlapping uplink transmissions associated with different TAGs in accordance with one or more aspects of the present disclosure. The scheduling diagrams 300 and 301 may implement or be implemented to realize aspects of the wireless communications system 100 or the wireless communications system 200. For example, a UE 115 (such as a UE 115 or a UE 115-a as illustrated by and described with reference to FIGS. 1 and 2, respectively) may receive control signaling from different TRPs (such as the TRP 205 and the TRP 210 as illustrated by and described with reference to FIG. 2) on different CORESETs of a same serving cell and the different CORESETs may be associated with different TAGs. As such, multiple TA values may be applicable or valid for a time period (e.g., a first time period during which the TAG 225 is valid may at least partially overlap with a second time period during which the TAG 230 is valid), where each of the multiple TAs may be activated or set by a TA command in a MAC-CE.

In the examples of the scheduling diagrams 300 and 301, the UE 115 may receive one or more control signaling messages 215-a from the TRP 205 on a first CORESET (e.g., corresponding to a first CORESETPoolIndex value) associated with the TAG 225 and may receive one or more control signaling messages 215-b from the TRP 210 on a second CORESET (e.g., corresponding to a second CORESETPoolIndex value) associated with the TAG 230. In some aspects, the one or more control signaling messages 215-a and the one or more control signaling messages 215-b may each schedule one or more uplink transmissions associated with the TAG 225 and the TAG 230, respectively. As illustrated in FIGS. 3 and 5-12, a solid line may represent an uplink transmission as scheduled based on logical time and a dashed line may represent the uplink transmission (e.g., the same uplink transmission) as scheduled or observed based on actual time.

As shown in the scheduling diagram 300, for example, the TRP 205 may schedule, via the one or more control signaling messages 215-a (which may include one or more RRC messages, MAC-CEs, DCI messages, or any combination thereof), an uplink transmission 305-a associated with the TAG 225 and the TRP 210 may schedule, via the one or more control signaling messages 215-b (which may include one or more RRC messages, MAC-CEs, DCI messages, or any combination thereof), an uplink transmission 310-a associated with the TAG 230. In some aspects, the TRP 205 may schedule the uplink transmission 305-a for a logical time slot n and the TRP 210 may schedule the uplink transmission 310-a for a logical time slot n+1. In other words, the uplink transmission 305-a and the uplink transmission 310-a may be non-overlapping based on logical time. In accordance with the TA associated with the TAG 225 and the TA associated with the TAG 230, however, the uplink transmission 305-a and the uplink transmission 310-a may overlap in actual time. For example, the uplink transmission 305-a and the uplink transmission 310-a may have an overlapping part 315 due to the multiple TAs in the system. In some systems, if two adjacent slots overlap due to a TA command, a latter of the two slots may be reduced relative to the former slot. In such systems, for example, the UE 115 may perform the uplink transmission 305-a and may perform a portion of the uplink transmission 310-a (e.g., a portion excluding the overlapping part 315 of the uplink transmission 310-a), which may be scheduled in a later slot than the uplink transmission 305-a.

As shown in the scheduling diagram 301, the TRP 205 may schedule, via the one or more control signaling messages 215-a, an uplink transmission 305-b associated with the TAG 225 and the TRP 210 may schedule, via the one or more control signaling messages 215-b, an uplink transmission 310-b associated with the TAG 230. In some aspects, the TRP 205 may schedule the uplink transmission 305-b for a logical time slot n+1 and the TRP 210 may schedule the uplink transmission 310-b for a logical time slot n+1. In other words, the uplink transmission 305-b and the uplink transmission 310-b may be overlapping based on logical time. In accordance with the TA associated with the TAG 225 and the TA associated with the TAG 230, however, the uplink transmission 305-b and the uplink transmission 310-b may be non-overlapping in actual time.

Thus, non-overlapping uplink transmissions based on logical time may be overlapping based on actual time due to different TAs for the uplink transmissions and overlapping uplink transmissions based on logical time may be non-overlapping based on actual time due to different TAs for the uplink transmissions. In accordance with the implementations described herein, the UE 115, the TRP 205, and the TRP 210 may employ a configured or mutually understood transmission rule-based procedure according to which the UE 115 determines how or whether to multiplex, drop, or trim one or more scheduled uplink transmissions to resolve potential overlapping based on one or both of logical time and actual time and according to which the TRP 205 and the TRP are able to identify or expect the multiplexing, dropping, or trimming performed by the UE 115.

FIG. 4 shows examples of transmission rule-based procedures 400, 401, 402, and 403 that support techniques for handling overlapping uplink transmissions associated with different TAGs in accordance with one or more aspects of the present disclosure. The transmission rule-based procedures 400, 401, 402, and 403 may implement or be implemented to realize aspects of the wireless communications system 100 or the wireless communications system 200. For example, a UE 115 (such as a UE 115 or a UE 115-a as illustrated by and described with reference to FIGS. 1 and 2, respectively) may receive control signaling from different TRPs (such as the TRP 205 and the TRP 210 as illustrated by and described with reference to FIG. 2) on different CORESETs of a same serving cell and the different CORESETs may be associated with different TAGs. As such, the UE 115, the TRP 205, and the TRP 210 may employ one or more of the transmission rule-based procedures 400, 401, 402, and 403 to resolve overlapping based on one or both of logical time and actual time.

Across the transmission rule-based procedures 400, 401, 402, and 403, the UE 115 and the multiple TRPs may perform different steps or may perform similar steps in different orders, or any combination thereof. Further, although the transmission rule-based procedures 400, 401, 402, and 403 show one ordering of steps, other orders of the same steps are possible. The UE 115 and the multiple TRPs also may perform additional steps not shown in the transmission rule-based procedures 400, 401, 402, and 403 or steps may be removed from the transmission rule-based procedures 400, 401, 402, and 403. Generally, each of the transmission rule-based procedures 400, 401, 402, and 403 may be associated with three steps, each associated with an application of a different transmission rule.

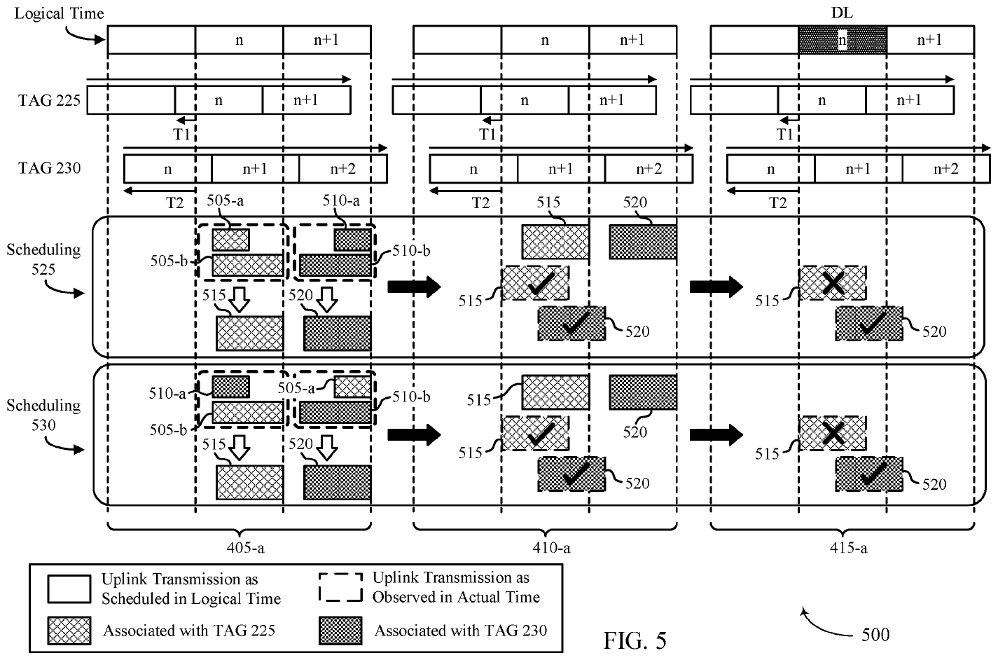

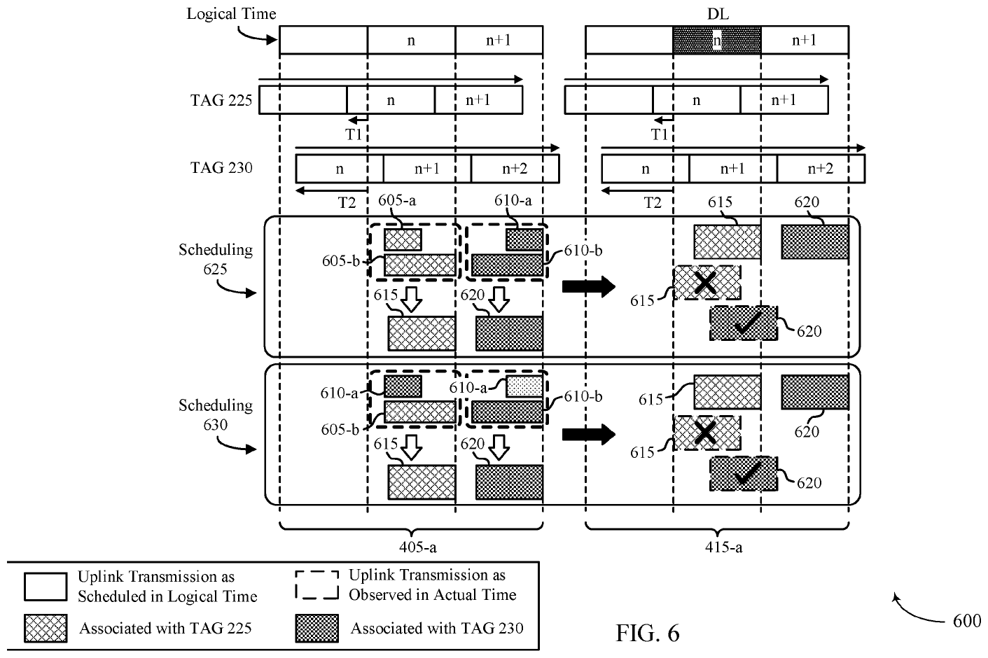

As shown in the transmission rule-based procedure 400, the UE 115 and the multiple TRPs may resolve overlapping uplink transmissions (e.g., via UCI multiplexing, prioritization, or dropping for overlapping channels) in logical time, resolve remaining overlapping in actual time, and consider limitations for UE transmission (e.g., due to any potential direction conflicts between uplink and downlink) in accordance with a configured or indicated slot format. Alternatively, the UE 115 and the multiple TRPs may consider the limitations for UE transmission (e.g., due to any potential direction conflicts between uplink and downlink) in accordance with a configured or indicated slot format before resolving any remaining overlapping in actual time. In other words, 410-a and 415-a may be switched in order. Additional details relating to the transmission rule-based procedure 400 are illustrated by and described with reference to FIGS. 5 and 6.

At 405-a, the UE 115 and the multiple TRPs may resolve overlapping uplink transmissions in logical time. In some implementations, the UE 115 and the multiple TRPs may resolve the overlapping uplink transmissions in logical time in accordance with applying a first transmission rule to a set of uplink transmissions that are scheduled by the multiple TRPs regardless of which TAG or CORESETPoolIndex value the uplink transmissions are associated with. In accordance with the first transmission rule, the UE 115 may multiplex or drop a set of uplink transmissions that overlap in a given logical time domain location (e.g., one or more slots or one or more symbols) to obtain one uplink transmission in that logical time domain location. The UE 115 may similarly multiplex or drop other sets of uplink transmissions that overlap in other logical time domain locations to obtain one uplink transmission in each logical time domain location (such that there are no remaining overlapping transmissions based on logical time after application of the first transmission rule).

At 410-a, the UE 115 and the multiple TRPs may resolve overlapping uplink transmissions in actual time. In some implementations, the UE 115 and the multiple TRPs may resolve the overlapping uplink transmissions in actual time in accordance with applying a second transmission rule to uplink transmissions that overlap in actual time (e.g., regardless of which TAG or CORESETPoolIndex value the uplink transmissions are associated with). In accordance with the second transmission rule, the UE 115 and the multiple TRPs may select one or more uplink transmissions based on a satisfaction of a condition associated with a capability of the UE 115.

At 415-a, the UE 115 and the multiple TRPs may apply limitations for UE transmission due to a direction conflict associated with a slot format. In implementations in which the UE 115 and the multiple TRPs apply the transmission limitations after 410-a, the UE and the multiple TRPs may de-select one or more uplink transmissions that are selected in accordance with the second transmission rule and that overlap with a slot or symbol that is configured for downlink to avoid a direction conflict (e.g., to avoid expecting to transmit and receive at a same time). In implementations in which the UE 115 and the multiple TRPs apply the transmission limitations after 405-a and before 410-a, the UE 115 and the multiple TRPs may de-select one or more uplink transmissions that are selected in accordance with the first transmission rule and that overlap with a slot or symbol that is configured for downlink to avoid a direction conflict (e.g., to avoid expecting to transmit and receive at a same time).

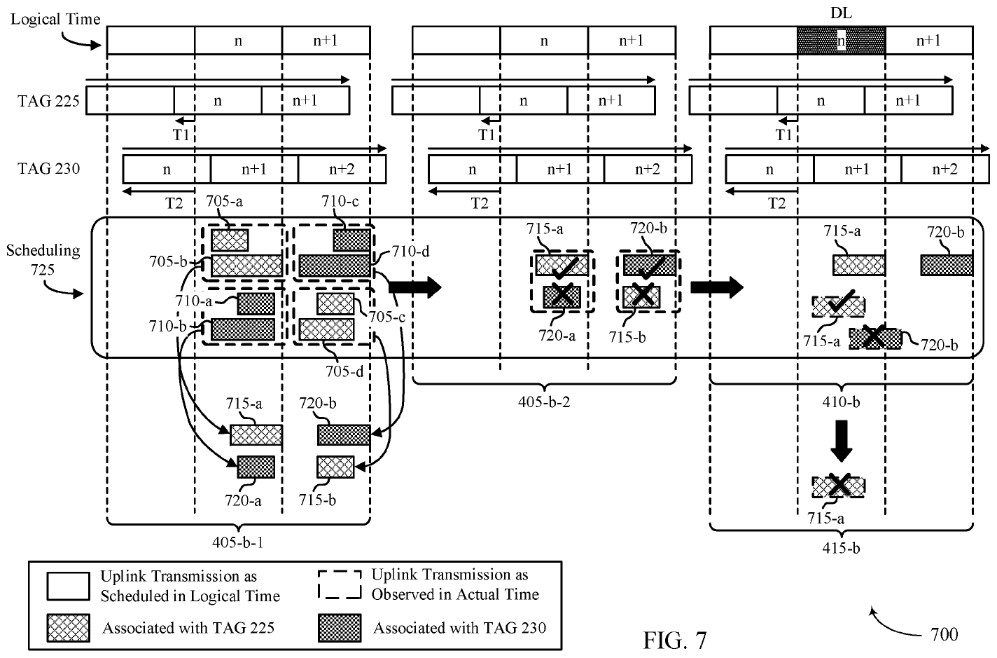

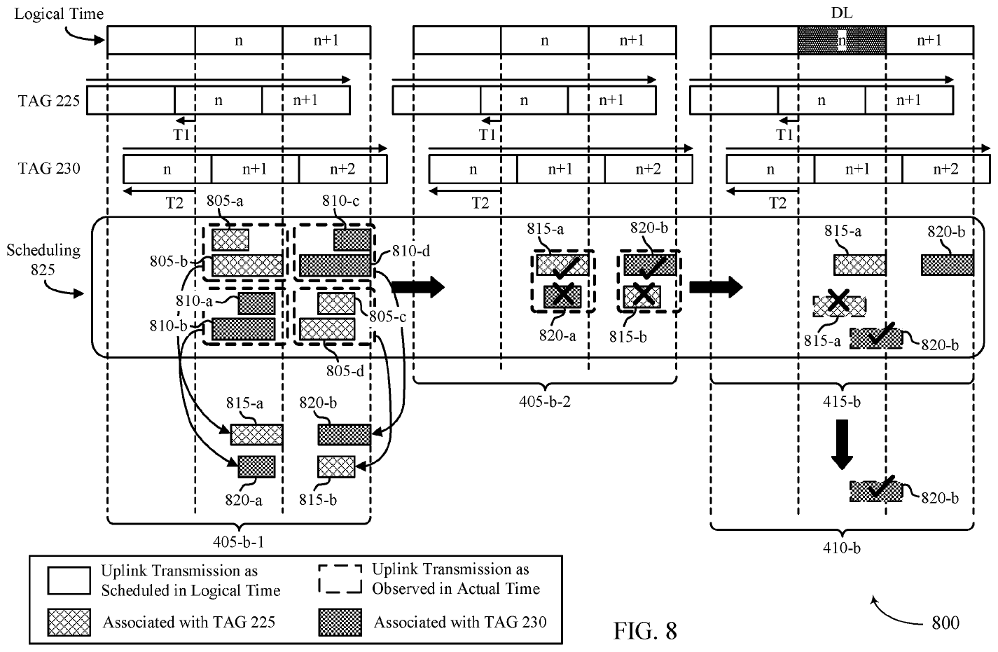

As shown in the transmission rule-based procedure 401, the UE 115 and the multiple TRPs may resolve overlapping uplink transmissions (e.g., via UCI multiplexing, prioritization, or dropping for overlapping channels) in logical time within a same TAG or associated with a same CORESETPoolIndex value, resolve overlapping uplink transmissions (e.g., via UCI multiplexing, prioritization, or dropping for overlapping channels) in logical time across different TAGs or CORESETPoolIndex values, resolve overlapping uplink transmissions in actual time, and consider limitations for UE transmission (e.g., due to any potential direction conflicts between uplink and downlink) in accordance with a configured or indicated slot format. Alternatively, the UE 115 and the multiple TRPs may consider limitations for UE transmission (e.g., due to any potential direction conflicts between uplink and downlink) in accordance with a configured or indicated slot format prior to resolving overlapping uplink transmissions in actual time. In other words, 410-b and 415-b may be switched in order. Additional details relating to the transmission rule-based procedure 401 are illustrated by and described with reference to FIGS. 7 and 8.

At 405-b, the UE 115 and the multiple TRPs may resolve overlapping uplink transmissions in logical time. In some implementations, the UE 115 and the multiple TRPs may resolve the overlapping uplink transmissions in logical time in accordance with applying a first transmission rule to a set of uplink transmissions that are scheduled by the multiple TRPs. In the example of the transmission rule-based procedure 401, the first transmission rule may include a first stage and a second stage.

At 405-b-1, for example, the UE 115 and the multiple TRPs may apply the first stage of the first transmission rule to resolve overlapping uplink transmissions in logical time within a same TAG or associated with a same CORESETPoolIndex value. For example, in accordance with the first stage of the first transmission rule, the UE 115 may multiplex or drop a set of uplink transmissions that overlap in a given logical time domain location (e.g., one or more slots or one or more symbols) and that are associated with a same TAG or CORESETPoolIndex value to obtain one or more intermediate uplink transmissions in that logical time domain location. The UE 115 may similarly multiplex or drop other sets of uplink transmissions that overlap in other logical time domain locations that are associated with a same TAG or CORESETPoolIndex value to obtain one or more other intermediate uplink transmissions in each logical time domain location.

At 405-b-2, the UE 115 and the multiple TRPs may apply the second stage of the first transmission rule to resolve overlapping uplink transmissions in logical time across different TAGs or CORESETPoolIndex values. For example, in accordance with the second stage of the first transmission rule, the UE 115 may select one of a set of intermediate uplink transmissions that overlap in logical time for each logical time domain location during which intermediate uplink transmissions obtained from the first stage overlap. In some aspects, and in accordance with performing the first stage, intermediate uplink transmissions obtained from the first stage that overlap in a logical time domain location may be associated with different TAGs or CORESETPoolIndex values.

At 410-b, the UE 115 and the multiple TRPs may resolve overlapping uplink transmissions in actual time. In some implementations, the UE 115 and the multiple TRPs may resolve the overlapping uplink transmissions in actual time in accordance with applying a second transmission rule to uplink transmissions that overlap in actual time (e.g., regardless of which TAG or CORESETPoolIndex value the uplink transmissions are associated with). In accordance with the second transmission rule, the UE 115 and the multiple TRPs may select one or more uplink transmissions based on a satisfaction of a condition associated with a capability of the UE 115.

At 415-b, the UE 115 and the multiple TRPs may apply limitations for UE transmission due to a direction conflict associated with a slot format. In implementations in which the UE 115 and the multiple TRPs apply the transmission limitations after 410-b, the UE and the multiple TRPs may de-select one or more uplink transmissions that are selected in accordance with the second transmission rule and that overlap with a slot or symbol that is configured or indicated for downlink to avoid a direction conflict (e.g., to avoid expecting to transmit and receive at a same time). In implementations in which the UE 115 and the multiple TRPs apply the transmission limitations after 405-b and before 410-b, the UE 115 and the multiple TRPs may de-select one or more uplink transmissions that are selected in accordance with the first transmission rule and that overlap with a slot or symbol that is configured or indicated for downlink to avoid a direction conflict (e.g., to avoid expecting to transmit and receive at a same time).

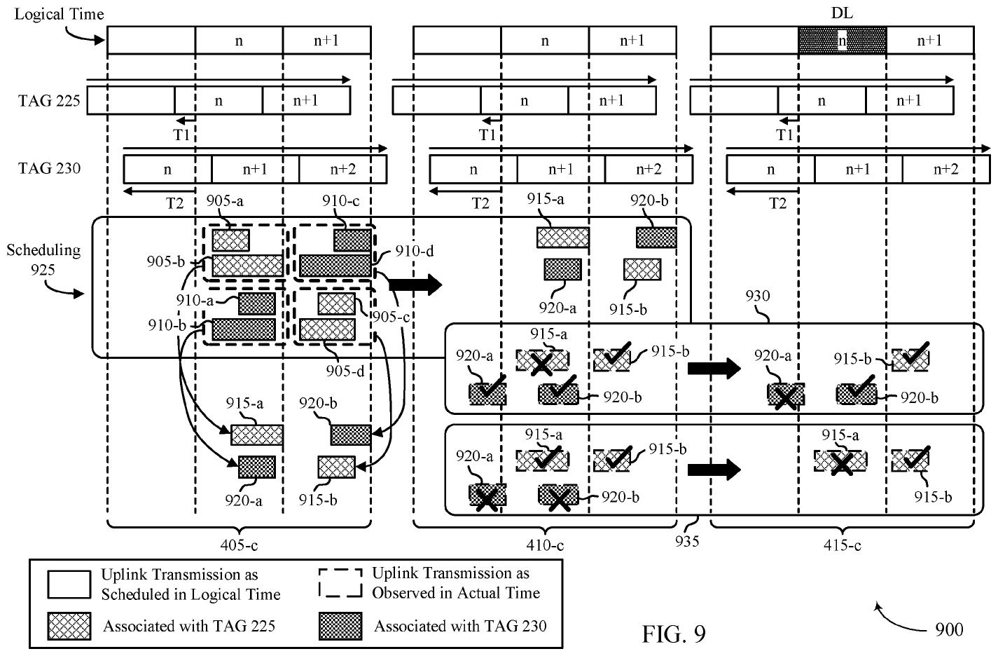

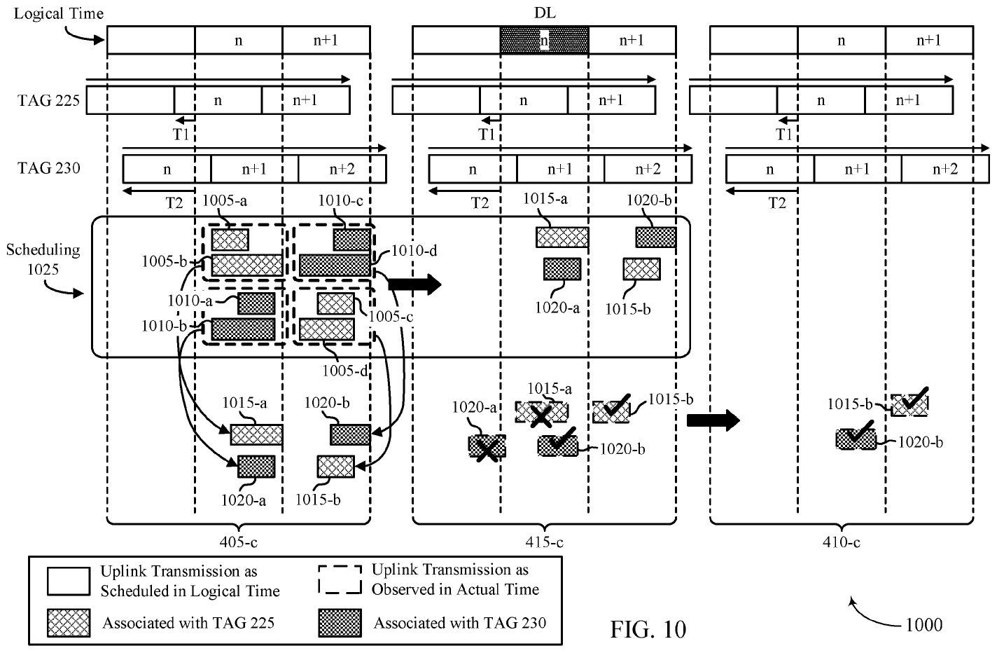

As shown in the transmission rule-based procedure 402, the UE 115 and the multiple TRPs may resolve overlapping uplink transmissions (e.g., via UCI multiplexing, prioritization, or dropping for overlapping channels) in logical time within a same TAG or associated with a same CORESETPoolIndex value, resolve overlapping uplink transmissions in actual time, and consider limitations for UE transmission (e.g., due to any potential direction conflicts between uplink and downlink) in accordance with a configured or indicated slot format. Alternatively, the UE 115 and the multiple TRPs may consider limitations for UE transmission (e.g., due to any potential direction conflicts between uplink and downlink) in accordance with a configured or indicated slot format prior to resolving overlapping uplink transmissions in actual time. In other words, 410-c and 415-c may be switched in order. Additional details relating to the transmission rule-based procedure 402 are illustrated by and described with reference to FIGS. 9 and 10.

At 405-c, the UE 115 and the multiple TRPs may resolve overlapping uplink transmissions in logical time within a same TAG or associated with a same CORESETPoolIndex value. In some implementations, the UE 115 and the multiple TRPs may resolve the overlapping uplink transmissions in logical time within the same TAG or associated with the same CORESETPoolIndex value in accordance with applying a first transmission rule. For example, in accordance with the first transmission rule, the UE 115 may multiplex or drop uplink transmissions of a set of uplink transmissions that overlap in a given logical time domain location (e.g., one or more slots or one or more symbols) and that are associated with a same TAG or CORESETPoolIndex value to obtain one or more uplink transmissions in that logical time domain location. The UE 115 may similarly multiplex or drop uplink transmissions of other sets of uplink transmissions that overlap in other logical time domain locations and that are associated with a same TAG or CORESETPoolIndex value to obtain one or more other uplink transmissions in each of the other logical time domain locations. As such, some uplink transmissions obtained from applying the first transmission rule may still overlap in logical time, but such overlapping uplink transmissions will be associated with different TAGs or CORESETPoolIndex values.

At 410-c, the UE 115 and the multiple TRPs may resolve overlapping uplink transmissions in actual time. In some implementations, the UE 115 and the multiple TRPs may resolve the overlapping uplink transmissions in actual time in accordance with applying a second transmission rule to uplink transmissions that overlap in actual time (e.g., regardless of which TAG or CORESETPoolIndex value the uplink transmissions are associated with). In accordance with the second transmission rule, the UE 115 and the multiple TRPs may select one or more uplink transmissions based on a satisfaction of a condition associated with a capability of the UE 115.

At 415-c, the UE 115 and the multiple TRPs may apply limitations for UE transmission due to a direction conflict associated with a slot format. In implementations in which the UE 115 and the multiple TRPs apply the transmission limitations after 410-c, the UE and the multiple TRPs may de-select one or more uplink transmissions that are selected in accordance with the second transmission rule and that overlap with a slot or symbol that is configured or indicated for downlink to avoid a direction conflict (e.g., to avoid expecting to transmit and receive at a same time). In implementations in which the UE 115 and the multiple TRPs apply the transmission limitations after 405-c and before 410-c, the UE 115 and the multiple TRPs may de-select one or more uplink transmissions that are selected in accordance with the first transmission rule and that overlap with a slot or symbol that is configured or indicated for downlink to avoid a direction conflict (e.g., to avoid expecting to transmit and receive at a same time).

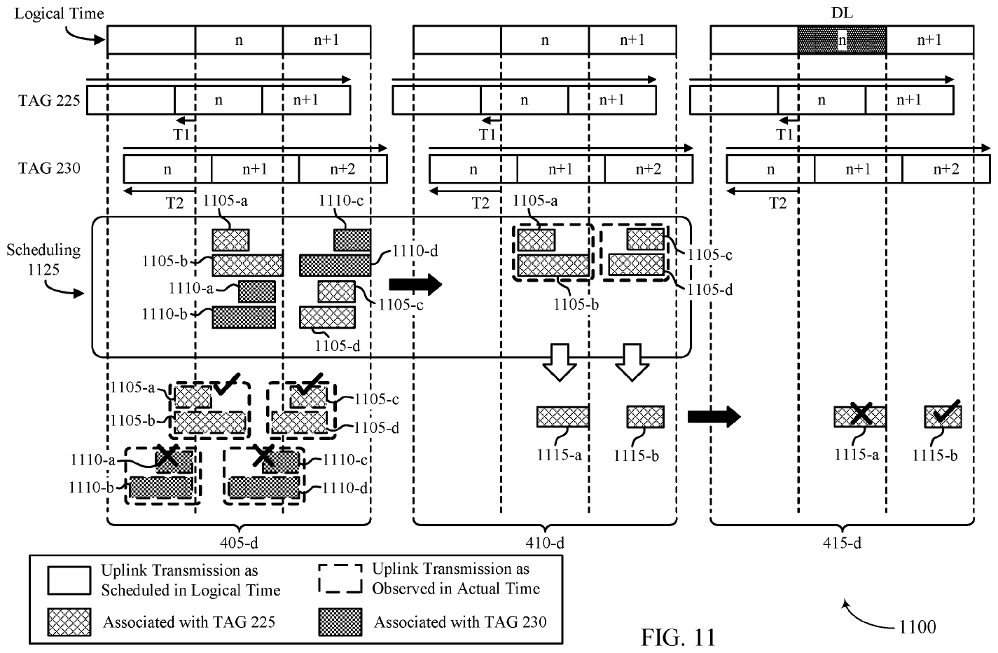

As shown in the transmission rule-based procedure 403, the UE 115 and the multiple TRPs may resolve overlapping uplink transmissions in actual time across different TAGs or CORESETPoolIndex values, resolve overlapping uplink transmissions (e.g., via UCI multiplexing, prioritization, or dropping for overlapping channels) in logical time regardless of TAG or CORESETPoolIndex value, and consider limitations for UE transmission (e.g., due to any potential direction conflicts between uplink and downlink) in accordance with a configured slot format. Additional details relating to the transmission rule-based procedure 403 are illustrated by and described with reference to FIG. 11.

At 405-d, the UE 115 and the multiple TRPs may resolve overlapping uplink transmissions in actual time across different TAGs or CORESETPoolIndex values. In some implementations, the UE 115 and the multiple TRPs may resolve the overlapping uplink transmissions in actual time across different TAGs or CORESETPoolIndex values in accordance with applying a first transmission rule to the uplink transmissions that overlap in actual time and that are associated with different TAGs or CORESETPoolIndex values. For example, the UE 115 and the multiple TRPs may group uplink transmissions within a same TAG or CORESETPoolIndex value that overlap in actual time and may select between different groups that overlap in actual time. For instance, if a first group of one or more uplink transmissions associated with a first TAG (e.g., the TAG 225) overlap with a second group of one or more uplink transmissions associated with a second TAG (e.g., the TAG 230) based on actual time, the UE 115 and the multiple TRPs may select one of the first group or the second group in accordance with the first transmission rule.

At 410-d, the UE 115 and the multiple TRPs may resolve overlapping uplink transmissions in logical time regardless of which TAG or CORESETPoolIndex value the overlapping uplink transmissions are associated with. In some implementations, the UE 115 and the multiple TRPs may resolve the overlapping uplink transmissions in logical time regardless of which TAG or CORESETPoolIndex value the overlapping uplink transmissions are associated with in accordance with applying a second transmission rule. In accordance with the second transmission rule, the UE 115 may multiplex or drop a set of uplink transmissions that overlap in a given logical time domain location (e.g., one or more slots or one or more symbols) to obtain one uplink transmission in that logical time domain location. The UE 115 may similarly multiplex or drop other sets of uplink transmissions that overlap in other logical time domain locations to obtain one uplink transmission in each logical time domain location (such that there is no remaining overlapping transmissions based on logical time after application of the second transmission rule).

At 415-d, the UE 115 and the multiple TRPs may apply limitations for UE transmission due to a direction conflict associated with a slot format. In implementations in which the UE 115 and the multiple TRPs apply the transmission limitations after 410-d, the UE and the multiple TRPs may de-select one or more uplink transmissions that are selected in accordance with the second transmission rule and that overlap with a slot or symbol that is configured or indicated for downlink to avoid a direction conflict (e.g., to avoid expecting to transmit and receive at a same time).

FIG. 5 shows an example of a transmission rule-based procedure 500 that supports techniques for handling overlapping uplink transmissions associated with different TAGs in accordance with one or more aspects of the present disclosure. The transmission rule-based procedure 500 may implement or be implemented to realize aspects of the wireless communications system 100 or the wireless communications system 200. For example, a UE 115 (such as a UE 115 or a UE 115-a as illustrated by and described with reference to FIGS. 1 and 2, respectively) may receive control signaling from different TRPs (such as the TRP 205 and the TRP 210 as illustrated by and described with reference to FIG. 2) on different CORESETs of a same serving cell and the different CORESETs may be associated with different TAGs. In some implementations, the UE 115 and the multiple TRPs may apply the transmission rule-based procedure 500, which may be an example of the transmission rule-based procedure 400 in which 410-a is before 415-a, to resolve potential overlap between uplink transmissions based on one or both of logical time and actual time.

For example, the UE 115 may receive a first set of one or more control signaling messages from the TRP 205 on one or more CORESETs corresponding to a first CORESETPoolIndex value associated with a TAG 225 scheduling a first set of one or more uplink transmissions 505 (which may refer to one or both of an uplink transmission 505-a and an uplink transmission 505-b). The UE 115 may receive a second set of one or more control signaling messages from the TRP 210 on one or more CORESETs corresponding to a second CORESETPoolIndex value associated with a TAG 230 scheduling a second set of one or more uplink transmissions 510 (which may refer to one or both of an uplink transmission 510-a and an uplink transmission 510-b).

At 405-a, the UE 115 and the multiple TRPs may apply a first transmission rule to the first set of one or more uplink transmissions 505 and the second set of one or more uplink transmissions 510 in accordance with an overlapping between uplink transmissions of one or both of the uplink transmissions 505 and the uplink transmissions 510 in a logical time domain (e.g., a scheduled time domain). The UE 115 and the multiple TRPs may obtain a first uplink transmission 515 in a first logical time domain location (e.g., a slot or one or more symbols) and a second uplink transmission 520 in a second logical time domain location (e.g., a slot or one or more symbols) in accordance with applying the first transmission rule to the first set of one or more uplink transmissions 505 and the second set of one or more uplink transmissions 510. In some implementations, such as implementations in which carrier aggregation is used, the UE 115 and the multiple TRPs may apply the first transmission rule across a set of (e.g., all) component carriers in a same PUCCH group.

The UE 115 and the multiple TRPs may apply the first transmission rule to overlapping uplink transmissions of one or both of the uplink transmissions 505 and the uplink transmissions 510 regardless of which TAG or CORESETPoolIndex value the overlapping uplink transmissions are associated with. For example, the UE 115 and the multiple TRPs may apply the first transmission rule to any uplink transmissions that overlap in logical time. In accordance with a scheduling 525, for example, the UE 115 and the multiple TRPs may apply the first transmission rule to the uplink transmission 505-a and the uplink transmission 505-b (which may both be associated with the TAG 225) to obtain the uplink transmission 515 and may apply the first transmission rule to the uplink transmission 510-a and the uplink transmission 510-b (which may both be associated with the TAG 230) to obtain the uplink transmission 520. In accordance with a scheduling 530, in another example, the UE 115 and the multiple TRPs may apply the first transmission rule to the uplink transmission 510-a and the uplink transmission 505-b (which may be associated with different TAGs) to obtain the uplink transmission 515 and may apply the first transmission rule to the uplink transmission 505-a and the uplink transmission 510-b (which may be associated with different TAGs) to obtain the uplink transmission 520.

In some implementations, the UE 115 may not expect to be scheduled or configured to perform overlapping uplink transmissions across different TAGs or associated with different CORESETPoolIndex values for a given component carrier in accordance with the first transmission rule (e.g., the UE 115 may not expect the scheduling 530 and may treat the scheduling 530 as an error case). In implementations in which the UE 115 does not expect to be scheduled or configured to perform overlapping uplink transmissions across different TAGs or associated with different CORESETPoolIndex values but is scheduled in accordance with the scheduling 530, the UE 115 may drop one or more uplink transmissions that overlap in logical time domain locations based on identifying the error case. Additionally, or alternatively, the UE 115 may employ multiplexing, prioritization, or dropping rules (e.g., UCI multiplexing, prioritization, or dropping rules) for any overlapping uplink transmissions within a same TAG or associated with a same CORESETPoolIndex value in accordance with not expecting to be scheduled or configured to perform overlapping uplink transmissions across different TAGs or associated with different CORESETPoolIndex values.

In some other implementations, the UE 115 and the multiple TRPs may employ multiplexing, prioritization, or dropping rules (e.g., UCI multiplexing, prioritization, or dropping rules) for overlapping uplink transmissions regardless of which TAGs or CORESETPoolIndex values are associated with the overlapping uplink transmissions. For example, the UE 115 may multiplex or drop, or do any combination thereof, one or more first uplink transmissions of one or both of the first set of uplink transmissions 505 and the second set of uplink transmissions 510 that overlap in the first logical time domain location (e.g., the logical time domain slot n) to obtain the first uplink transmission 515. Similarly, the UE 115 may multiplex or drop, or do any combination thereof, one or more second uplink transmissions of one or both of the first set of uplink transmissions 505 and the second set of uplink transmissions 510 that overlap in the second logical time domain location (e.g., the logical time domain slot n+1) to obtain the second uplink transmission 520.

In the example of the scheduling 525, for instance, the UE 115 may multiplex the uplink transmission 505-a and the uplink transmission 505-b or drop one of the uplink transmission 505-a and the uplink transmission 505-b to obtain the uplink transmission 515 in the logical time domain slot n and may multiplex the uplink transmission 510-a and the uplink transmission 510-b or drop one of the uplink transmission 510-a and the uplink transmission 510-b to obtain the uplink transmission 520 in the logical time domain slot n+1. In the example of the scheduling 530, the UE 115 may multiplex the uplink transmission 510-a and the uplink transmission 505-b or drop one of the uplink transmission 510-a and the uplink transmission 505-b to obtain the uplink transmission 515 in the logical time domain slot n and may multiplex the uplink transmission 505-a and the uplink transmission 510-b or drop one of the uplink transmission 505-a and the uplink transmission 510-b to obtain the uplink transmission 520 in the logical time domain slot n+1.

At 410-a, the UE 115 and the multiple TRPs may apply a second transmission rule to the first uplink transmission 515 and the second uplink transmission 520 in accordance with an overlapping between the first uplink transmission 515 and the second uplink transmission 520 in an actual time domain (e.g., a time domain associated with or accounting for a TA associated with the TAG 225 and the TAG 230). In accordance with the second transmission rule, the UE 115 and the multiple TRPs may determine which one or more uplink transmissions may be transmitted for a given component carrier (e.g., the component carrier that is configured with two CORESETPoolIndex values and two corresponding TAGs) based on a satisfaction of a condition associated with a capability of the UE 115.

For example, the UE 115 may perform both the first uplink transmission 515 and the second uplink transmission 520 if one of various conditions is satisfied. In some implementations, the UE 115 may perform both the first uplink transmission 515 and the second uplink transmission 520 if the UE 115 is capable of multi-panel uplink transmission and if the uplink transmissions (e.g., the first uplink transmission 515 and the second uplink transmission 520) are scheduled for different panels of the UE 115. For example, the UE 115 may perform the first uplink transmission 515 via a first panel of the UE 115 and may perform the second uplink transmission 520 via a second panel of the UE 115. Additionally, or alternatively, the UE 115 may perform both the first uplink transmission 515 and the second uplink transmission 520 if the UE 115 is capable of simultaneous uplink transmission. Additionally, or alternatively, the UE 115 may perform both the first uplink transmission 515 and the second uplink transmission 520 if the UE 115 is capable of multi-panel uplink transmission and simultaneous uplink transmission. Additionally, or alternatively, the UE 115 may perform both the first uplink transmission 515 and the second uplink transmission 520 if the UE 115 is capable of multi-panel uplink transmission and if the first uplink transmission 515 and the second uplink transmission 520 are of a same channel type in the given component carrier. For example, the UE 115 may perform both the first uplink transmission 515 and the second uplink transmission 520 if both are PUCCH transmissions or if both are PUSCH transmissions. Alternatively, the UE 115 may perform one of the first uplink transmission 515 and the second uplink transmission 520 (and drop the other) if one is a PUCCH transmission and the other is a PUSCH transmission.

If one or more of such conditions are not satisfied, the UE 115 and the multiple TRPs may select one of the first uplink transmission 515 and the second uplink transmission 520 in accordance with a signaled or configured or predefined set of rules. In some implementations, the UE 115 may select to perform an uplink transmission that starts in an earlier symbol or slot based on logical time and may refrain from performing an overlapping part (e.g., a set of one or more symbols or a portion that may not be aligned with a symbol boundary) of an uplink transmission that starts in a later symbol or slot based on logical time. For example, the UE 115 may select to perform the uplink transmission 515 and may select to perform a portion of the uplink transmission 520 that is non-overlapping with the uplink transmission 515. In other words, the UE 115 may trim the uplink transmission 520 such that an actually performed portion of the uplink transmission 520 does not overlap with the uplink transmission 515 in actual time. In some other implementations, the UE 115 may select to perform an uplink transmission that starts in an earlier symbol or slot based on logical time and may drop an uplink transmission that starts in a later symbol or slot based on logical time. For example, the UE 115 may select to perform the uplink transmission 515 and may drop the uplink transmission 520.

In some implementations, the UE 115 may select to perform an uplink transmission that starts in an earlier symbol or slot based on actual time and may refrain from performing an overlapping part of an uplink transmission that starts in a later symbol or slot based on actual time. For example, the UE 115 may select to perform the uplink transmission 515 and may select to perform a portion of the uplink transmission 520 that is non-overlapping with the uplink transmission 515. In some other implementations, the UE 115 may select to perform an uplink transmission that starts in an earlier symbol or slot based on actual time and may drop an uplink transmission that starts in a later symbol or slot based on actual time. For example, the UE 115 may select to perform the uplink transmission 515 and may drop the uplink transmission 520.

In some implementations, the UE 115 may select to perform an uplink transmission associated with a specific TRP and may refrain from performing an overlapping part of an uplink transmission associated with another TRP. For example, if the specific TRP is the TRP 205 that schedules uplink transmissions associated with the TAG 225 (e.g., the first set of uplink transmissions 505), the UE 115 may select to perform the uplink transmission 515 and may select to perform a portion of the uplink transmission 520 that is non-overlapping with the uplink transmission 515. In some other implementations, the UE 115 may select to perform an uplink transmission associated with a specific TRP and may drop (e.g., not perform) an uplink transmission associated with another TRP. For example, if the specific TRP is the TRP 205 that schedules uplink transmissions associated with the TAG 225 (e.g., the first set of uplink transmissions 505), the UE 115 may select to perform the uplink transmission 515 and may drop the uplink transmission 520.

The UE 115 and the multiple TRPs may be configured or hardcoded with a rule for identifying the specific TRP or may receive or exchange signaling indicating the specific TRP. In some implementations, the specific TRP may be the TRP associated with a relatively smaller (e.g., smallest) TA value or the TRP associated with a relatively larger (e.g., largest) TA value. Additionally, or alternatively, the specific TRP may be the TRP associated with a specific Tag-Id parameter value (e.g., a relatively lower or lowest Tag-Id parameter value or a relatively higher or highest Tag-Id parameter value). Additionally, or alternatively, the specific TRP may be the TRP associated with a specific CORESETPoolIndex value (e.g., a CORESETPoolIndex value of 0). Additionally, or alternatively, the specific TRP may be the TRP associated with a specific closed loop power control index value (e.g., a specific closedLoopIndex value, such as a closedLoopIndex value of 0). In some aspects, different closed loop power control index values may be associated with different calculations for uplink transmit power and may be associated with different spatial relation information. As such, different closed loop power control index values may differentiate between different TRPs. Accordingly, a closed loop power control index may be equivalently referred to as a beam index, a power control index, or a TRP-specific power control index, among other examples.

In some implementations, and as illustrated by the transmission rule-based procedure 500, the UE 115 and the multiple TRPs may select both the uplink transmission 515 and the uplink transmission 520 in accordance with applying the second transmission rule. In accordance with the transmission rule-based procedure 500, the UE 115 and the multiple TRPs may apply a limitation for UE transmission due to direction conflict to select one or both of the uplink transmission 515 or the uplink transmission 520 in accordance with a slot format.

At 415-a, for example, the UE 115 and the multiple TRPs may select one or both of the uplink transmission 515 and the uplink transmission 520 in accordance with a configured or indicated slot format and the UE 115 may perform the selected one or both of the uplink transmission 515 and the uplink transmission 520. In some aspects, the UE 115 and the multiple TRPs may perform the selection in accordance with the logical time domain. For example, a logical time domain location n may be configured or indicated for downlink and the UE 115 and the multiple TRPs may drop the uplink transmission 515 based on the uplink transmission 515 being associated with one or more uplink transmissions initially scheduled for the logical time domain location n. The UE 115 may perform the uplink transmission 520 based on the uplink transmission 520 being associated with one or more uplink transmissions scheduled for the logical time domain location n+1 (which may not be configured for downlink).

FIG. 6 shows an example of a transmission rule-based procedure 600 that supports techniques for handling overlapping uplink transmissions associated with different TAGs in accordance with one or more aspects of the present disclosure. The transmission rule-based procedure 600 may implement or be implemented to realize aspects of the wireless communications system 100 or the wireless communications system 200. For example, a UE 115 (such as a UE 115 or a UE 115-a as illustrated by and described with reference to FIGS. 1 and 2, respectively) may receive control signaling from different TRPs (such as the TRP 205 and the TRP 210 as illustrated by and described with reference to FIG. 2) on different CORESETs of a same serving cell and the different CORESETs may be associated with different TAGs. In some implementations, the UE 115 and the multiple TRPs may apply the transmission rule-based procedure 600, which may be an example of the transmission rule-based procedure 400 in which 415-a is before 410-a, to resolve potential overlap between uplink transmissions based on one or both of logical time and actual time.

For example, in accordance with a scheduling 625 or a scheduling 630, the UE 115 may receive a first set of one or more control signaling messages from the TRP 205 on one or more CORESETs corresponding to a first CORESETPoolIndex value associated with a TAG 225 scheduling a first set of one or more uplink transmissions 605 (which may refer to one or both of an uplink transmission 605-a and an uplink transmission 605-b). The UE 115 may receive a second set of one or more control signaling messages from the TRP 210 on one or more CORESETs corresponding to a second CORESETPoolIndex value associated with a TAG 230 scheduling a second set of one or more uplink transmissions 610 (which may refer to one or both of an uplink transmission 610-a and an uplink transmission 610-b).

At 405-a, the UE 115 and the multiple TRPs may apply a first transmission rule to the first set of one or more uplink transmissions 605 and the second set of one or more uplink transmissions 610 in accordance with an overlapping between uplink transmissions of one or both of the uplink transmissions 605 and the uplink transmissions 610 in a logical time domain (e.g., a scheduled time domain). The UE 115 and the multiple TRPs may obtain a first uplink transmission 615 in a first logical time domain location (e.g., a slot or one or more symbols) and a second uplink transmission 620 in a second logical time domain location (e.g., a slot or one or more symbols) in accordance with applying the first transmission rule to the first set of one or more uplink transmissions 605 and the second set of one or more uplink transmissions 610. Additional details relating to such a step 405-a are described with reference to FIG. 5.

At 415-a, the UE 115 and the multiple TRPs may select one or both of the uplink transmission 615 and the uplink transmission 620 in accordance with a configured or indicated slot format and the UE 115 may perform the selected one or both of the uplink transmission 615 and the uplink transmission 620. In some aspects, the UE 115 and the multiple TRPs may perform the selection in accordance with the logical time domain. For example, a logical time domain location n may be configured or indicated for downlink and the UE 115 and the multiple TRPs may drop the uplink transmission 615 based on the uplink transmission 615 being associated with one or more uplink transmissions initially scheduled for the logical time domain location n. The UE 115 may perform the uplink transmission 620 based on the uplink transmission 620 being associated with one or more uplink transmissions scheduled for the logical time domain location n+1 (which may not be configured for downlink). As illustrated by the transmission rule-based procedure 600, the UE 115 and the multiple TRPs may resolve all overlaps between uplink transmissions at 415-a and, as such, may refrain from applying a second transmission rule associated with resolving overlapping uplink transmissions based on actual time at 410-a.

FIG. 7 shows an example of a transmission rule-based procedure 700 that supports techniques for handling overlapping uplink transmissions associated with different TAGs in accordance with one or more aspects of the present disclosure. The transmission rule-based procedure 700 may implement or be implemented to realize aspects of the wireless communications system 100 or the wireless communications system 200. For example, a UE 115 (such as a UE 115 or a UE 115-a as illustrated by and described with reference to FIGS. 1 and 2, respectively) may receive control signaling from different TRPs (such as the TRP 205 and the TRP 210 as illustrated by and described with reference to FIG. 2) on different CORESETs of a same serving cell and the different CORESETs may be associated with different TAGs. In some implementations, the UE 115 and the multiple TRPs may apply the transmission rule-based procedure 700, which may be an example of the transmission rule-based procedure 401 in which 410-b is before 415-b, to resolve potential overlap between uplink transmissions based on one or both of logical time and actual time.

For example, in accordance with a scheduling 725, the UE 115 may receive a first set of one or more control signaling messages from the TRP 205 on one or more CORESETs corresponding to a first CORESETPoolIndex value associated with a TAG 225 scheduling a first set of one or more uplink transmissions 705 (which may refer to one or more of an uplink transmission 705-a, an uplink transmission 705-b, an uplink transmission 705-c, and an uplink transmission 705-d). The UE 115 may receive a second set of one or more control signaling messages from the TRP 210 on one or more CORESETs corresponding to a second CORESETPoolIndex value associated with a TAG 230 scheduling a second set of one or more uplink transmissions 710 (which may refer to one or more of an uplink transmission 710-a, an uplink transmission 710-b, an uplink transmission 710-c, and an uplink transmission 710-d).

In accordance with the transmission rule-based procedure 700 and as described with reference to FIG. 4, the UE 115 and the multiple TRPs may apply a first transmission rule at 405-b and, in some implementations, the first transmission rule may include a first stage at 405-b-1 and a second stage at 405-b-2. The first stage may be associated with a resolving of overlapping uplink transmissions in logical time within a same TAG or associated with a same CORESETPoolIndex value. The second stage may be associated with a resolving of overlapping uplink transmissions in logical time across different TAGs or CORESETPoolIndex values.

At 405-b-1 (e.g., during the first stage), for example, the UE 115 and the multiple TRPs may employ multiplexing, prioritization, or dropping rules (e.g., UCI multiplexing, prioritization, or dropping rules) for overlapping uplink transmissions for overlapping uplink transmissions in logical time within a same TAG or associated with a same CORESETPoolIndex value. For example, the UE 115 may multiplex or drop, or do any combination thereof, one or more uplink transmissions of the first set of uplink transmissions 705 to obtain one or both of an uplink transmission 715-a (e.g., a first intermediate uplink transmission) in a first logical time domain location and an uplink transmission 715-b (e.g., a second intermediate uplink transmission) in a second logical time domain location. Similarly, the UE 115 may multiplex or drop, or do any combination thereof, one or more uplink transmissions of the second set of uplink transmissions 710 to obtain one or both of an uplink transmission 720-a (e.g., a third intermediate uplink transmission) in the first logical time domain location and an uplink transmission 720-b (e.g., a fourth intermediate uplink transmission) in the second logical time domain location. In a case of carrier aggregation, the UE 115 and the multiple TRPs may apply the first stage of the first transmission rule for uplink transmissions in a set of (e.g., all) component carriers in a same PUCCH group and associated with a same CORESETPoolIndex value (assuming a default value, such as a default value of 0, for CORESETPoolIndex if a value is not configured for an uplink transmission).

In accordance with the scheduling 725, the UE 115 may be scheduled to perform the uplink transmission 705-a, the uplink transmission 705-b, the uplink transmission 710-a, and the uplink transmission 710-b during a logical time domain location n (e.g., a logical time domain slot n) and may be scheduled to perform the uplink transmission 705-c, the uplink transmission 705-d, the uplink transmission 710-c, and the uplink transmission 710-d during a logical time domain location n+1 (e.g., a logical time domain slot n+1). Accordingly, the UE 115 may multiplex or drop, or do any combination thereof, one or both of the uplink transmission 705-a and the uplink transmission 705-b (in accordance with the uplink transmission 705-a and the uplink transmission 705-b being commonly associated with the TAG 225) to obtain the uplink transmission 715-a and may multiplex or drop, or do any combination thereof, one or both of the uplink transmission 710-a and the uplink transmission 710-b (in accordance with the uplink transmission 710-a and the uplink transmission 710-b being commonly associated with the TAG 230) to obtain the uplink transmission 720-a. The UE 115 may similarly multiplex or drop, or do any combination thereof, one or both of the uplink transmission 705-c and the uplink transmission 705-d (in accordance with the uplink transmission 705-c and the uplink transmission 705-d being commonly associated with the TAG 225) to obtain the uplink transmission 715-b and may multiplex or drop, or do any combination thereof, one or both of the uplink transmission 710-c and the uplink transmission 710-d (in accordance with the uplink transmission 710-c and the uplink transmission 710-d being commonly associated with the TAG 230) to obtain the uplink transmission 720-b.

At 405-b-2 (e.g., during the second stage), the UE 115 and the multiple TRPs may select one of the uplink transmission 715-a (e.g., the first intermediate uplink transmission) and the uplink transmission 720-a (e.g., the third intermediate uplink transmission) to obtain a first uplink transmission in the logical time domain location n and may select one of the uplink transmission 715-b (e.g., the second intermediate uplink transmission) and the uplink transmission 720-b (e.g., the fourth intermediate uplink transmission) to obtain a second uplink transmission in the logical time domain location n+1. In other words, the second stage may apply for overlapping uplink transmissions in logical time across different TAGs or associated with different CORESETPoolIndex values and, for any of such overlapping uplink transmissions, the UE 115 and the multiple TRPs may select one for the component carrier that is configured with multiple (e.g., two) CORESETPoolIndex values and multiple (e.g., two) corresponding TAGs.

In some implementations, the UE 115 may perform an uplink transmission that starts in a relatively earlier symbol or slot based on logical time and may refrain from performing an uplink transmission that starts in a relatively later symbol or slot based on logical time. For example, the UE 115 and the multiple TRPs may select the uplink transmission 715-a and drop the uplink transmission 720-a in accordance with the uplink transmission 715-a being scheduled to start in a relatively earlier symbol or slot in logical time. Additionally, or alternatively, the UE 115 may perform an uplink transmission associated with a specific TRP and may refrain from performing an uplink transmission associated with another TRP. For example, the UE 115 and the multiple TRPs may select uplink transmissions associated with the TAG 225 (e.g., associated with the TRP 205) or may select uplink transmissions associated with the TAG 230 (e.g., associated with the TRP 210) and may drop any non-selected uplink transmissions. In some aspects, and as illustrated by the transmission rule-based procedure 700, the UE 115 and the multiple TRPs may select the uplink transmission 715-a and the uplink transmission 720-b in accordance with the second stage of the first transmission rule.

At 410-b, the UE 115 and the multiple TRPs may apply a second transmission rule to the uplink transmission 715-a and the uplink transmission 720-b in accordance with an overlapping between the uplink transmission 715-a and the uplink transmission 720-b in an actual time domain (e.g., a time domain associated with or accounting for TAs associated the TAG 225 and the TAG 230). In accordance with the second transmission rule, the UE 115 and the multiple TRPs may determine which one or more uplink transmissions may be performed for the component carrier (e.g., the component carrier that is configured with two CORESETPoolIndex values and two corresponding TAGs) based on a satisfaction of a condition associated with a capability of the UE 115.

For example, the UE 115 may perform both the uplink transmission 715-a and the uplink transmission 720-b if one of various conditions is satisfied. In some implementations, the UE 115 may perform both the uplink transmission 715-a and the uplink transmission 720-b if the UE 115 is capable of multi-panel uplink transmission and if the uplink transmissions (e.g., the uplink transmission 715-a and the uplink transmission 720-b) are scheduled for different panels of the UE 115. Additionally, or alternatively, the UE 115 may perform both the uplink transmission 715-a and the uplink transmission 720-b if the UE 115 is capable of simultaneous uplink transmission. Additionally, or alternatively, the UE 115 may perform both the uplink transmission 715-a and the uplink transmission 720-b if the UE 115 is capable of multi-panel uplink transmission and simultaneous uplink transmission. Additionally, or alternatively, the UE 115 may perform both the uplink transmission 715-a and the uplink transmission 720-b if the UE 115 is capable of multi-panel uplink transmission and if the uplink transmission 715-a and the uplink transmission 720-b are of a same channel type (e.g., both the uplink transmission 715-a and the uplink transmission 720-b are PUCCH transmissions or both the uplink transmission 715-a and the uplink transmission 720-b are PUSCH transmissions) in the given component carrier.

If one or more of such conditions are not satisfied, the UE 115 and the multiple TRPs may select one of the uplink transmission 715-a and the uplink transmission 720-b in accordance with a configured or predefined set of rules. In some implementations, the UE 115 may select to perform an uplink transmission that starts in an earlier symbol or slot based on logical time and may refrain from performing an overlapping part of an uplink transmission that starts in a later symbol or slot based on logical time. In some other implementations, the UE 115 may select to perform an uplink transmission that starts in an earlier symbol or slot based on logical time and may drop an uplink transmission that starts in a later symbol or slot based on logical time.

In some implementations, the UE 115 may select to perform an uplink transmission that starts in an earlier symbol or slot based on actual time and may refrain from performing an overlapping part of an uplink transmission that starts in a later symbol or slot based on actual time. In some other implementations, the UE 115 may select to perform an uplink transmission that starts in an earlier symbol or slot based on actual time and may drop an uplink transmission that starts in a later symbol or slot based on actual time. In some implementations, the UE 115 may select to perform an uplink transmission associated with a specific TRP and may refrain from performing an overlapping part of an uplink transmission associated with another TRP. In some other implementations, the UE 115 may select to perform an uplink transmission associated with a specific TRP and may drop an uplink transmission associated with another TRP.

The UE 115 and the multiple TRPs may be configured or predefined with a rule for identifying the specific TRP or may receive or exchange signaling indicating the specific TRP. In some implementations, the specific TRP may be the TRP associated with a relatively smaller (e.g., a smallest) TA value or a TRP associated with a relatively larger (e.g., a largest) TA value. Additionally, or alternatively, the specific TRP may be the TRP associated with a specific Tag-Id parameter value (e.g., a relatively lower or lowest Tag-Id parameter value or a relatively higher or highest Tag-Id parameter value). Additionally, or alternatively, the specific TRP may be the TRP associated with a specific CORESETPoolIndex value (e.g., a CORESETPoolIndex value of 0). Additionally, or alternatively, the specific TRP may be the TRP associated with a specific closed loop power control index value (e.g., a specific closedLoopIndex value, such as a closedLoopIndex value of 0).

In some implementations, and as illustrated by the transmission rule-based procedure 700, the UE 115 and the multiple TRPs may select the uplink transmission 715-a and may drop the uplink transmission 720-b in accordance with applying the second transmission rule. In accordance with the transmission rule-based procedure 700, the UE 115 and the multiple TRPs may apply a limitation for UE transmission due to direction conflict to select whether to perform the uplink transmission 715-a or not.

At 415-b, for example, the UE 115 and the multiple TRPs may select to perform or drop the uplink transmission 715-a in accordance with a configured or indicated slot format and the UE 115 may perform or refrain from performing the uplink transmission 715-a accordingly. In some aspects, the UE 115 and the multiple TRPs may perform the selection in accordance with the logical time domain. For example, a logical time domain location n may be configured or indicated for downlink and the UE 115 and the multiple TRPs may drop the uplink transmission 715-a based on the uplink transmission 715-a being associated with one or more uplink transmissions initially scheduled for the logical time domain location n.

FIG. 8 shows an example of a transmission rule-based procedure 800 that supports techniques for handling overlapping uplink transmissions associated with different TAGs in accordance with one or more aspects of the present disclosure. The transmission rule-based procedure 800 may implement or be implemented to realize aspects of the wireless communications system 100 or the wireless communications system 200. For example, a UE 115 (such as a UE 115 or a UE 115-a as illustrated by and described with reference to FIGS. 1 and 2, respectively) may receive control signaling from different TRPs (such as the TRP 205 and the TRP 210 as illustrated by and described with reference to FIG. 2) on different CORESETs of a same serving cell and the different CORESETs may be associated with different TAGs. In some implementations, the UE 115 and the multiple TRPs may apply the transmission rule-based procedure 800, which may be an example of the transmission rule-based procedure 401 in which 415-b is before 410-b, to resolve potential overlap between uplink transmissions based on one or both of logical time and actual time.

For example, in accordance with a scheduling 825, the UE 115 may receive a first set of one or more control signaling messages from the TRP 205 on one or more CORESETs corresponding to a first CORESETPoolIndex value associated with a TAG 225 scheduling a first set of one or more uplink transmissions 805 (which may refer to one or more of an uplink transmission 805-a, an uplink transmission 805-b, an uplink transmission 805-c, and an uplink transmission 805-d). The UE 115 may receive a second set of one or more control signaling messages from the TRP 210 on one or more CORESETs corresponding to a second CORESETPoolIndex value associated with a TAG 230 scheduling a second set of one or more uplink transmissions 810 (which may refer to one or more of an uplink transmission 810-a, an uplink transmission 810-b, an uplink transmission 810-c, and an uplink transmission 810-d).

In accordance with the transmission rule-based procedure 800 and as described with reference to FIG. 4, the UE 115 and the multiple TRPs may apply a first transmission rule at 405-b and, in some implementations, the first transmission rule may include a first stage at 405-b-1 and a second stage at 405-b-2. The first stage may be associated with a resolving of overlapping uplink transmissions in logical time within a same TAG or associated with a same CORESETPoolIndex value. The second stage may be associated with a resolving of overlapping uplink transmissions in logical time across different TAGs or CORESETPoolIndex values.

At 405-b-1 (e.g., during the first stage), for example, the UE 115 and the multiple TRPs may employ multiplexing, prioritization, or dropping rules (e.g., UCI multiplexing, prioritization, or dropping rules) for overlapping uplink transmissions in logical time within a same TAG or associated with a same CORESETPoolIndex value. For example, the UE 115 may multiplex or drop, or do any combination thereof, one or more uplink transmissions of the first set of uplink transmissions 805 to obtain one or both of an uplink transmission 815-a (e.g., a first intermediate uplink transmission) in a first logical time domain location and an uplink transmission 815-b (e.g., a second intermediate uplink transmission) in a second logical time domain location. Similarly, the UE 115 may multiplex or drop, or do any combination thereof, one or more uplink transmissions of the second set of uplink transmissions 810 to obtain one or both of an uplink transmission 820-a (e.g., a third intermediate uplink transmission) in the first logical time domain location and an uplink transmission 820-b (e.g., a fourth uplink transmission) in the second logical time domain location. Additional details relating to such a multiplexing or dropping, or any combination thereof, in accordance with the scheduling 825 (which may be an example of the scheduling 725) is described in more detail with reference to FIG. 7.

At 405-b-2 (e.g., during the second stage), the UE 115 and the multiple TRPs may select one of the uplink transmission 815-a (e.g., the first intermediate uplink transmission) and the uplink transmission 820-a (e.g., the third intermediate uplink transmission) to obtain a first uplink transmission in the logical time domain location n and may select one of the uplink transmission 815-b (e.g., the second intermediate uplink transmission) and the uplink transmission 820-b (e.g., the fourth intermediate uplink transmission) to obtain a second uplink transmission in the logical time domain location n+1. In other words, the second stage may apply for overlapping uplink transmissions in logical time across different TAGs or associated with different CORESETPoolIndex values and, for any of such overlapping uplink transmissions, the UE 115 and the multiple TRPs may select one for the component carrier that is configured with multiple (e.g., two) CORESETPoolIndex values and multiple (e.g., two) corresponding TAGs. Additional details relating to such a second stage at 405-b-2 is described in more detail with reference to FIG. 7. In some aspects, and as illustrated by the transmission rule-based procedure 800, the UE 115 and the multiple TRPs may select the uplink transmission 815-a and the uplink transmission 820-b in accordance with the second stage of the first transmission rule.

At 415-b, the UE 115 and the multiple TRPs may select to perform one or both of the uplink transmission 815-a and the uplink transmission 820-b in accordance with a configured or indicated slot format. In some aspects, the UE 115 and the multiple TRPs may perform the selection in accordance with the logical time domain. For example, a logical time domain location n may be configured or indicated for downlink and the UE 115 and the multiple TRPs may drop the uplink transmission 815-a based on the uplink transmission 815-a being associated with one or more uplink transmissions initially scheduled for the logical time domain location n. The UE 115 and the multiple TRPs may select the uplink transmission 820-b based on the uplink transmission 820-b being associated with one or more uplink transmissions initially scheduled for the logical time domain location n+1 (which may not be configured or indicated for downlink and may be configured or indicated for uplink or flexible transmission).

At 410-b, the UE 115 and the multiple TRPs may apply a second transmission rule to resolve any remaining overlapping between uplink transmissions in an actual time domain (e.g., a time domain associated with or accounting for the TAG 225 and the TAG 230). In accordance with the second transmission rule, the UE 115 and the multiple TRPs may determine which one or more uplink transmissions may be performed for the component carrier (e.g., the component carrier that is configured with two CORESETPoolIndex values and two corresponding TAGs) based on a satisfaction of a condition associated with a capability of the UE 115. Additional details relating to such a satisfaction of a condition associated with a UE capability are described with reference to FIG. 7. In some implementations, and as illustrated by the transmission rule-based procedure 800, the UE 115 and the multiple TRPs may select the uplink transmission 820-b (e.g., based, in part, on a lack of any remaining overlapping). The UE 115 may perform the uplink transmission 820-b accordingly.

FIG. 9 shows an example of a transmission rule-based procedure 900 that supports techniques for handling overlapping uplink transmissions associated with different TAGs in accordance with one or more aspects of the present disclosure. The transmission rule-based procedure 900 may implement or be implemented to realize aspects of the wireless communications system 100 or the wireless communications system 200. For example, a UE 115 (such as a UE 115 or a UE 115-a as illustrated by and described with reference to FIGS. 1 and 2, respectively) may receive control signaling from different TRPs (such as the TRP 205 and the TRP 210 as illustrated by and described with reference to FIG. 2) on different CORESETs of a same serving cell and the different CORESETs may be associated with different TAGs. In some implementations, the UE 115 and the multiple TRPs may apply the transmission rule-based procedure 900, which may be an example of the transmission rule-based procedure 402 in which 410-c is before 415-c, to resolve potential overlap between uplink transmissions based on one or both of logical time and actual time.

For example, in accordance with a scheduling 925, the UE 115 may receive a first set of one or more control signaling messages from the TRP 205 on one or more CORESETs corresponding to a first CORESETPoolIndex value associated with a TAG 225 scheduling a first set of one or more uplink transmissions 905 (which may refer to one or more of an uplink transmission 905-a, an uplink transmission 905-b, an uplink transmission 905-c, and an uplink transmission 905-d). The UE 115 may receive a second set of one or more control signaling messages from the TRP 210 on one or more CORESETs corresponding to a second CORESETPoolIndex value associated with a TAG 230 scheduling a second set of one or more uplink transmissions 910 (which may refer to one or more of an uplink transmission 910-a, an uplink transmission 910-b, an uplink transmission 910-c, and an uplink transmission 910-d).

At 405-c, the UE 115 and the multiple TRPs may employ multiplexing, prioritization, or dropping rules (e.g., UCI multiplexing, prioritization, or dropping rules) for overlapping uplink transmissions (e.g., overlapping uplink channels) in logical time within a same TAG or associated with a same CORESETPoolIndex value. For example, the UE 115 may multiplex or drop, or do any combination thereof, one or more uplink transmissions of the first set of uplink transmissions 905 to obtain one or both of an uplink transmission 915-a in a first logical time domain location and an uplink transmission 915-b in a second logical time domain location. Similarly, the UE 115 may multiplex or drop, or do any combination thereof, one or more uplink transmissions of the second set of uplink transmissions 910 to obtain one or both of an uplink transmission 920-a in the first logical time domain location and an uplink transmission 920-b in the second logical time domain location. In a case of carrier aggregation, the UE 115 and the multiple TRPs may apply the first stage of the first transmission rule for uplink transmissions in a set of (e.g., all) component carriers in a same PUCCH group and associated with a same CORESETPoolIndex value (assuming a default value, such as a default value of 0, for CORESETPoolIndex if a value is not configured for an uplink transmission).

In accordance with the scheduling 925, the UE 115 may be scheduled to perform the uplink transmission 905-a, the uplink transmission 905-b, the uplink transmission 910-a, and the uplink transmission 910-b during a logical time domain location n (e.g., a logical time domain slot n) and may be scheduled to perform the uplink transmission 905-c, the uplink transmission 905-d, the uplink transmission 910-c, and the uplink transmission 910-d during a logical time domain location n+1 (e.g., a logical time domain slot n+1). Accordingly, the UE 115 may multiplex or drop, or do any combination thereof, one or both of the uplink transmission 905-a and the uplink transmission 905-b (both being commonly associated with the TAG 225) to obtain the uplink transmission 915-a and may multiplex or drop, or do any combination thereof, one or both of the uplink transmission 910-a and the uplink transmission 910-b (both being associated with the TAG 230) to obtain the uplink transmission 920-a. The UE 115 may similarly multiplex or drop, or do any combination thereof, one or both of the uplink transmission 905-c and the uplink transmission 905-d to obtain the uplink transmission 915-b and may multiplex or drop, or do any combination thereof, one or both of the uplink transmission 910-c and the uplink transmission 910-d to obtain the uplink transmission 920-b.

At 410-c, the UE 115 and the multiple TRPs may apply a second transmission rule to the uplink transmission 915-a and the uplink transmission 915-b (e.g., a first set of one or more uplink transmissions) and to the uplink transmission 920-a and the uplink transmission 920-b (e.g., a second set of one or more uplink transmissions) in accordance with an overlapping between any one or more of the uplink transmission 915-a, the uplink transmission 915-b, the uplink transmission 920-a, and the uplink transmission 920-b in an actual time domain (e.g., a time domain associated with or accounting for TAs associated with the TAG 225 and the TAG 230). In accordance with the second transmission rule, the UE 115 and the multiple TRPs may determine which one or more uplink transmissions may be performed for the component carrier (e.g., the component carrier that is configured with two CORESETPoolIndex values and two corresponding TAGs) based on a satisfaction of a condition associated with a capability of the UE 115.

For example, the UE 115 may perform each of two or more overlapping uplink transmissions if one of various conditions is satisfied. In some implementations, the UE 115 may perform two or more overlapping uplink transmissions if the UE 115 is capable of multi-panel uplink transmission and if the overlapping uplink transmissions are scheduled for different panels of the UE 115. Additionally, or alternatively, the UE 115 may perform two or more overlapping uplink transmissions if the UE 115 is capable of simultaneous uplink transmission. Additionally, or alternatively, the UE 115 may perform two or more overlapping uplink transmissions if the UE 115 is capable of multi-panel uplink transmission and simultaneous uplink transmission. Additionally, or alternatively, the UE 115 may perform two or more overlapping uplink transmissions if the UE 115 is capable of multi-panel uplink transmission and if the two or more overlapping uplink transmissions are of a same channel type in the given component carrier.

If one or more of such conditions are not satisfied, the UE 115 and the multiple TRPs may select one of two or more overlapping uplink transmissions in accordance with a configured or predefined set of rules. In some implementations, the UE 115 may select to perform an uplink transmission that starts in an earlier symbol or slot based on logical time and may refrain from performing an overlapping part of an uplink transmission that starts in a later symbol or slot based on logical time. In some other implementations, the UE 115 may select to perform an uplink transmission that starts in an earlier symbol or slot based on logical time and may drop an uplink transmission that starts in a later symbol or slot based on logical time.

In some implementations, the UE 115 may select to perform an uplink transmission that starts in an earlier symbol or slot based on actual time and may refrain from performing an overlapping part of an uplink transmission that starts in a later symbol or slot based on actual time. In some other implementations, the UE 115 may select to perform an uplink transmission that starts in an earlier symbol or slot based on actual time and may drop an uplink transmission that starts in a later symbol or slot based on actual time. In some implementations, the UE 115 may select to perform an uplink transmission associated with a specific TRP and may refrain from performing an overlapping part of an uplink transmission associated with another TRP. In some other implementations, the UE 115 may select to perform an uplink transmission associated with a specific TRP and may drop an uplink transmission associated with another TRP.

The UE 115 and the multiple TRPs may be configured or hardcoded with a rule for identifying the specific TRP or may receive or exchange signaling indicating the specific TRP. In some implementations, the specific TRP may be the TRP associated with a relatively smaller (e.g., a smallest) TA value or a TRP associated with a relatively larger (e.g., a largest) TA value. Additionally, or alternatively, the specific TRP may be the TRP associated with a specific Tag-Id parameter value (e.g., a relatively lower or lowest Tag-Id parameter value or a relatively higher or highest Tag-Id parameter value). Additionally, or alternatively, the specific TRP may be the TRP associated with a specific CORESETPoolIndex value (e.g., a CORESETPoolIndex value of 0). Additionally, or alternatively, the specific TRP may be the TRP associated with a specific closed loop power control index value (e.g., a specific closedLoopIndex value, such as a closedLoopIndex value of 0).

In some implementations, and as illustrated by the transmission rule-based procedure 900 in an option 930, the UE 115 and the multiple TRPs may select the uplink transmission 920-a, the uplink transmission 920-b, and the uplink transmission 915-b and may drop the uplink transmission 915-a. In some implementations, and as illustrated by the transmission rule-based procedure 900 in an option 935, the UE 115 and the multiple TRPs may select the uplink transmission 915-a and the uplink transmission 915-b and may drop the uplink transmission 920-a and the uplink transmission 920-b. In accordance with the transmission rule-based procedure 900, the UE 115 and the multiple TRPs may apply a limitation for UE transmission due to direction conflict to select whether to perform one or more of the uplink transmissions selected at 410-c.

At 415-c, for example, the UE 115 and the multiple TRPs may select to perform or drop the uplink transmission 920-a, the uplink transmission 920-b, and the uplink transmission 915-b in the option 930 and in accordance with a configured or indicated slot format. In the option 935, the UE 115 and the multiple TRPs may select to perform or drop the uplink transmission 915-a and the uplink transmission 915-b in accordance with a configured or indicated slot format. In some aspects, the UE 115 and the multiple TRPs may perform the selection in accordance with the logical time domain. For example, a logical time domain location n may be configured or indicated for downlink. Accordingly, in the option 930, the UE 115 and the multiple TRPs may drop the uplink transmission 920-a based on the uplink transmission 920-a being associated with one or more uplink transmissions initially scheduled for the logical time domain location n and the UE 115 may perform the uplink transmission 915-b and the uplink transmission 920-b. In the option 935, the UE 115 and the multiple TRPs may drop the uplink transmission 915-a based on the uplink transmission 915-a being associated with one or more uplink transmissions initially scheduled for the logical time domain location n and the UE 115 may perform the uplink transmission 915-b.

FIG. 10 shows an example of a transmission rule-based procedure 1000 that supports techniques for handling overlapping uplink transmissions associated with different TAGs in accordance with one or more aspects of the present disclosure. The transmission rule-based procedure 1000 may implement or be implemented to realize aspects of the wireless communications system 100 or the wireless communications system 200. For example, a UE 115 (such as a UE 115 or a UE 115-a as illustrated by and described with reference to FIGS. 1 and 2, respectively) may receive control signaling from different TRPs (such as the TRP 205 and the TRP 210 as illustrated by and described with reference to FIG. 2) on different CORESETs of a same serving cell and the different CORESETs may be associated with different TAGs. In some implementations, the UE 115 and the multiple TRPs may apply the transmission rule-based procedure 1000, which may be an example of the transmission rule-based procedure 402 in which 415-c is before 410-c, to resolve potential overlap between uplink transmissions based on one or both of logical time and actual time.

For example, in accordance with a scheduling 1025, the UE 115 may receive a first set of one or more control signaling messages from the TRP 205 on one or more CORESETs corresponding to a first CORESETPoolIndex value associated with a TAG 225 scheduling a first set of one or more uplink transmissions 1005 (which may refer to one or more of an uplink transmission 1005-a, an uplink transmission 1005-b, an uplink transmission 1005-c, and an uplink transmission 1005-d). The UE 115 may receive a second set of one or more control signaling messages from the TRP 210 on one or more CORESETs corresponding to a second CORESETPoolIndex value associated with a TAG 230 scheduling a second set of one or more uplink transmissions 1010 (which may refer to one or more of an uplink transmission 1010-a, an uplink transmission 1010-b, an uplink transmission 1010-c, and an uplink transmission 1010-d).

At 405-c, the UE 115 and the multiple TRPs may employ multiplexing, prioritization, or dropping rules (e.g., UCI multiplexing, prioritization, or dropping rules) for overlapping uplink transmissions for overlapping uplink transmissions (e.g., overlapping uplink channels) in logical time within a same TAG or associated with a same CORESETPoolIndex value. For example, the UE 115 may multiplex or drop, or do any combination thereof, one or more uplink transmissions of the first set of uplink transmissions 1005 to obtain one or both of an uplink transmission 1015-a in a first logical time domain location and an uplink transmission 1015-b in a second logical time domain location. Similarly, the UE 115 may multiplex or drop, or do any combination thereof, one or more uplink transmissions of the second set of uplink transmissions 1010 to obtain one or both of an uplink transmission 1020-a in the first logical time domain location and an uplink transmission 1020-b in the second logical time domain location. In a case of carrier aggregation, the UE 115 and the multiple TRPs may apply the first stage of the first transmission rule for uplink transmissions in a set of (e.g., all) component carriers in a same PUCCH group and associated with a same CORESETPoolIndex value (assuming a default value, such as a default value of 0, for CORESETPoolIndex if a value is not configured for an uplink transmission). Additional details relating to such a resolving of overlapping uplink transmissions with a same TAG or associated with a same CORESETPoolIndex value are described with reference to FIG. 9.

At 415-c, the UE 115 and the multiple TRPs may select to perform or drop the uplink transmission 1015-a, the uplink transmission 1015-b, the uplink transmission 1020-a, and the uplink transmission 1020-b in accordance with a configured or indicated slot format. In some aspects, the UE 115 and the multiple TRPs may perform the selection in accordance with the logical time domain. For example, a logical time domain location n may be configured or indicated for downlink and the UE 115 may refrain from performing uplink transmissions scheduled during the logical time domain location n. Accordingly, the UE 115 and the multiple TRPs may drop the uplink transmission 1015-a and the uplink transmission 1020-a based on the uplink transmission 1015-a and the uplink transmission 1020-a being associated with one or more uplink transmissions initially scheduled for the logical time domain location n. Likewise, the UE 115 and the multiple TRPs may select the uplink transmission 1015-b and the uplink transmission 1020-b based on the uplink transmission 1015-b and the uplink transmission 1020-b being associated with one or more uplink transmissions initially scheduled for the logical time domain location n+1.

At 410-c, the UE 115 and the multiple TRPs may apply a second transmission rule to the uplink transmission 1015-b (e.g., a first set of one or more uplink transmissions) and to the uplink transmission 1020-b (e.g., a second set of one or more uplink transmissions) to resolve any potential overlapping between the uplink transmission 1015-b and the uplink transmission 1020-b in an actual time domain (e.g., a time domain associated with or accounting for the TAG 225 and the TAG 230). In accordance with the second transmission rule, the UE 115 and the multiple TRPs may determine which one or more uplink transmissions may be performed for the component carrier (e.g., the component carrier that is configured with two CORESETPoolIndex values and two corresponding TAGs) based on a satisfaction of a condition associated with a capability of the UE 115. As illustrated by the transmission rule-based procedure 1000, the UE 115 may perform both the uplink transmission 1015-b and the uplink transmission 1020-b (e.g., based, in part, on a lack of overlapping between the uplink transmission 1015-b and the uplink transmission 1020-b in actual time).

FIG. 11 shows an example of a transmission rule-based procedure 1100 that supports techniques for handling overlapping uplink transmissions associated with different TAGs in accordance with one or more aspects of the present disclosure. The transmission rule-based procedure 1100 may implement or be implemented to realize aspects of the wireless communications system 100 or the wireless communications system 200. For example, a UE 115 (such as a UE 115 or a UE 115-a as illustrated by and described with reference to FIGS. 1 and 2, respectively) may receive control signaling from different TRPs (such as the TRP 205 and the TRP 210 as illustrated by and described with reference to FIG. 2) on different CORESETs of a same serving cell and the different CORESETs may be associated with different TAGs. In some implementations, the UE 115 and the multiple TRPs may apply the transmission rule-based procedure 1100, which may be an example of the transmission rule-based procedure 403, to resolve potential overlap between uplink transmissions based on one or both of logical time and actual time.

For example, in accordance with a scheduling 1125, the UE 115 may receive a first set of one or more control signaling messages from the TRP 205 on one or more CORESETs corresponding to a first CORESETPoolIndex value associated with a TAG 225 scheduling a first set of one or more uplink transmissions 1105 (which may refer to one or more of an uplink transmission 1105-a, an uplink transmission 1105-b, an uplink transmission 1105-c, and an uplink transmission 1105-d). The UE 115 may receive a second set of one or more control signaling messages from the TRP 210 on one or more CORESETs corresponding to a second CORESETPoolIndex value associated with a TAG 230 scheduling a second set of one or more uplink transmissions 1110 (which may refer to one or more of an uplink transmission 1110-a, an uplink transmission 1110-b, an uplink transmission 1110-c, and an uplink transmission 1110-d).

At 405-d, the UE 115 and the multiple TRPs may apply a first transmission rule to the first set of uplink transmissions 1105 and to the second set of uplink transmissions 1110 to resolve any potential overlapping in an actual time domain (e.g., a time domain associated with or accounting for TAs associated with the TAG 225 and the TAG 230). In some implementations, the UE 115 and the multiple TRPs may apply the first transmission rule to resolve overlapping uplink transmissions in actual time across different TAGs or associated with different CORESETPoolIndex values. Further, in accordance with the first transmission rule, the UE 115 and the multiple TRPs may determine which one or more uplink transmissions may be performed for the component carrier (e.g., the component carrier that is configured with two CORESETPoolIndex values and two corresponding TAGs) based on a satisfaction of a condition associated with a capability of the UE 115.

In some implementations, the UE 115 and the multiple TRPs may apply the first transmission rule to the first set of uplink transmissions 1105 and the second set of uplink transmissions 1110 to select one of the two sets of uplink transmissions. For example, the UE 115 and the multiple TRPs may resolve an overlapping in actual time by selecting uplink transmissions associated with a specific TRP and dropping uplink transmissions associated with another TRP. The UE 115 and the multiple TRPs may be configured with a rule for identifying the specific TRP or may receive or exchange signaling indicating the specific TRP. In some implementations, the specific TRP may be the TRP associated with a relatively smaller (e.g., a smallest) TA value or a TRP associated with a relatively larger (e.g., a largest) TA value. Additionally, or alternatively, the specific TRP may be the TRP associated with a specific Tag-Id parameter value (e.g., a relatively lower or lowest Tag-Id parameter value or a relatively higher or highest Tag-Id parameter value). Additionally, or alternatively, the specific TRP may be the TRP associated with a specific CORESETPoolIndex value (e.g., a CORESETPoolIndex value of 0). Additionally, or alternatively, the specific TRP may be the TRP associated with a specific closed loop power control index value (e.g., a specific closedLoopIndex value, such as a closedLoopIndex value of 0).

As illustrated by the transmission rule-based procedure 1100, the UE 115 and the multiple TRPs may select the first set of uplink transmissions 1105 and may identify the second set of uplink transmissions 1110 as dropped. Upon applying the first transmission rule to resolve overlapping uplink transmissions across TAGs or CORESETPoolIndex values in actual time, the UE 115 and the multiple TRPs may apply a second transmission rule to resolve overlapping uplink transmissions in logical time (e.g., regardless of TAG or CORESETPoolIndex value).

At 410-d, for example, the UE 115 and the multiple TRPs may apply a second transmission rule to the first set of uplink transmissions 1105 in accordance with an overlapping between uplink transmissions of the first set of uplink transmissions 1105 in the logical time domain. As part of the second transmission rule, the UE 115 and the multiple TRPs may employ multiplexing, prioritization, or dropping rules (e.g., UCI multiplexing, prioritization, or dropping rules) for overlapping uplink transmissions (e.g., overlapping uplink channels) in logical time. For example, the UE 115 may multiplex or drop, or do any combination thereof, one or more uplink transmissions of the first set of uplink transmissions 1105 to obtain one or both of an uplink transmission 1115-a in a first logical time domain location and an uplink transmission 1115-b in a second logical time domain location. In a case of carrier aggregation, the UE 115 and the multiple TRPs may apply the first stage of the first transmission rule for uplink transmissions in a set of (e.g., all) component carriers in a same PUCCH group and associated with a same CORESETPoolIndex value (assuming a default value, such as a default value of 0, for CORESETPoolIndex if a value is not configured for an uplink transmission).

At 415-d, the UE 115 and the multiple TRPs may select to perform or drop the uplink transmission 1115-a and the uplink transmission 1115-b in accordance with a configured or indicated slot format. In some aspects, the UE 115 and the multiple TRPs may perform the selection in accordance with the logical time domain. For example, a logical time domain location n may be configured or indicated for downlink and the UE 115 may refrain from performing uplink transmissions scheduled during the logical time domain location n. Accordingly, the UE 115 and the multiple TRPs may drop the uplink transmission 1115-a based on the uplink transmission 1115-a being associated with one or more uplink transmissions initially scheduled for the logical time domain location n. Likewise, the UE 115 and the multiple TRPs may select the uplink transmission 1115-b based on the uplink transmission 1115-b being associated with one or more uplink transmissions initially scheduled for the logical time domain location n+1.

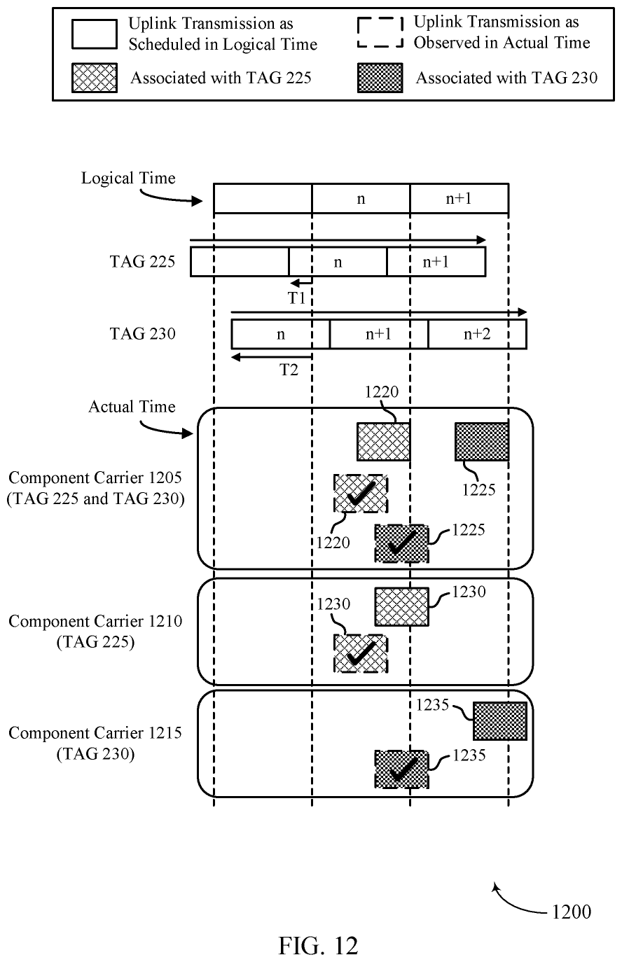

FIG. 12 shows an example of a carrier aggregation technique 1200 that supports techniques for handling overlapping uplink transmissions associated with different TAGs in accordance with one or more aspects of the present disclosure. The carrier aggregation technique 1200 may implement or be implemented to realize aspects of the wireless communications system 100 or the wireless communications system 200. For example, a UE 115 (such as a UE 115 or a UE 115-a as illustrated by and described with reference to FIGS. 1 and 2, respectively) may receive control signaling from different TRPs (such as the TRP 205 and the TRP 210 as illustrated by and described with reference to FIG. 2) on different CORESETs of a same serving cell and the different CORESETs may be associated with different TAGs. In some implementations, the UE 115 and the multiple TRPs may employ the carrier aggregation technique 1200 in scenarios in which the UE 115 communicates with the multiple TRPs on the serving cell using carrier aggregation (e.g., in scenarios in which the UE 115 transmits or receives on multiple component carriers of the serving cell).

For example, the UE 115 may receive first control signaling from the TRP 205 on a CORESET corresponding to a first CORESETPoolIndex value associated with the TAG 225 scheduling an uplink transmission 1220 on a component carrier 1205 and may receive second control signaling from the TRP 210 on a CORESET corresponding to a second CORESETPoolIndex value associated with the TAG 230 scheduling an uplink transmission 1225 on the component carrier 1205. As such, the component carrier 1205 may be associated with the TAG 225 and the TAG 230. Further, the UE 115 may receive first control signaling from the TRP 205 on a CORESET corresponding to the first CORESETPoolIndex value associated with the TAG 225 scheduling an uplink transmission 1230 on a component carrier 1210 and second control signaling from the TRP 210 on a CORESET corresponding to the second CORESETPoolIndex value associated with the TAG 230 scheduling an uplink transmission 1235 on a component carrier 1215. As such, the component carrier 1210 may be associated with the TAG 225 and the component carrier 1215 may be associated with the TAG 230.

In accordance with such a carrier aggregation in which uplink transmissions on a same component carrier or across multiple component carriers may overlap in time, the UE 115 and the multiple TRPs may resolve any potential overlapping between uplink transmissions based on one or both of actual time and logical time on a same component carrier or across multiple component carriers in accordance with various options or alternatives. For example, the UE 115 and the multiple TRPs may apply the second transmission rule as described at 410-a, 410-b, or 410-c, the first transmission rule at 405-d, or the second stage of the first transmission rule at 405-b-2 to resolve overlapping between uplink transmissions based on logical time or actual time and, in a case of carrier aggregation, the UE 115 and the multiple TRPs may apply the second transmission rule as described at 410-a, 410-b, or 410-c, the first transmission rule at 405-d, or the second stage of the first transmission rule at 405-b-2 according to any of the described options or alternatives.

In some implementations, the UE 115 and the multiple TRPs may resolve overlapping between uplink transmissions in actual time for each component carrier (e.g., per component carrier) that is configured with multiple (e.g., two) CORESETPoolIndex values and multiple (e.g., two) corresponding TAGs. In such implementations, for example, the UE 115 and the multiple TRPs may resolve overlapping between uplink transmissions in actual time on the component carrier 1205.

Additionally, or alternatively, the UE 115 and the multiple TRPs may resolve overlapping between uplink transmissions in actual time for each band (e.g., per band, such as across a set of or all component carriers in a band) if at least one component carrier in the band is configured with multiple (e.g., two) CORESETPoolIndex values and multiple (e.g., two) corresponding TAGs and other component carriers in the band are configured with at least one of the multiple TAGs. In other words, the other component carriers in the band may be configured with at least one of the same TAGs that are configured for the at least one component carrier that is configured with multiple CORESETPoolIndex values and multiple corresponding TAGs (and not configured with a TAG outside of the TAGs that are configured for the at least one component carrier that is configured with multiple CORESETPoolIndex values and multiple corresponding TAGs).

Additionally, or alternatively, the UE 115 and the multiple TRPs may resolve overlapping between uplink transmissions in actual time for each PUCCH group (e.g., per PUCCH group, such as across a set of or all component carriers in a PUCCH group) if at least one component carrier in the PUCCH group is configured with multiple (e.g., two) CORESETPoolIndex values and multiple (e.g., two) corresponding TAGs and other component carriers in the PUCCH group are configured with at least one of the multiple TAGs. In other words, the other component carriers in the PUCCH group may be configured with at least one of the same TAGs that are configured for the at least one component carrier that is configured with multiple CORESETPoolIndex values and multiple corresponding TAGs (and not configured with a TAG outside of the TAGs that are configured for the at least one component carrier that is configured with multiple CORESETPoolIndex values and multiple corresponding TAGs).

Additionally, or alternatively, the UE 115 and the multiple TRPs may resolve overlapping between uplink transmissions in actual time for each set of component carriers (e.g., per set of component carriers, such as across a subset of or all component carriers in a set of component carriers). A set of component carriers may be defined or configured such that at least one component carrier in the set of component carriers is configured with multiple (e.g., two) CORESETPoolIndex values and multiple (e.g., two) corresponding TAGs and other component carriers in the set of component carriers are configured with at least one of the multiple TAGs. In other words, the other component carriers in the set of component carriers may be configured with at least one of the same TAGs that are configured for the at least one component carrier that is configured with multiple CORESETPoolIndex values and multiple corresponding TAGs (and not configured with a TAG outside of the TAGs that are configured for the at least one component carrier that is configured with multiple CORESETPoolIndex values and multiple corresponding TAGs).

As illustrated by the carrier aggregation technique 1200, the UE 115 and the multiple TRPs may select overlapping uplink transmissions in various (e.g., all) component carriers on a per component carrier basis, in a band, in a PUCCH group, or in a set of component carriers. For example, the UE 115 and the multiple TRPs may select both the uplink transmission 1220 and the uplink transmission 1225 on the component carrier 1205, the uplink transmission 1230 on the component carrier 1210, and the uplink transmission 1235 on the component carrier 1215. Alternatively, the UE 115 and the multiple TRPs may drop one or more of overlapping uplink transmissions in various (e.g., all) component carriers on a per component carrier basis, in a band, in a PUCCH group, or in a set of component carriers. In some aspects, the UE 115 and the multiple TRPs may select an uplink transmission in each component carrier in a band, PUCCH group, or set of component carriers that is associated with a specific TRP and drop uplink transmissions associated with other TRPs. For example, the UE 115 and the multiple TRPs may select uplink transmissions associated with the TAG 225 (e.g., the TRP 205) and may drop uplink transmissions associated with the TAG 230 (e.g., the TRP 210). As such, the UE 115 and the multiple TRPs may select the uplink transmission 1220 and drop the uplink transmission 1225 on the component carrier 1205, select the uplink transmission 1230 on the component carrier 1210, and drop the uplink transmission 1235 on the component carrier 1215.

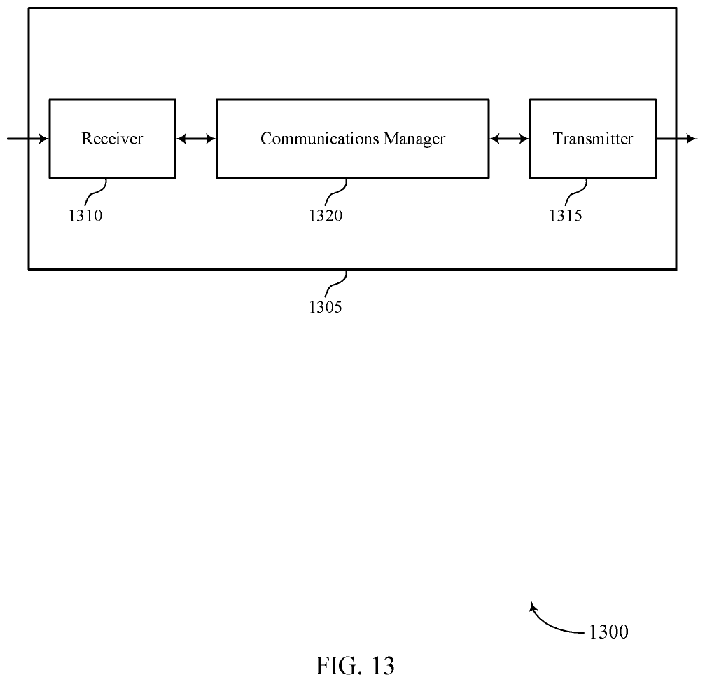

FIG. 13 shows a block diagram 1300 of a device 1305 that supports techniques for handling overlapping uplink transmissions associated with different TAGs in accordance with one or more aspects of the present disclosure. The device 1305 may be an example of aspects of a UE 115 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to techniques for handling overlapping uplink transmissions associated with different TAGs). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to techniques for handling overlapping uplink transmissions associated with different TAGs). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations thereof or various components thereof may be examples of means for performing various aspects of techniques for handling overlapping uplink transmissions associated with different TAGs as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a UE in accordance with examples as disclosed herein. For example, the communications manager 1320 may be configured as or otherwise support a means for receiving, over a first CORESET associated with a first CORESET pool index of a serving cell, first control signaling scheduling a first set of one or more uplink transmissions associated with a first TAG. The communications manager 1320 may be configured as or otherwise support a means for receiving, over a second CORESET associated with a second CORESET pool index of the serving cell, second control signaling scheduling a second set of one or more uplink transmissions associated with a second TAG. The communications manager 1320 may be configured as or otherwise support a means for applying, to the first set of one or more uplink transmissions and the second set of one or more uplink transmissions in accordance with an overlapping between uplink transmissions of one or both of the first set of one or more uplink transmissions and the second set of one or more uplink transmissions in a scheduled time domain, a first transmission rule to obtain a first uplink transmission in a first scheduled time domain location and a second uplink transmission in a second scheduled time domain location. The communications manager 1320 may be configured as or otherwise support a means for applying a second transmission rule to the first uplink transmission and the second uplink transmission in accordance with an overlapping between the first uplink transmission and the second uplink transmission in an observed time domain, where the observed time domain is associated with the first TAG and the second TAG. The communications manager 1320 may be configured as or otherwise support a means for performing one or both of the first uplink transmission and the second uplink transmission in accordance with the second transmission rule.

Additionally, or alternatively, the communications manager 1320 may support wireless communication at a UE in accordance with examples as disclosed herein. For example, the communications manager 1320 may be configured as or otherwise support a means for receiving, over a first CORESET associated with a first CORESET pool index of a serving cell, first control signaling scheduling a first set of multiple uplink transmissions associated with a first TAG. The communications manager 1320 may be configured as or otherwise support a means for receiving, over a second CORESET associated with a second CORESET pool index of the serving cell, second control signaling scheduling a second set of multiple uplink transmissions associated with a second TAG. The communications manager 1320 may be configured as or otherwise support a means for applying, to obtain a first set of one or more uplink transmissions associated with the first TAG and a second set of one or more uplink transmissions associated with the second TAG, a first transmission rule to each of the first set of multiple uplink transmissions and the second set of multiple uplink transmissions independently and in accordance with an overlapping between uplink transmissions of the first set of multiple uplink transmissions in a scheduled time domain, and between uplink transmissions of the second set of multiple uplink transmissions in the scheduled time domain. The communications manager 1320 may be configured as or otherwise support a means for applying a second transmission rule to the first set of one or more uplink transmissions and the second set of one or more uplink transmissions in accordance with an overlapping between the first set of one or more uplink transmissions and the second set of one or more uplink transmissions in an observed time domain, where the observed time domain is associated with the first TAG and the second TAG. The communications manager 1320 may be configured as or otherwise support a means for performing one or more of the first set of one or more uplink transmissions and the second set of one or more uplink transmissions in accordance with the second transmission rule.

Additionally, or alternatively, the communications manager 1320 may support wireless communication at a UE in accordance with examples as disclosed herein. For example, the communications manager 1320 may be configured as or otherwise support a means for receiving, over a first CORESET associated with a first CORESET pool index of a serving cell, first control signaling scheduling a first set of one or more uplink transmissions associated with a first TAG. The communications manager 1320 may be configured as or otherwise support a means for receiving, over a second CORESET associated with a second CORESET pool index of the serving cell, second control signaling scheduling a second set of one or more uplink transmissions associated with a second TAG. The communications manager 1320 may be configured as or otherwise support a means for applying, to the first set of one or more uplink transmissions and the second set of one or more uplink transmissions in accordance with an overlapping between the first set of one or more uplink transmissions and the second set of one or more uplink transmissions in an observed time domain, a first transmission rule to select the first set of one or more uplink transmissions, where the observed time domain is associated with the first TAG and the second TAG. The communications manager 1320 may be configured as or otherwise support a means for applying a second transmission rule to the first set of one or more uplink transmissions in accordance with an overlapping between uplink transmissions of the first set of one or more uplink transmissions in a scheduled time domain to obtain a third set of one or more uplink transmissions. The communications manager 1320 may be configured as or otherwise support a means for performing one or more uplink transmissions of the third set of one or more uplink transmissions in accordance with the second transmission rule.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for reduced processing, reduced power consumption, and more efficient utilization of communication resources.

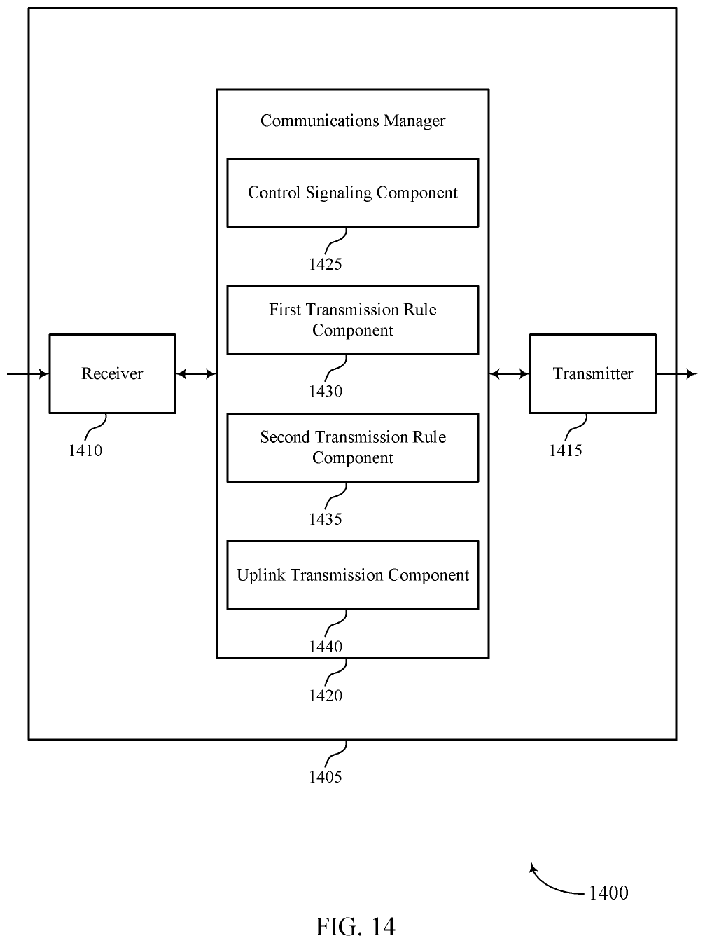

FIG. 14 shows a block diagram 1400 of a device 1405 that supports techniques for handling overlapping uplink transmissions associated with different TAGs in accordance with one or more aspects of the present disclosure. The device 1405 may be an example of aspects of a device 1305 or a UE 115 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to techniques for handling overlapping uplink transmissions associated with different TAGs). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to techniques for handling overlapping uplink transmissions associated with different TAGs). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of techniques for handling overlapping uplink transmissions associated with different TAGs as described herein. For example, the communications manager 1420 may include a control signaling component 1425, a first transmission rule component 1430, a second transmission rule component 1435, an uplink transmission component 1440, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a UE in accordance with examples as disclosed herein. The control signaling component 1425 may be configured as or otherwise support a means for receiving, over a first CORESET associated with a first CORESET pool index of a serving cell, first control signaling scheduling a first set of one or more uplink transmissions associated with a first TAG. The control signaling component 1425 may be configured as or otherwise support a means for receiving, over a second CORESET associated with a second CORESET pool index of the serving cell, second control signaling scheduling a second set of one or more uplink transmissions associated with a second TAG. The first transmission rule component 1430 may be configured as or otherwise support a means for applying, to the first set of one or more uplink transmissions and the second set of one or more uplink transmissions in accordance with an overlapping between uplink transmissions of one or both of the first set of one or more uplink transmissions and the second set of one or more uplink transmissions in a scheduled time domain, a first transmission rule to obtain a first uplink transmission in a first scheduled time domain location and a second uplink transmission in a second scheduled time domain location. The second transmission rule component 1435 may be configured as or otherwise support a means for applying a second transmission rule to the first uplink transmission and the second uplink transmission in accordance with an overlapping between the first uplink transmission and the second uplink transmission in an observed time domain, where the observed time domain is associated with the first TAG and the second TAG. The uplink transmission component 1440 may be configured as or otherwise support a means for performing one or both of the first uplink transmission and the second uplink transmission in accordance with the second transmission rule.

Additionally, or alternatively, the communications manager 1420 may support wireless communication at a UE in accordance with examples as disclosed herein. The control signaling component 1425 may be configured as or otherwise support a means for receiving, over a first CORESET associated with a first CORESET pool index of a serving cell, first control signaling scheduling a first set of multiple uplink transmissions associated with a first TAG. The control signaling component 1425 may be configured as or otherwise support a means for receiving, over a second CORESET associated with a second CORESET pool index of the serving cell, second control signaling scheduling a second set of multiple uplink transmissions associated with a second TAG. The first transmission rule component 1430 may be configured as or otherwise support a means for applying, to obtain a first set of one or more uplink transmissions associated with the first TAG and a second set of one or more uplink transmissions associated with the second TAG, a first transmission rule to each of the first set of multiple uplink transmissions and the second set of multiple uplink transmissions independently and in accordance with an overlapping between uplink transmissions of the first set of multiple uplink transmissions in a scheduled time domain, and between uplink transmissions of the second set of multiple uplink transmissions in the scheduled time domain. The second transmission rule component 1435 may be configured as or otherwise support a means for applying a second transmission rule to the first set of one or more uplink transmissions and the second set of one or more uplink transmissions in accordance with an overlapping between the first set of one or more uplink transmissions and the second set of one or more uplink transmissions in an observed time domain, where the observed time domain is associated with the first TAG and the second TAG. The uplink transmission component 1440 may be configured as or otherwise support a means for performing one or more of the first set of one or more uplink transmissions and the second set of one or more uplink transmissions in accordance with the second transmission rule.

Additionally, or alternatively, the communications manager 1420 may support wireless communication at a UE in accordance with examples as disclosed herein. The control signaling component 1425 may be configured as or otherwise support a means for receiving, over a first CORESET associated with a first CORESET pool index of a serving cell, first control signaling scheduling a first set of one or more uplink transmissions associated with a first TAG. The control signaling component 1425 may be configured as or otherwise support a means for receiving, over a second CORESET associated with a second CORESET pool index of the serving cell, second control signaling scheduling a second set of one or more uplink transmissions associated with a second TAG. The first transmission rule component 1430 may be configured as or otherwise support a means for applying, to the first set of one or more uplink transmissions and the second set of one or more uplink transmissions in accordance with an overlapping between the first set of one or more uplink transmissions and the second set of one or more uplink transmissions in an observed time domain, a first transmission rule to select the first set of one or more uplink transmissions, where the observed time domain is associated with the first TAG and the second TAG. The second transmission rule component 1435 may be configured as or otherwise support a means for applying a second transmission rule to the first set of one or more uplink transmissions in accordance with an overlapping between uplink transmissions of the first set of one or more uplink transmissions in a scheduled time domain to obtain a third set of one or more uplink transmissions. The uplink transmission component 1440 may be configured as or otherwise support a means for performing one or more uplink transmissions of the third set of one or more uplink transmissions in accordance with the second transmission rule.

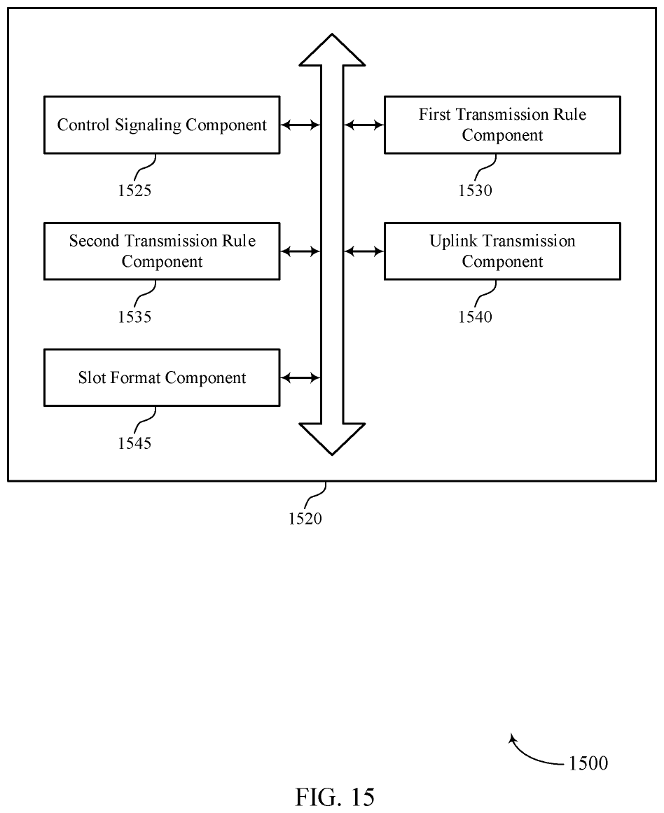

FIG. 15 shows a block diagram 1500 of a communications manager 1520 that supports techniques for handling overlapping uplink transmissions associated with different TAGs in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of techniques for handling overlapping uplink transmissions associated with different TAGs as described herein. For example, the communications manager 1520 may include a control signaling component 1525, a first transmission rule component 1530, a second transmission rule component 1535, an uplink transmission component 1540, a slot format component 1545, or any combination thereof. Each of these components may communicate, directly or indirectly, with one another (e.g., via one or more buses).

The communications manager 1520 may support wireless communication at a UE in accordance with examples as disclosed herein. The control signaling component 1525 may be configured as or otherwise support a means for receiving, over a first CORESET associated with a first CORESET pool index of a serving cell, first control signaling scheduling a first set of one or more uplink transmissions associated with a first TAG. In some examples, the control signaling component 1525 may be configured as or otherwise support a means for receiving, over a second CORESET associated with a second CORESET pool index of the serving cell, second control signaling scheduling a second set of one or more uplink transmissions associated with a second TAG. The first transmission rule component 1530 may be configured as or otherwise support a means for applying, to the first set of one or more uplink transmissions and the second set of one or more uplink transmissions in accordance with an overlapping between uplink transmissions of one or both of the first set of one or more uplink transmissions and the second set of one or more uplink transmissions in a scheduled time domain, a first transmission rule to obtain a first uplink transmission in a first scheduled time domain location and a second uplink transmission in a second scheduled time domain location. The second transmission rule component 1535 may be configured as or otherwise support a means for applying a second transmission rule to the first uplink transmission and the second uplink transmission in accordance with an overlapping between the first uplink transmission and the second uplink transmission in an observed time domain, where the observed time domain is associated with the first TAG and the second TAG. The uplink transmission component 1540 may be configured as or otherwise support a means for performing one or both of the first uplink transmission and the second uplink transmission in accordance with the second transmission rule.

In some examples, the slot format component 1545 may be configured as or otherwise support a means for selecting one or both of the first uplink transmission and the second uplink transmission in accordance with a slot format, where performing one or both of the first uplink transmission and the second uplink transmission is based on selecting one or both of the first uplink transmission and the second uplink transmission in accordance with the slot format.

In some examples, to support applying the first transmission rule to obtain the first uplink transmission in the first scheduled time domain location and the second uplink transmission in the second scheduled time domain location, the first transmission rule component 1530 may be configured as or otherwise support a means for multiplexing or dropping one or more first uplink transmissions of one or both of the first set of one or more uplink transmissions and the second set of one or more uplink transmissions that overlap in the first scheduled time domain location to obtain the first uplink transmission. In some examples, to support applying the first transmission rule to obtain the first uplink transmission in the first scheduled time domain location and the second uplink transmission in the second scheduled time domain location, the first transmission rule component 1530 may be configured as or otherwise support a means for multiplexing or dropping one or more second uplink transmissions of one or both of the first set of one or more uplink transmissions and the second set of one or more uplink transmissions that overlap in the second scheduled time domain location to obtain the second uplink transmission.

In some examples, dropping the one or more first uplink transmissions that overlap in the first scheduled time domain location or the one or more second uplink transmissions that overlap in the second scheduled time domain location is based on an error case. In some examples, the error case is associated with the overlapping between the uplink transmissions of at least one of the first set of one or more uplink transmissions and at least one of the second set of one or more uplink transmissions in the scheduled time domain.

In some examples, to support first stage, the first transmission rule component 1530 may be configured as or otherwise support a means for multiplexing or dropping one or more uplink transmissions of the first set of one or more uplink transmissions that overlap in the scheduled time domain to obtain one or both of a first intermediate uplink transmission in the first scheduled time domain location or a second intermediate uplink transmission in the second scheduled time domain location. In some examples, to support first stage, the first transmission rule component 1530 may be configured as or otherwise support a means for multiplexing or dropping one or more uplink transmissions of the second set of one or more uplink transmissions that overlap in the scheduled time domain to obtain one or both of a third intermediate uplink transmission in the first scheduled time domain location or a fourth intermediate uplink transmission in the second scheduled time domain location.

In some examples, to support second stage, the first transmission rule component 1530 may be configured as or otherwise support a means for selecting one of the first intermediate uplink transmission and the third intermediate uplink transmission to obtain the first uplink transmission in the first scheduled time domain location. In some examples, to support second stage, the first transmission rule component 1530 may be configured as or otherwise support a means for selecting one of the second intermediate uplink transmission and the fourth intermediate uplink transmission to obtain the second uplink transmission in the second scheduled time domain location.

In some examples, the UE communicates with a network entity without carrier aggregation. In some examples, the first stage of the first transmission rule, the second stage of the first transmission rule, and the second transmission rule are applied for a single component carrier.

In some examples, the UE communicates with a network entity using carrier aggregation. In some examples, the first stage of the first transmission rule is applied to the first set of one or more uplink transmissions and the second set of one or more uplink transmissions across a first set of component carriers of a first uplink control channel group and associated with a same CORESET pool index. In some examples, the second stage of the first transmission rule and the second transmission rule are applied across a second set of component carriers associated with multiple CORESET pool indices.

In some examples, the second stage of the first transmission rule and the second transmission rule are applied for each component carrier that is associated with the first CORESET pool index and the second CORESET pool index and associated with the first TAG and the second TAG; or for each radio frequency band including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG; or for each uplink control channel group including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG; or for each set of component carriers including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG.

In some examples, to support applying the second transmission rule to the first uplink transmission and the second uplink transmission, the second transmission rule component 1535 may be configured as or otherwise support a means for selecting one or both of the first uplink transmission and the second uplink transmission based on a satisfaction of a condition associated with a capability of the UE.

In some examples, the satisfaction of the condition is based on the first uplink transmission and the second uplink transmission being scheduled for different panels of the UE and the capability of the UE for supporting multi-panel uplink transmission; or simultaneous uplink transmission; or both multi-panel uplink transmission and simultaneous uplink transmission.

In some examples, the satisfaction of the condition is based on the first uplink transmission and the second uplink transmission being scheduled for different panels of the UE, the capability of the UE for supporting multi-panel uplink transmission, and the first uplink transmission and the second uplink transmission being associated with a same channel type.

In some examples, the UE may select to perform one of the first uplink transmission and the second uplink transmission based on failing to satisfy the condition. In such examples, to support performing one or both of the first uplink transmission and the second uplink transmission, the second transmission rule component 1535 may be configured as or otherwise support a means for performing the first uplink transmission based on the first uplink transmission being scheduled in a first symbol or slot in the scheduled time domain. In such examples, to support performing one or both of the first uplink transmission and the second uplink transmission, the second transmission rule component 1535 may be configured as or otherwise support a means for performing a portion of the second uplink transmission that does not overlap with the first uplink transmission in the observed time domain based on the second uplink transmission being scheduled in a second symbol or slot in the scheduled time domain, where the first symbol or slot is earlier than the second symbol or slot.

In some examples, the UE may select to perform one of the first uplink transmission and the second uplink transmission based on failing to satisfy the condition. In such examples, to support performing one or both of the first uplink transmission and the second uplink transmission, the second transmission rule component 1535 may be configured as or otherwise support a means for performing the first uplink transmission based on the first uplink transmission being scheduled in a first symbol or slot in the scheduled time domain. In such examples, to support performing one or both of the first uplink transmission and the second uplink transmission, the second transmission rule component 1535 may be configured as or otherwise support a means for dropping the second uplink transmission based on the second uplink transmission being scheduled in a second symbol or slot in the scheduled time domain, where the first symbol or slot is earlier than the second symbol or slot.

In some examples, the UE may select to perform one of the first uplink transmission and the second uplink transmission based on failing to satisfy the condition. In such examples, to support performing one or both of the first uplink transmission and the second uplink transmission, the second transmission rule component 1535 may be configured as or otherwise support a means for performing the first uplink transmission based on the first uplink transmission being scheduled in a first symbol or slot in the observed time domain. In such examples, to support performing one or both of the first uplink transmission and the second uplink transmission, the second transmission rule component 1535 may be configured as or otherwise support a means for performing a portion of the second uplink transmission that does not overlap with the first uplink transmission in the observed time domain based on the second uplink transmission being scheduled in a second symbol or slot in the observed time domain, where the first symbol or slot is earlier than the second symbol or slot.

In some examples, the UE may select to perform one of the first uplink transmission and the second uplink transmission based on failing to satisfy the condition. In such examples, to support performing one or both of the first uplink transmission and the second uplink transmission, the second transmission rule component 1535 may be configured as or otherwise support a means for performing the first uplink transmission based on the first uplink transmission being scheduled in a first symbol or slot in the observed time domain. In such examples, to support performing one or both of the first uplink transmission and the second uplink transmission, the second transmission rule component 1535 may be configured as or otherwise support a means for dropping the second uplink transmission based on the second uplink transmission being scheduled in a second symbol or slot in the observed time domain, where the first symbol or slot is earlier than the second symbol or slot.

In some examples, the UE may select to perform one of the first uplink transmission and the second uplink transmission based on failing to satisfy the condition. In such examples, to support performing one or both of the first uplink transmission and the second uplink transmission, the second transmission rule component 1535 may be configured as or otherwise support a means for performing the first uplink transmission based on the first uplink transmission being associated with the first CORESET pool index. In such examples, to support performing one or both of the first uplink transmission and the second uplink transmission, the second transmission rule component 1535 may be configured as or otherwise support a means for performing a portion of the second uplink transmission that does not overlap with the first uplink transmission in the observed time domain based on the second uplink transmission being associated with the second CORESET pool index.

In some examples, the UE may select to perform one of the first uplink transmission and the second uplink transmission based on failing to satisfy the condition. In such examples, to support performing one or both of the first uplink transmission and the second uplink transmission, the second transmission rule component 1535 may be configured as or otherwise support a means for performing the first uplink transmission based on the first uplink transmission being associated with the first CORESET pool index. In such examples, to support performing one or both of the first uplink transmission and the second uplink transmission, the second transmission rule component 1535 may be configured as or otherwise support a means for dropping the second uplink transmission based on the second uplink transmission being associated with the second CORESET pool index.

In some examples, the UE communicates with a network entity without carrier aggregation. In some examples, the first transmission rule and the second transmission rule are applied for a single component carrier.

In some examples, the UE communicates with a network entity using carrier aggregation. In some examples, the first transmission rule is applied across a first set of component carriers of a same uplink control channel group. In some examples, the second transmission rule is applied across a second set of component carriers associated with multiple CORESET pool indices.

In some examples, the second transmission rule is applied for each component carrier that is associated with the first CORESET pool index and the second CORESET pool index and associated with the first TAG and the second TAG; or for each radio frequency band including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG; or for each uplink control channel group including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG; or for each set of component carriers including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG.

Additionally, or alternatively, the communications manager 1520 may support wireless communication at a UE in accordance with examples as disclosed herein. In some examples, the control signaling component 1525 may be configured as or otherwise support a means for receiving, over a first CORESET associated with a first CORESET pool index of a serving cell, first control signaling scheduling a first set of multiple uplink transmissions associated with a first TAG. In some examples, the control signaling component 1525 may be configured as or otherwise support a means for receiving, over a second CORESET associated with a second CORESET pool index of the serving cell, second control signaling scheduling a second set of multiple uplink transmissions associated with a second TAG. In some examples, the first transmission rule component 1530 may be configured as or otherwise support a means for applying, to obtain a first set of one or more uplink transmissions associated with the first TAG and a second set of one or more uplink transmissions associated with the second TAG, a first transmission rule to each of the first set of multiple uplink transmissions and the second set of multiple uplink transmissions independently and in accordance with an overlapping between uplink transmissions of the first set of multiple uplink transmissions in a scheduled time domain, and between uplink transmissions of the second set of multiple uplink transmissions in the scheduled time domain. In some examples, the second transmission rule component 1535 may be configured as or otherwise support a means for applying a second transmission rule to the first set of one or more uplink transmissions and the second set of one or more uplink transmissions in accordance with an overlapping between the first set of one or more uplink transmissions and the second set of one or more uplink transmissions in an observed time domain, where the observed time domain is associated with the first TAG and the second TAG. In some examples, the uplink transmission component 1540 may be configured as or otherwise support a means for performing one or more of the first set of one or more uplink transmissions and the second set of one or more uplink transmissions in accordance with the second transmission rule.

In some examples, the slot format component 1545 may be configured as or otherwise support a means for selecting one or more of the first set of one or more uplink transmissions and the second set of one or more uplink transmissions in accordance with a slot format, where performing one or more of the first set of one or more uplink transmissions and the second set of one or more uplink transmissions is based on selecting one or more of the first set of one or more uplink transmissions and the second set of one or more uplink transmissions in accordance with the slot format.

In some examples, to support applying the first transmission rule to obtain the first set of one or more uplink transmissions associated with the first TAG and the second set of one or more uplink transmissions associated with the second TAG, the first transmission rule component 1530 may be configured as or otherwise support a means for multiplexing or dropping one or more uplink transmissions of the first set of multiple uplink transmissions that overlap in the scheduled time domain to obtain the first set of one or more uplink transmissions associated with the first TAG. In some examples, to support applying the first transmission rule to obtain the first set of one or more uplink transmissions associated with the first TAG and the second set of one or more uplink transmissions associated with the second TAG, the first transmission rule component 1530 may be configured as or otherwise support a means for multiplexing or dropping one or more uplink transmissions of the second set of multiple uplink transmissions that overlap in the scheduled time domain to obtain the second set of one or more uplink transmissions associated with the second TAG.

In some examples, the first set of one or more uplink transmissions associated with the first TAG is in one or both of a first scheduled time domain location and a second scheduled time domain location. In some examples, the second set of one or more uplink transmissions associated with the second TAG is in one or both of the first scheduled time domain location and the second scheduled time domain location.

In some examples, to support applying the second transmission rule to the first set of one or more uplink transmissions and the second set of one or more uplink transmissions, the second transmission rule component 1535 may be configured as or otherwise support a means for selecting one or more uplink transmissions of one or both the first set of one or more uplink transmissions and the second set of one or more uplink transmissions based on a satisfaction of a condition associated with a capability of the UE.

In some examples, the satisfaction of the condition is based on any overlapping uplink transmissions of the first set of one or more uplink transmissions and the second set of one or more uplink transmissions in the observed time domain being scheduled for different panels of the UE and the capability of the UE for supporting multi-panel uplink transmission; or simultaneous uplink transmission; or both multi-panel uplink transmission and simultaneous uplink transmission.

In some examples, the satisfaction of the condition is based on any overlapping uplink transmissions of the first set of one or more uplink transmissions and the second set of one or more uplink transmissions in the observed time domain being scheduled for different panels of the UE, the capability of the UE for supporting multi-panel uplink transmission, and the one or more of the first set of one or more uplink transmissions and the second set of one or more uplink transmissions being associated with a same channel type.

In some examples, a first uplink transmission and a second uplink transmission may overlap the observed time domain and the UE may select to perform one of the first uplink transmission and the second uplink transmission based on failing to satisfy the condition. In such examples, to support performing the one or more of the first set of one or more uplink transmissions and the second set of one or more uplink transmissions, the second transmission rule component 1535 may be configured as or otherwise support a means for performing the first uplink transmission based on the first uplink transmission being scheduled in a first symbol or slot in the scheduled time domain. In such examples, to support performing the one or more of the first set of one or more uplink transmissions and the second set of one or more uplink transmissions, the second transmission rule component 1535 may be configured as or otherwise support a means for dropping the second uplink transmission based on the second uplink transmission being scheduled in a second symbol or slot in the scheduled time domain, where the first symbol or slot is earlier than the second symbol or slot.

In some examples, a first uplink transmission and a second uplink transmission may overlap the observed time domain and the UE may select to perform one of the first uplink transmission and the second uplink transmission based on failing to satisfy the condition. In such examples, to support performing the one or more of the first set of one or more uplink transmissions and the second set of one or more uplink transmissions, the second transmission rule component 1535 may be configured as or otherwise support a means for performing the first uplink transmission based on the first uplink transmission being scheduled in a first symbol or slot in the observed time domain. In such examples, to support performing the one or more of the first set of one or more uplink transmissions and the second set of one or more uplink transmissions, the second transmission rule component 1535 may be configured as or otherwise support a means for dropping the second uplink transmission based on the second uplink transmission being scheduled in a second symbol or slot in the observed time domain, where the first symbol or slot is earlier than the second symbol or slot.

In some examples, a first uplink transmission and a second uplink transmission may overlap the observed time domain and the UE may select to perform one of the first uplink transmission and the second uplink transmission based on failing to satisfy the condition. In such examples, to support performing the one or more of the first set of one or more uplink transmissions and the second set of one or more uplink transmissions, the second transmission rule component 1535 may be configured as or otherwise support a means for performing the first uplink transmission based on the first uplink transmission being associated with the first CORESET pool index. In such examples, to support performing the one or more of the first set of one or more uplink transmissions and the second set of one or more uplink transmissions, the second transmission rule component 1535 may be configured as or otherwise support a means for dropping the second uplink transmission based on the second uplink transmission being associated with the second CORESET pool index.

In some examples, the UE communicates with a network entity without carrier aggregation. In some examples, the first transmission rule and the second transmission rule are applied for a single component carrier.

In some examples, the UE communicates with a network entity using carrier aggregation. In some examples, the first transmission rule is applied to each of the first set of multiple uplink transmissions and the second set of multiple uplink transmissions independently across a first set of component carriers of a first uplink control channel group and associated with a same CORESET pool index. In some examples, the second transmission rule is applied across a second set of component carriers associated with multiple CORESET pool indices.

In some examples, the second transmission rule is applied for each component carrier that is associated with the first CORESET pool index and the second CORESET pool index and associated with the first TAG and the second TAG; or for each radio frequency band including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG; or for each uplink control channel group including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG; or for each set of component carriers including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG.

Additionally, or alternatively, the communications manager 1520 may support wireless communication at a UE in accordance with examples as disclosed herein. In some examples, the control signaling component 1525 may be configured as or otherwise support a means for receiving, over a first CORESET associated with a first CORESET pool index of a serving cell, first control signaling scheduling a first set of one or more uplink transmissions associated with a first TAG. In some examples, the control signaling component 1525 may be configured as or otherwise support a means for receiving, over a second CORESET associated with a second CORESET pool index of the serving cell, second control signaling scheduling a second set of one or more uplink transmissions associated with a second TAG. In some examples, the first transmission rule component 1530 may be configured as or otherwise support a means for applying, to the first set of one or more uplink transmissions and the second set of one or more uplink transmissions in accordance with an overlapping between the first set of one or more uplink transmissions and the second set of one or more uplink transmissions in an observed time domain, a first transmission rule to select the first set of one or more uplink transmissions, where the observed time domain is associated with the first TAG and the second TAG. In some examples, the second transmission rule component 1535 may be configured as or otherwise support a means for applying a second transmission rule to the first set of one or more uplink transmissions in accordance with an overlapping between uplink transmissions of the first set of one or more uplink transmissions in a scheduled time domain to obtain a third set of one or more uplink transmissions. In some examples, the uplink transmission component 1540 may be configured as or otherwise support a means for performing one or more uplink transmissions of the third set of one or more uplink transmissions in accordance with the second transmission rule.

In some examples, the slot format component 1545 may be configured as or otherwise support a means for selecting the one or more uplink transmissions from the third set of one or more uplink transmissions in accordance with a slot format, where performing the one or more uplink transmissions is based on selecting the one or more uplink transmissions from the third set of one or more uplink transmissions in accordance with the slot format.

In some examples, to support applying the first transmission rule to obtain the first set of one or more uplink transmissions, the first transmission rule component 1530 may be configured as or otherwise support a means for selecting the first set of one or more uplink transmissions based on the first TAG associated with the first set of one or more uplink transmissions being smaller than the second TAG associated with the second set of one or more uplink transmissions.

In some examples, to support applying the first transmission rule to obtain the first set of one or more uplink transmissions, the first transmission rule component 1530 may be configured as or otherwise support a means for selecting the first set of one or more uplink transmissions based on the first TAG associated with the first set of one or more uplink transmissions being larger than the second TAG associated with the second set of one or more uplink transmissions.

In some examples, to support applying the first transmission rule to obtain the first set of one or more uplink transmissions, the first transmission rule component 1530 may be configured as or otherwise support a means for selecting the first set of one or more uplink transmissions based on a first TAG index associated with the first set of one or more uplink transmissions being larger than a second TAG index associated with the second set of one or more uplink transmissions.

In some examples, to support applying the first transmission rule to obtain the first set of one or more uplink transmissions, the first transmission rule component 1530 may be configured as or otherwise support a means for selecting the first set of one or more uplink transmissions based on a first TAG index associated with the first set of one or more uplink transmissions being smaller than a second TAG index associated with the second set of one or more uplink transmissions.

In some examples, to support applying the first transmission rule to obtain the first set of one or more uplink transmissions, the first transmission rule component 1530 may be configured as or otherwise support a means for selecting the first set of one or more uplink transmissions based on the first CORESET pool index associated with the first set of one or more uplink transmissions.

In some examples, to support applying the first transmission rule to obtain the first set of one or more uplink transmissions, the first transmission rule component 1530 may be configured as or otherwise support a means for selecting the first set of one or more uplink transmissions based on a closed loop power control index associated with the first set of one or more uplink transmissions.

In some examples, to support applying the second transmission rule to the first set of one or more uplink transmissions, the second transmission rule component 1535 may be configured as or otherwise support a means for multiplexing or dropping uplink transmissions of the first set of one or more uplink transmissions that overlap in the scheduled time domain to obtain the third set of one or more uplink transmissions.

In some examples, the UE communicates with a network entity without carrier aggregation. In some examples, the first transmission rule and the second transmission rule are applied for a single component carrier.

In some examples, the UE communicates with a network entity using carrier aggregation. In some examples, the first transmission rule is applied to the first set of one or more uplink transmissions and the second set of one or more uplink transmissions across a first set of component carriers associated with multiple CORESET pool indices. In some examples, the second transmission rule is applied across a second set of component carriers of an uplink control channel group associated with a same CORESET pool index.

In some examples, the first transmission rule is applied for each component carrier that is associated with the first CORESET pool index and the second CORESET pool index and associated with the first TAG and the second TAG; or for each radio frequency band including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG; or for each uplink control channel group including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG; or for each set of component carriers including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG.

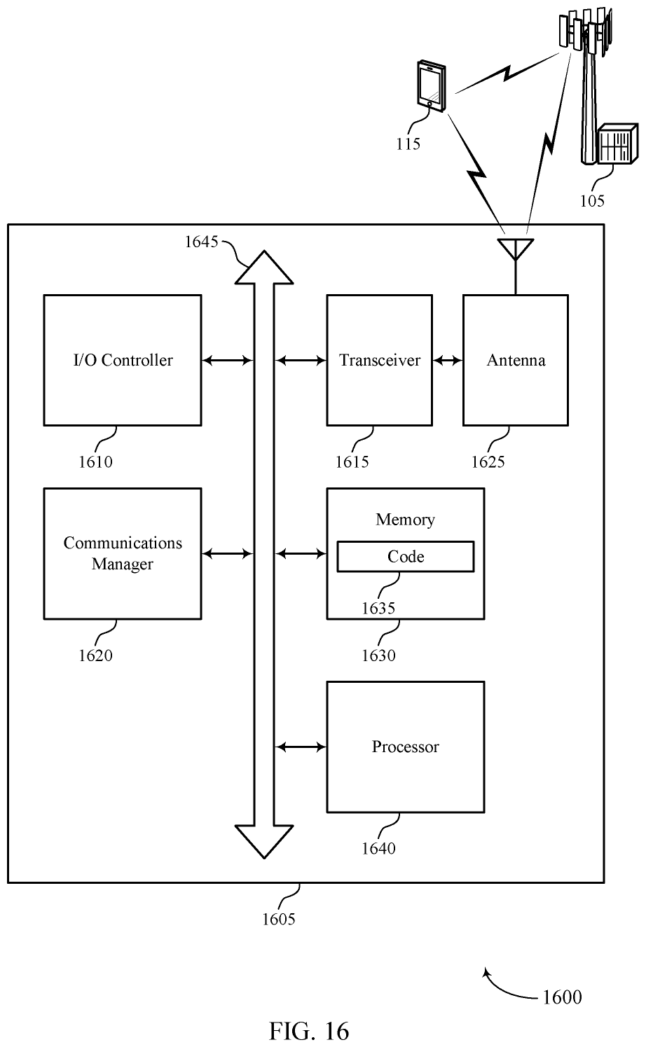

FIG. 16 shows a diagram of a system 1600 including a device 1605 that supports techniques for handling overlapping uplink transmissions associated with different TAGs in accordance with one or more aspects of the present disclosure. The device 1605 may be an example of or include the components of a device 1305, a device 1405, or a UE 115 as described herein. The device 1605 may communicate (e.g., wirelessly) with one or more network entities 105, one or more UEs 115, or any combination thereof. The device 1605 may include components for bi-directional voice and data communications including components for transmitting and receiving communications, such as a communications manager 1620, an input/output (I/O) controller 1610, a transceiver 1615, an antenna 1625, a memory 1630, code 1635, and a processor 1640. These components may be in electronic communication or otherwise coupled (e.g., operatively, communicatively, functionally, electronically, electrically) via one or more buses (e.g., a bus 1645).

The I/O controller 1610 may manage input and output signals for the device 1605. The I/O controller 1610 may also manage peripherals not integrated into the device 1605. In some cases, the I/O controller 1610 may represent a physical connection or port to an external peripheral. In some cases, the I/O controller 1610 may utilize an operating system such as iOS®, ANDROID®, MS-DOS®, MS-WINDOWS®, OS/2®, UNIX®, LINUX®, or another known operating system. Additionally or alternatively, the I/O controller 1610 may represent or interact with a modem, a keyboard, a mouse, a touchscreen, or a similar device. In some cases, the I/O controller 1610 may be implemented as part of a processor, such as the processor 1640. In some cases, a user may interact with the device 1605 via the I/O controller 1610 or via hardware components controlled by the I/O controller 1610.

In some cases, the device 1605 may include a single antenna 1625. However, in some other cases, the device 1605 may have more than one antenna 1625, which may be capable of concurrently transmitting or receiving multiple wireless transmissions. The transceiver 1615 may communicate bi-directionally, via the one or more antennas 1625, wired, or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The memory 1630 may include random access memory (RAM) and read-only memory (ROM). The memory 1630 may store computer-readable, computer-executable code 1635 including instructions that, when executed by the processor 1640, cause the device 1605 to perform various functions described herein. The code 1635 may be stored in a non-transitory computer-readable medium such as system memory or another type of memory. In some cases, the code 1635 may not be directly executable by the processor 1640 but may cause a computer (e.g., when compiled and executed) to perform functions described herein. In some cases, the memory 1630 may contain, among other things, a basic I/O system (BIOS) which may control basic hardware or software operation such as the interaction with peripheral components or devices.

The processor 1640 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some other cases, a memory controller may be integrated into the processor 1640. The processor 1640 may be configured to execute computer-readable instructions stored in a memory (e.g., the memory 1630) to cause the device 1605 to perform various functions (e.g., functions or tasks supporting techniques for handling overlapping uplink transmissions associated with different TAGs). For example, the device 1605 or a component of the device 1605 may include a processor 1640 and memory 1630 coupled with or to the processor 1640, the processor 1640 and memory 1630 configured to perform various functions described herein.

The communications manager 1620 may support wireless communication at a UE in accordance with examples as disclosed herein. For example, the communications manager 1620 may be configured as or otherwise support a means for receiving, over a first CORESET associated with a first CORESET pool index of a serving cell, first control signaling scheduling a first set of one or more uplink transmissions associated with a first TAG. The communications manager 1620 may be configured as or otherwise support a means for receiving, over a second CORESET associated with a second CORESET pool index of the serving cell, second control signaling scheduling a second set of one or more uplink transmissions associated with a second TAG. The communications manager 1620 may be configured as or otherwise support a means for applying, to the first set of one or more uplink transmissions and the second set of one or more uplink transmissions in accordance with an overlapping between uplink transmissions of one or both of the first set of one or more uplink transmissions and the second set of one or more uplink transmissions in a scheduled time domain, a first transmission rule to obtain a first uplink transmission in a first scheduled time domain location and a second uplink transmission in a second scheduled time domain location. The communications manager 1620 may be configured as or otherwise support a means for applying a second transmission rule to the first uplink transmission and the second uplink transmission in accordance with an overlapping between the first uplink transmission and the second uplink transmission in an observed time domain, where the observed time domain is associated with the first TAG and the second TAG. The communications manager 1620 may be configured as or otherwise support a means for performing one or both of the first uplink transmission and the second uplink transmission in accordance with the second transmission rule.

Additionally, or alternatively, the communications manager 1620 may support wireless communication at a UE in accordance with examples as disclosed herein. For example, the communications manager 1620 may be configured as or otherwise support a means for receiving, over a first CORESET associated with a first CORESET pool index of a serving cell, first control signaling scheduling a first set of multiple uplink transmissions associated with a first TAG. The communications manager 1620 may be configured as or otherwise support a means for receiving, over a second CORESET associated with a second CORESET pool index of the serving cell, second control signaling scheduling a second set of multiple uplink transmissions associated with a second TAG. The communications manager 1620 may be configured as or otherwise support a means for applying, to obtain a first set of one or more uplink transmissions associated with the first TAG and a second set of one or more uplink transmissions associated with the second TAG, a first transmission rule to each of the first set of multiple uplink transmissions and the second set of multiple uplink transmissions independently and in accordance with an overlapping between uplink transmissions of the first set of multiple uplink transmissions in a scheduled time domain, and between uplink transmissions of the second set of multiple uplink transmissions in the scheduled time domain. The communications manager 1620 may be configured as or otherwise support a means for applying a second transmission rule to the first set of one or more uplink transmissions and the second set of one or more uplink transmissions in accordance with an overlapping between the first set of one or more uplink transmissions and the second set of one or more uplink transmissions in an observed time domain, where the observed time domain is associated with the first TAG and the second TAG. The communications manager 1620 may be configured as or otherwise support a means for performing one or more of the first set of one or more uplink transmissions and the second set of one or more uplink transmissions in accordance with the second transmission rule.

Additionally, or alternatively, the communications manager 1620 may support wireless communication at a UE in accordance with examples as disclosed herein. For example, the communications manager 1620 may be configured as or otherwise support a means for receiving, over a first CORESET associated with a first CORESET pool index of a serving cell, first control signaling scheduling a first set of one or more uplink transmissions associated with a first TAG. The communications manager 1620 may be configured as or otherwise support a means for receiving, over a second CORESET associated with a second CORESET pool index of the serving cell, second control signaling scheduling a second set of one or more uplink transmissions associated with a second TAG. The communications manager 1620 may be configured as or otherwise support a means for applying, to the first set of one or more uplink transmissions and the second set of one or more uplink transmissions in accordance with an overlapping between the first set of one or more uplink transmissions and the second set of one or more uplink transmissions in an observed time domain, a first transmission rule to select the first set of one or more uplink transmissions, where the observed time domain is associated with the first TAG and the second TAG. The communications manager 1620 may be configured as or otherwise support a means for applying a second transmission rule to the first set of one or more uplink transmissions in accordance with an overlapping between uplink transmissions of the first set of one or more uplink transmissions in a scheduled time domain to obtain a third set of one or more uplink transmissions. The communications manager 1620 may be configured as or otherwise support a means for performing one or more uplink transmissions of the third set of one or more uplink transmissions in accordance with the second transmission rule.

By including or configuring the communications manager 1620 in accordance with examples as described herein, the device 1605 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the processor 1640, the memory 1630, the code 1635, or any combination thereof. For example, the code 1635 may include instructions executable by the processor 1640 to cause the device 1605 to perform various aspects of techniques for handling overlapping uplink transmissions associated with different TAGs as described herein, or the processor 1640 and the memory 1630 may be otherwise configured to perform or support such operations.

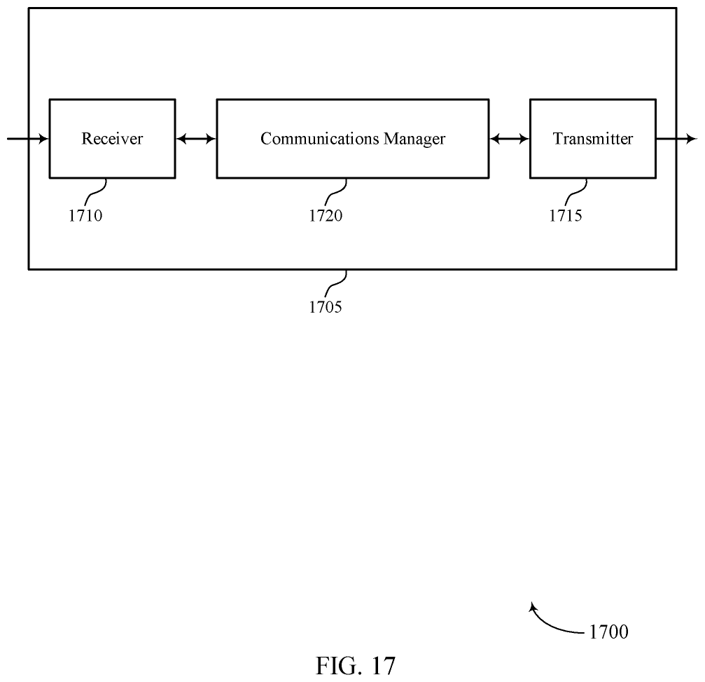

FIG. 17 shows a block diagram 1700 of a device 1705 that supports techniques for handling overlapping uplink transmissions associated with different TAGs in accordance with one or more aspects of the present disclosure. The device 1705 may be an example of aspects of a network entity 105 as described herein. The device 1705 may include a receiver 1710, a transmitter 1715, and a communications manager 1720. The device 1705 may also include a processor. Each of these components may be in communication with one another (e.g., via one or more buses).

The receiver 1710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1705. In some examples, the receiver 1710 may support obtaining information by receiving signals via one or more antennas. Additionally, or alternatively, the receiver 1710 may support obtaining information by receiving signals via one or more wired (e.g., electrical, fiber optic) interfaces, wireless interfaces, or any combination thereof.

The transmitter 1715 may provide a means for outputting (e.g., transmitting, providing, conveying, sending) information generated by other components of the device 1705. For example, the transmitter 1715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1715 may support outputting information by transmitting signals via one or more antennas. Additionally, or alternatively, the transmitter 1715 may support outputting information by transmitting signals via one or more wired (e.g., electrical, fiber optic) interfaces, wireless interfaces, or any combination thereof. In some examples, the transmitter 1715 and the receiver 1710 may be co-located in a transceiver, which may include or be coupled with a modem.

The communications manager 1720, the receiver 1710, the transmitter 1715, or various combinations thereof or various components thereof may be examples of means for performing various aspects of techniques for handling overlapping uplink transmissions associated with different TAGs as described herein. For example, the communications manager 1720, the receiver 1710, the transmitter 1715, or various combinations or components thereof may support a method for performing one or more of the functions described herein.

In some examples, the communications manager 1720, the receiver 1710, the transmitter 1715, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1720, the receiver 1710, the transmitter 1715, or various combinations or components thereof may be implemented in code (e.g., as communications management software or firmware) executed by a processor. If implemented in code executed by a processor, the functions of the communications manager 1720, the receiver 1710, the transmitter 1715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1720 may be configured to perform various operations (e.g., receiving, obtaining, monitoring, outputting, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to obtain information, output information, or perform various other operations as described herein.

The communications manager 1720 may support wireless communications at a network entity in accordance with examples as disclosed herein. For example, the communications manager 1720 may be configured as or otherwise support a means for outputting, to a UE via a first component and over a first CORESET associated with a first CORESET pool index of a serving cell, first control signaling scheduling a first set of one or more uplink transmissions associated with a first TAG. The communications manager 1720 may be configured as or otherwise support a means for outputting, to the UE via a second component and over a second CORESET associated with a second CORESET pool index of the serving cell, second control signaling scheduling a second set of one or more uplink transmissions associated with a second TAG. The communications manager 1720 may be configured as or otherwise support a means for applying, to the first set of one or more uplink transmissions and the second set of one or more uplink transmissions in accordance with an overlapping between uplink transmissions of one or both of the first set of one or more uplink transmissions and the second set of one or more uplink transmissions in a scheduled time domain, a first transmission rule to obtain a first uplink transmission in a first scheduled time domain location and a second uplink transmission in a second scheduled time domain location. The communications manager 1720 may be configured as or otherwise support a means for applying a second transmission rule to the first uplink transmission and the second uplink transmission in accordance with an overlapping between the first uplink transmission and the second uplink transmission in an observed time domain, where the observed time domain is associated with the first TAG and the second TAG. The communications manager 1720 may be configured as or otherwise support a means for obtaining, from the UE, one or both of the first uplink transmission and the second uplink transmission in accordance with the second transmission rule.

Additionally, or alternatively, the communications manager 1720 may support wireless communications at a network entity in accordance with examples as disclosed herein. For example, the communications manager 1720 may be configured as or otherwise support a means for outputting, to a UE via a first component and over a first CORESET associated with a first CORESET pool index of a serving cell, first control signaling scheduling a first set of multiple uplink transmissions associated with a first TAG. The communications manager 1720 may be configured as or otherwise support a means for outputting, to the UE via a second component and over a second CORESET associated with a second CORESET pool index of the serving cell, second control signaling scheduling a second set of multiple uplink transmissions associated with a second TAG. The communications manager 1720 may be configured as or otherwise support a means for applying, to obtain a first set of one or more uplink transmissions associated with the first TAG and a second set of one or more uplink transmissions associated with the second TAG, a first transmission rule to each of the first set of multiple uplink transmissions and the second set of multiple uplink transmissions independently and in accordance with an overlapping between uplink transmissions of the first set of multiple uplink transmissions in a scheduled time domain, and between uplink transmissions of the second set of multiple uplink transmissions in the scheduled time domain. The communications manager 1720 may be configured as or otherwise support a means for applying a second transmission rule to the first set of one or more uplink transmissions and the second set of one or more uplink transmissions in accordance with an overlapping between the first set of one or more uplink transmissions and the second set of one or more uplink transmissions in an observed time domain, where the observed time domain is associated with the first TAG and the second TAG. The communications manager 1720 may be configured as or otherwise support a means for obtaining, from the UE, one or more of the first set of one or more uplink transmissions and the second set of one or more uplink transmissions in accordance with the second transmission rule.

Additionally, or alternatively, the communications manager 1720 may support wireless communications at a network entity in accordance with examples as disclosed herein. For example, the communications manager 1720 may be configured as or otherwise support a means for outputting, to a UE via a first component and over a first CORESET associated with a first CORESET pool index of a serving cell, first control signaling scheduling a first set of one or more uplink transmissions associated with a first TAG. The communications manager 1720 may be configured as or otherwise support a means for outputting, to the UE via a second component and over a second CORESET associated with a second CORESET pool index of the serving cell, second control signaling scheduling a second set of one or more uplink transmissions associated with a second TAG. The communications manager 1720 may be configured as or otherwise support a means for applying, to the first set of one or more uplink transmissions and the second set of one or more uplink transmissions in accordance with an overlapping between the first set of one or more uplink transmissions and the second set of one or more uplink transmissions in an observed time domain, a first transmission rule to select the first set of one or more uplink transmissions, where the observed time domain is associated with the first TAG and the second TAG. The communications manager 1720 may be configured as or otherwise support a means for applying a second transmission rule to the first set of one or more uplink transmissions in accordance with an overlapping between uplink transmissions of the first set of one or more uplink transmissions in a scheduled time domain to obtain a third set of one or more uplink transmissions. The communications manager 1720 may be configured as or otherwise support a means for obtaining, from the UE, one or more uplink transmissions of the third set of one or more uplink transmissions in accordance with the second transmission rule.

By including or configuring the communications manager 1720 in accordance with examples as described herein, the device 1705 (e.g., a processor controlling or otherwise coupled with the receiver 1710, the transmitter 1715, the communications manager 1720, or a combination thereof) may support techniques for reduced processing, reduced power consumption, and more efficient utilization of communication resources.

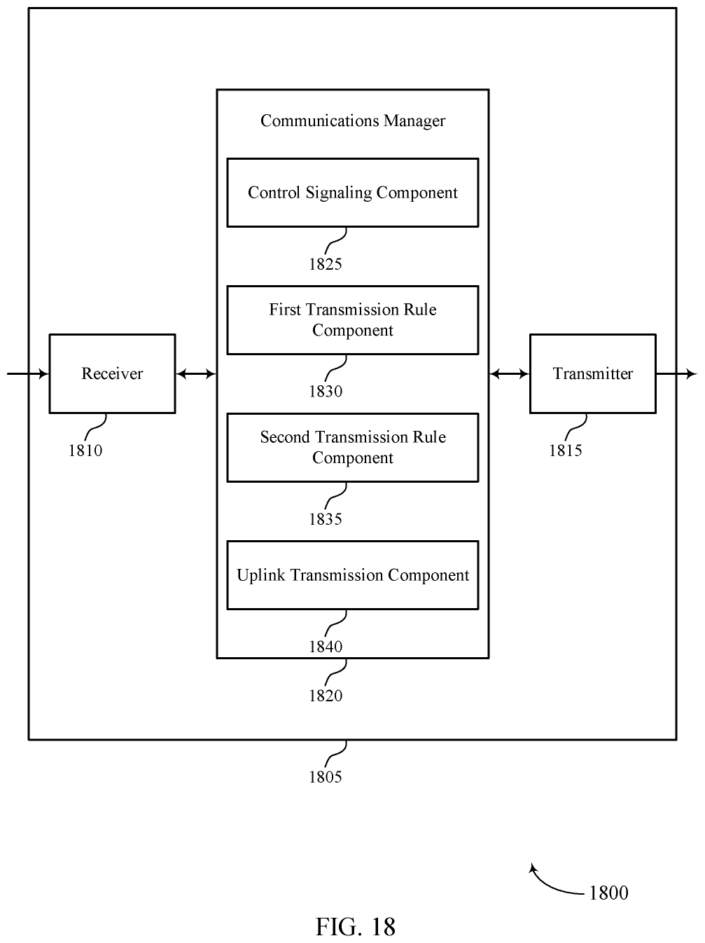

FIG. 18 shows a block diagram 1800 of a device 1805 that supports techniques for handling overlapping uplink transmissions associated with different TAGs in accordance with one or more aspects of the present disclosure. The device 1805 may be an example of aspects of a device 1705 or a network entity 105 as described herein. The device 1805 may include a receiver 1810, a transmitter 1815, and a communications manager 1820. The device 1805 may also include a processor. Each of these components may be in communication with one another (e.g., via one or more buses).

The receiver 1810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1805. In some examples, the receiver 1810 may support obtaining information by receiving signals via one or more antennas. Additionally, or alternatively, the receiver 1810 may support obtaining information by receiving signals via one or more wired (e.g., electrical, fiber optic) interfaces, wireless interfaces, or any combination thereof.

The transmitter 1815 may provide a means for outputting (e.g., transmitting, providing, conveying, sending) information generated by other components of the device 1805. For example, the transmitter 1815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1815 may support outputting information by transmitting signals via one or more antennas. Additionally, or alternatively, the transmitter 1815 may support outputting information by transmitting signals via one or more wired (e.g., electrical, fiber optic) interfaces, wireless interfaces, or any combination thereof. In some examples, the transmitter 1815 and the receiver 1810 may be co-located in a transceiver, which may include or be coupled with a modem.

The device 1805, or various components thereof, may be an example of means for performing various aspects of techniques for handling overlapping uplink transmissions associated with different TAGs as described herein. For example, the communications manager 1820 may include a control signaling component 1825, a first transmission rule component 1830, a second transmission rule component 1835, an uplink transmission component 1840, or any combination thereof. The communications manager 1820 may be an example of aspects of a communications manager 1720 as described herein. In some examples, the communications manager 1820, or various components thereof, may be configured to perform various operations (e.g., receiving, obtaining, monitoring, outputting, transmitting) using or otherwise in cooperation with the receiver 1810, the transmitter 1815, or both. For example, the communications manager 1820 may receive information from the receiver 1810, send information to the transmitter 1815, or be integrated in combination with the receiver 1810, the transmitter 1815, or both to obtain information, output information, or perform various other operations as described herein.

The communications manager 1820 may support wireless communications at a network entity in accordance with examples as disclosed herein. The control signaling component 1825 may be configured as or otherwise support a means for outputting, to a UE via a first component and over a first CORESET associated with a first CORESET pool index of a serving cell, first control signaling scheduling a first set of one or more uplink transmissions associated with a first TAG. The control signaling component 1825 may be configured as or otherwise support a means for outputting, to the UE via a second component and over a second CORESET associated with a second CORESET pool index of the serving cell, second control signaling scheduling a second set of one or more uplink transmissions associated with a second TAG. The first transmission rule component 1830 may be configured as or otherwise support a means for applying, to the first set of one or more uplink transmissions and the second set of one or more uplink transmissions in accordance with an overlapping between uplink transmissions of one or both of the first set of one or more uplink transmissions and the second set of one or more uplink transmissions in a scheduled time domain, a first transmission rule to obtain a first uplink transmission in a first scheduled time domain location and a second uplink transmission in a second scheduled time domain location. The second transmission rule component 1835 may be configured as or otherwise support a means for applying a second transmission rule to the first uplink transmission and the second uplink transmission in accordance with an overlapping between the first uplink transmission and the second uplink transmission in an observed time domain, where the observed time domain is associated with the first TAG and the second TAG. The uplink transmission component 1840 may be configured as or otherwise support a means for obtaining, from the UE, one or both of the first uplink transmission and the second uplink transmission in accordance with the second transmission rule.

Additionally, or alternatively, the communications manager 1820 may support wireless communications at a network entity in accordance with examples as disclosed herein. The control signaling component 1825 may be configured as or otherwise support a means for outputting, to a UE via a first component and over a first CORESET associated with a first CORESET pool index of a serving cell, first control signaling scheduling a first set of multiple uplink transmissions associated with a first TAG. The control signaling component 1825 may be configured as or otherwise support a means for outputting, to the UE via a second component and over a second CORESET associated with a second CORESET pool index of the serving cell, second control signaling scheduling a second set of multiple uplink transmissions associated with a second TAG. The first transmission rule component 1830 may be configured as or otherwise support a means for applying, to obtain a first set of one or more uplink transmissions associated with the first TAG and a second set of one or more uplink transmissions associated with the second TAG, a first transmission rule to each of the first set of multiple uplink transmissions and the second set of multiple uplink transmissions independently and in accordance with an overlapping between uplink transmissions of the first set of multiple uplink transmissions in a scheduled time domain, and between uplink transmissions of the second set of multiple uplink transmissions in the scheduled time domain. The second transmission rule component 1835 may be configured as or otherwise support a means for applying a second transmission rule to the first set of one or more uplink transmissions and the second set of one or more uplink transmissions in accordance with an overlapping between the first set of one or more uplink transmissions and the second set of one or more uplink transmissions in an observed time domain, where the observed time domain is associated with the first TAG and the second TAG. The uplink transmission component 1840 may be configured as or otherwise support a means for obtaining, from the UE, one or more of the first set of one or more uplink transmissions and the second set of one or more uplink transmissions in accordance with the second transmission rule.

Additionally, or alternatively, the communications manager 1820 may support wireless communications at a network entity in accordance with examples as disclosed herein. The control signaling component 1825 may be configured as or otherwise support a means for outputting, to a UE via a first component and over a first CORESET associated with a first CORESET pool index of a serving cell, first control signaling scheduling a first set of one or more uplink transmissions associated with a first TAG. The control signaling component 1825 may be configured as or otherwise support a means for outputting, to the UE via a second component and over a second CORESET associated with a second CORESET pool index of the serving cell, second control signaling scheduling a second set of one or more uplink transmissions associated with a second TAG. The first transmission rule component 1830 may be configured as or otherwise support a means for applying, to the first set of one or more uplink transmissions and the second set of one or more uplink transmissions in accordance with an overlapping between the first set of one or more uplink transmissions and the second set of one or more uplink transmissions in an observed time domain, a first transmission rule to select the first set of one or more uplink transmissions, where the observed time domain is associated with the first TAG and the second TAG. The second transmission rule component 1835 may be configured as or otherwise support a means for applying a second transmission rule to the first set of one or more uplink transmissions in accordance with an overlapping between uplink transmissions of the first set of one or more uplink transmissions in a scheduled time domain to obtain a third set of one or more uplink transmissions. The uplink transmission component 1840 may be configured as or otherwise support a means for obtaining, from the UE, one or more uplink transmissions of the third set of one or more uplink transmissions in accordance with the second transmission rule.

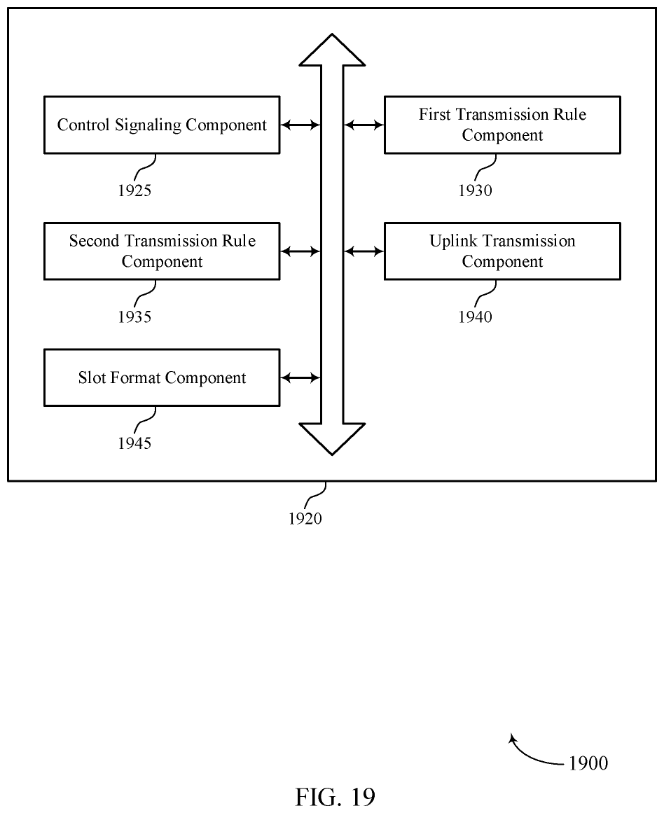

FIG. 19 shows a block diagram 1900 of a communications manager 1920 that supports techniques for handling overlapping uplink transmissions associated with different TAGs in accordance with one or more aspects of the present disclosure. The communications manager 1920 may be an example of aspects of a communications manager 1720, a communications manager 1820, or both, as described herein. The communications manager 1920, or various components thereof, may be an example of means for performing various aspects of techniques for handling overlapping uplink transmissions associated with different TAGs as described herein. For example, the communications manager 1920 may include a control signaling component 1925, a first transmission rule component 1930, a second transmission rule component 1935, an uplink transmission component 1940, a slot format component 1945, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1920 may support wireless communications at a network entity in accordance with examples as disclosed herein. The control signaling component 1925 may be configured as or otherwise support a means for outputting, to a UE via a first component and over a first CORESET associated with a first CORESET pool index of a serving cell, first control signaling scheduling a first set of one or more uplink transmissions associated with a first TAG. In some examples, the control signaling component 1925 may be configured as or otherwise support a means for outputting, to the UE via a second component and over a second CORESET associated with a second CORESET pool index of the serving cell, second control signaling scheduling a second set of one or more uplink transmissions associated with a second TAG. The first transmission rule component 1930 may be configured as or otherwise support a means for applying, to the first set of one or more uplink transmissions and the second set of one or more uplink transmissions in accordance with an overlapping between uplink transmissions of one or both of the first set of one or more uplink transmissions and the second set of one or more uplink transmissions in a scheduled time domain, a first transmission rule to obtain a first uplink transmission in a first scheduled time domain location and a second uplink transmission in a second scheduled time domain location. The second transmission rule component 1935 may be configured as or otherwise support a means for applying a second transmission rule to the first uplink transmission and the second uplink transmission in accordance with an overlapping between the first uplink transmission and the second uplink transmission in an observed time domain, where the observed time domain is associated with the first TAG and the second TAG. The uplink transmission component 1940 may be configured as or otherwise support a means for obtaining, from the UE, one or both of the first uplink transmission and the second uplink transmission in accordance with the second transmission rule.

In some examples, the slot format component 1945 may be configured as or otherwise support a means for selecting one or both of the first uplink transmission and the second uplink transmission in accordance with a slot format, where obtaining one or both of the first uplink transmission and the second uplink transmission is based on selecting one or both of the first uplink transmission and the second uplink transmission in accordance with the slot format.

In some examples, to support applying the first transmission rule to obtain the first uplink transmission in the first scheduled time domain location and the second uplink transmission in the second scheduled time domain location, the first transmission rule component 1930 may be configured as or otherwise support a means for identifying, as multiplexed or dropped, one or more first uplink transmissions of one or both of the first set of one or more uplink transmissions and the second set of one or more uplink transmissions that overlap in the first scheduled time domain location to obtain the first uplink transmission. In some examples, to support applying the first transmission rule to obtain the first uplink transmission in the first scheduled time domain location and the second uplink transmission in the second scheduled time domain location, the first transmission rule component 1930 may be configured as or otherwise support a means for identifying, as multiplexed or dropped, one or more second uplink transmissions of one or both of the first set of one or more uplink transmissions and the second set of one or more uplink transmissions that overlap in the second scheduled time domain location to obtain the second uplink transmission.

In some examples, the one or more first uplink transmissions are identified as dropped based on an error case. In some examples, the error case is associated with the overlapping between the uplink transmissions of at least one of the first set of one or more uplink transmissions and at least one of the second set of one or more uplink transmissions in the scheduled time domain.

In some examples, to support first stage, the first transmission rule component 1930 may be configured as or otherwise support a means for identifying, as multiplexed or dropped, one or more uplink transmissions of the first set of one or more uplink transmissions that overlap in the scheduled time domain to obtain one or both of a first intermediate uplink transmission in the first scheduled time domain location or a second intermediate uplink transmission in the second scheduled time domain location. In some examples, to support first stage, the first transmission rule component 1930 may be configured as or otherwise support a means for identifying, as multiplexed or dropped, one or more uplink transmissions of the second set of one or more uplink transmissions that overlap in the scheduled time domain to obtain one or both of a third intermediate uplink transmission in the first scheduled time domain location or a fourth intermediate uplink transmission in the second scheduled time domain location.

In some examples, to support second stage, the first transmission rule component 1930 may be configured as or otherwise support a means for selecting one of the first intermediate uplink transmission and the third intermediate uplink transmission to obtain the first uplink transmission in the first scheduled time domain location. In some examples, to support second stage, the first transmission rule component 1930 may be configured as or otherwise support a means for selecting one of the second intermediate uplink transmission and the fourth intermediate uplink transmission to obtain the second uplink transmission in the second scheduled time domain location.

In some examples, the network entity communicates with the UE without carrier aggregation. In some examples, the first stage of the first transmission rule, the second stage of the first transmission rule, and the second transmission rule are applied for a single component carrier.

In some examples, the network entity communicates with the UE using carrier aggregation. In some examples, the first stage of the first transmission rule is applied to the first set of one or more uplink transmissions and the second set of one or more uplink transmissions across a first set of component carriers of a first uplink control channel group and associated with a same CORESET pool index. In some examples, the second stage of the first transmission rule and the second transmission rule are applied across a second set of component carriers associated with multiple CORESET pool indices.

In some examples, the second stage of the first transmission rule and the second transmission rule are applied for each component carrier that is associated with the first CORESET pool index and the second CORESET pool index and associated with the first TAG and the second TAG; or for each radio frequency band including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG; or for each uplink control channel group including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG; or for each set of component carriers including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG.

In some examples, to support applying the second transmission rule to the first uplink transmission and the second uplink transmission, the second transmission rule component 1935 may be configured as or otherwise support a means for selecting one or both of the first uplink transmission and the second uplink transmission based on a satisfaction of a condition associated with a capability of the UE.

In some examples, the satisfaction of the condition is based on the first uplink transmission and the second uplink transmission being scheduled for different panels of the UE and the capability of the UE for supporting multi-panel uplink transmission; or simultaneous uplink transmission; or both multi-panel uplink transmission and simultaneous uplink transmission.

In some examples, the satisfaction of the condition is based on the first uplink transmission and the second uplink transmission being scheduled for different panels of the UE, the capability of the UE for supporting multi-panel uplink transmission, and the first uplink transmission and the second uplink transmission being associated with a same channel type.

In some examples, the network entity may select to obtain one of the first uplink transmission and the second uplink transmission based on failing to satisfy the condition. In such examples, to support obtaining one or both of the first uplink transmission and the second uplink transmission, the second transmission rule component 1935 may be configured as or otherwise support a means for obtaining the first uplink transmission based on the first uplink transmission being scheduled in a first symbol or slot in the scheduled time domain. In such examples, to support obtaining one or both of the first uplink transmission and the second uplink transmission, the second transmission rule component 1935 may be configured as or otherwise support a means for obtaining a portion of the second uplink transmission that does not overlap with the first uplink transmission in the observed time domain based on the second uplink transmission being scheduled in a second symbol or slot in the scheduled time domain, where the first symbol or slot is earlier than the second symbol or slot.

In some examples, the network entity may select to obtain one of the first uplink transmission and the second uplink transmission based on failing to satisfy the condition. In such examples, to support obtaining one or both of the first uplink transmission and the second uplink transmission, the second transmission rule component 1935 may be configured as or otherwise support a means for obtaining the first uplink transmission based on the first uplink transmission being scheduled in a first symbol or slot in the scheduled time domain. In such examples, to support obtaining one or both of the first uplink transmission and the second uplink transmission, the second transmission rule component 1935 may be configured as or otherwise support a means for identifying the second uplink transmission as dropped based on the second uplink transmission being scheduled in a second symbol or slot in the scheduled time domain, where the first symbol or slot is earlier than the second symbol or slot.

In some examples, the network entity may select to obtain one of the first uplink transmission and the second uplink transmission based on failing to satisfy the condition. In such examples, to support obtaining one or both of the first uplink transmission and the second uplink transmission, the second transmission rule component 1935 may be configured as or otherwise support a means for obtaining the first uplink transmission based on the first uplink transmission being scheduled in a first symbol or slot in the observed time domain. In such examples, to support obtaining one or both of the first uplink transmission and the second uplink transmission, the second transmission rule component 1935 may be configured as or otherwise support a means for obtaining a portion of the second uplink transmission that does not overlap with the first uplink transmission in the observed time domain based on the second uplink transmission being scheduled in a second symbol or slot in the observed time domain, where the first symbol or slot is earlier than the second symbol or slot.

In some examples, the network entity may select to obtain one of the first uplink transmission and the second uplink transmission based on failing to satisfy the condition. In such examples, to support obtaining one or both of the first uplink transmission and the second uplink transmission, the second transmission rule component 1935 may be configured as or otherwise support a means for obtaining the first uplink transmission based on the first uplink transmission being scheduled in a first symbol or slot in the observed time domain. In such examples, to support obtaining one or both of the first uplink transmission and the second uplink transmission, the second transmission rule component 1935 may be configured as or otherwise support a means for identifying the second uplink transmission as dropped based on the second uplink transmission being scheduled in a second symbol or slot in the observed time domain, where the first symbol or slot is earlier than the second symbol or slot.

In some examples, the network entity may select to obtain one of the first uplink transmission and the second uplink transmission based on failing to satisfy the condition. In such examples, to support obtaining one or both of the first uplink transmission and the second uplink transmission, the second transmission rule component 1935 may be configured as or otherwise support a means for obtaining the first uplink transmission based on the first uplink transmission being associated with the first CORESET pool index. In such examples, to support obtaining one or both of the first uplink transmission and the second uplink transmission, the second transmission rule component 1935 may be configured as or otherwise support a means for obtaining a portion of the second uplink transmission that does not overlap with the first uplink transmission in the observed time domain based on the second uplink transmission being associated with the second CORESET pool index.

In some examples, the network entity may select to obtain one of the first uplink transmission and the second uplink transmission based on failing to satisfy the condition. In such examples, to support obtaining one or both of the first uplink transmission and the second uplink transmission, the second transmission rule component 1935 may be configured as or otherwise support a means for obtaining the first uplink transmission based on the first uplink transmission being associated with the first CORESET pool index. In such examples, to support obtaining one or both of the first uplink transmission and the second uplink transmission, the second transmission rule component 1935 may be configured as or otherwise support a means for identifying the second uplink transmission as dropped based on the second uplink transmission being associated with the second CORESET pool index.

In some examples, the network entity communicates with the UE without carrier aggregation. In some examples, the first transmission rule and the second transmission rule are applied for a single component carrier.

In some examples, the network entity communicates with the UE using carrier aggregation. In some examples, the first transmission rule is applied across a first set of component carriers of an uplink control channel group. In some examples, the second transmission rule is applied across a second set of component carriers associated with multiple CORESET pool indices.

In some examples, the second transmission rule is applied for each component carrier that is associated with the first CORESET pool index and the second CORESET pool index and associated with the first TAG and the second TAG; or for each radio frequency band including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG; or for each uplink control channel group including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG; or for each set of component carriers including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG.

Additionally, or alternatively, the communications manager 1920 may support wireless communications at a network entity in accordance with examples as disclosed herein. In some examples, the control signaling component 1925 may be configured as or otherwise support a means for outputting, to a UE via a first component and over a first CORESET associated with a first CORESET pool index of a serving cell, first control signaling scheduling a first set of multiple uplink transmissions associated with a first TAG. In some examples, the control signaling component 1925 may be configured as or otherwise support a means for outputting, to the UE via a second component and over a second CORESET associated with a second CORESET pool index of the serving cell, second control signaling scheduling a second set of multiple uplink transmissions associated with a second TAG. In some examples, the first transmission rule component 1930 may be configured as or otherwise support a means for applying, to obtain a first set of one or more uplink transmissions associated with the first TAG and a second set of one or more uplink transmissions associated with the second TAG, a first transmission rule to each of the first set of multiple uplink transmissions and the second set of multiple uplink transmissions independently and in accordance with an overlapping between uplink transmissions of the first set of multiple uplink transmissions in a scheduled time domain, and between uplink transmissions of the second set of multiple uplink transmissions in the scheduled time domain. In some examples, the second transmission rule component 1935 may be configured as or otherwise support a means for applying a second transmission rule to the first set of one or more uplink transmissions and the second set of one or more uplink transmissions in accordance with an overlapping between the first set of one or more uplink transmissions and the second set of one or more uplink transmissions in an observed time domain, where the observed time domain is associated with the first TAG and the second TAG. In some examples, the uplink transmission component 1940 may be configured as or otherwise support a means for obtaining, from the UE, one or more of the first set of one or more uplink transmissions and the second set of one or more uplink transmissions in accordance with the second transmission rule.

In some examples, the slot format component 1945 may be configured as or otherwise support a means for selecting one or more of the first set of one or more uplink transmissions and the second set of one or more uplink transmissions in accordance with a slot format, where obtaining one or more of the first set of one or more uplink transmissions and the second set of one or more uplink transmissions is based on selecting the one or more of the first set of one or more uplink transmissions and the second set of one or more uplink transmissions in accordance with the slot format.

In some examples, to support applying the first transmission rule to obtain the first set of one or more uplink transmissions associated with the first TAG and the second set of one or more uplink transmissions associated with the second TAG, the first transmission rule component 1930 may be configured as or otherwise support a means for identifying, as multiplexed or dropped, one or more uplink transmissions of the first set of multiple uplink transmissions that overlap in the scheduled time domain to obtain the first set of one or more uplink transmissions associated with the first TAG. In some examples, to support applying the first transmission rule to obtain the first set of one or more uplink transmissions associated with the first TAG and the second set of one or more uplink transmissions associated with the second TAG, the first transmission rule component 1930 may be configured as or otherwise support a means for identifying, as multiplexed or dropped, one or more uplink transmissions of the second set of multiple uplink transmissions that overlap in the scheduled time domain to obtain the second set of one or more uplink transmissions associated with the second TAG.

In some examples, the first set of one or more uplink transmissions associated with the first TAG is in one or both of a first scheduled time domain location and a second scheduled time domain location. In some examples, the second set of one or more uplink transmissions associated with the second TAG is in one or both of the first scheduled time domain location and the second scheduled time domain location.

In some examples, to support applying the second transmission rule to the first set of one or more uplink transmissions and the second set of one or more uplink transmissions, the second transmission rule component 1935 may be configured as or otherwise support a means for selecting one or more uplink transmissions of one or both the first set of one or more uplink transmissions and the second set of one or more uplink transmissions based on a satisfaction of a condition associated with a capability of the UE.

In some examples, the satisfaction of the condition is based on any overlapping uplink transmissions of the first set of one or more uplink transmissions and the second set of one or more uplink transmissions in the observed time domain being scheduled for different panels of the UE and the capability of the UE for supporting multi-panel uplink transmission; or simultaneous uplink transmission; or both multi-panel uplink transmission and simultaneous uplink transmission.

In some examples, the satisfaction of the condition is based on any overlapping uplink transmissions of the first set of one or more uplink transmissions and the second set of one or more uplink transmissions in the observed time domain being scheduled for different panels of the UE, the capability of the UE for supporting multi-panel uplink transmission, and the one or more of the first set of one or more uplink transmissions and the second set of one or more uplink transmissions being associated with a same channel type.

In some examples, a first uplink transmission and a second uplink transmission may overlap the observed time domain and the network entity may select to obtain one of the first uplink such and the second uplink transmission based on failing to satisfy the condition. In such examples, to support obtaining the one or more of the first set of one or more uplink transmissions and the second set of one or more uplink transmissions, the second transmission rule component 1935 may be configured as or otherwise support a means for obtaining the first uplink transmission based on the first uplink transmission being scheduled in a first symbol or slot in the scheduled time domain. In such examples, to support obtaining the one or more of the first set of one or more uplink transmissions and the second set of one or more uplink transmissions, the second transmission rule component 1935 may be configured as or otherwise support a means for identifying the second uplink transmission as dropped based on the second uplink transmission being scheduled in a second symbol or slot in the scheduled time domain, where the first symbol or slot is earlier than the second symbol or slot.

In some examples, a first uplink transmission and a second uplink transmission may overlap the observed time domain and the network entity may select to obtain one of the first uplink such and the second uplink transmission based on failing to satisfy the condition. In such examples, to support obtaining the one or more of the first set of one or more uplink transmissions and the second set of one or more uplink transmissions, the second transmission rule component 1935 may be configured as or otherwise support a means for obtaining the first uplink transmission based on the first uplink transmission being scheduled in a first symbol or slot in the observed time domain. In such examples, to support obtaining the one or more of the first set of one or more uplink transmissions and the second set of one or more uplink transmissions, the second transmission rule component 1935 may be configured as or otherwise support a means for identifying the second uplink transmission as dropped based on the second uplink transmission being scheduled in a second symbol or slot in the observed time domain, where the first symbol or slot is earlier than the second symbol or slot.

In some examples, a first uplink transmission and a second uplink transmission may overlap the observed time domain and the network entity may select to obtain one of the first uplink such and the second uplink transmission based on failing to satisfy the condition. In such examples, to support obtaining the one or more of the first set of one or more uplink transmissions and the second set of one or more uplink transmissions, the second transmission rule component 1935 may be configured as or otherwise support a means for obtaining the first uplink transmission based on the first uplink transmission being associated with the first CORESET pool index. In such examples, to support obtaining the one or more of the first set of one or more uplink transmissions and the second set of one or more uplink transmissions, the second transmission rule component 1935 may be configured as or otherwise support a means for identifying the second uplink transmission as dropped based on the second uplink transmission being associated with the second CORESET pool index.

In some examples, the network entity communicates with the UE without carrier aggregation. In some examples, the first transmission rule and the second transmission rule are applied for a single component carrier.

In some examples, the network entity communicates with the UE without carrier aggregation. In some examples, the first transmission rule is applied to each of the first set of multiple uplink transmissions and the second set of multiple uplink transmissions independently across a first set of component carriers of a first uplink control channel group and associated with a same CORESET pool index. In some examples, the second transmission rule is applied across a second set of component carriers associated with multiple CORESET pool indices.

In some examples, the second transmission rule is applied for each component carrier that is associated with the first CORESET pool index and the second CORESET pool index and associated with the first TAG and the second TAG; or for each radio frequency band including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG; or for each uplink control channel group including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG; or for each set of component carriers including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG.

Additionally, or alternatively, the communications manager 1920 may support wireless communications at a network entity in accordance with examples as disclosed herein. In some examples, the control signaling component 1925 may be configured as or otherwise support a means for outputting, to a UE via a first component and over a first CORESET associated with a first CORESET pool index of a serving cell, first control signaling scheduling a first set of one or more uplink transmissions associated with a first TAG. In some examples, the control signaling component 1925 may be configured as or otherwise support a means for outputting, to the UE via a second component and over a second CORESET associated with a second CORESET pool index of the serving cell, second control signaling scheduling a second set of one or more uplink transmissions associated with a second TAG. In some examples, the first transmission rule component 1930 may be configured as or otherwise support a means for applying, to the first set of one or more uplink transmissions and the second set of one or more uplink transmissions in accordance with an overlapping between the first set of one or more uplink transmissions and the second set of one or more uplink transmissions in an observed time domain, a first transmission rule to select the first set of one or more uplink transmissions, where the observed time domain is associated with the first TAG and the second TAG. In some examples, the second transmission rule component 1935 may be configured as or otherwise support a means for applying a second transmission rule to the first set of one or more uplink transmissions in accordance with an overlapping between uplink transmissions of the first set of one or more uplink transmissions in a scheduled time domain to obtain a third set of one or more uplink transmissions. In some examples, the uplink transmission component 1940 may be configured as or otherwise support a means for obtaining, from the UE, one or more uplink transmissions of the third set of one or more uplink transmissions in accordance with the second transmission rule.

In some examples, the slot format component 1945 may be configured as or otherwise support a means for selecting the one or more uplink transmissions from the third set of one or more uplink transmissions in accordance with a slot format, where obtaining the one or more uplink transmissions is based on selecting the one or more uplink transmissions from the third set of one or more uplink transmissions in accordance with the slot format.

In some examples, to support applying the first transmission rule to obtain the first set of one or more uplink transmissions, the first transmission rule component 1930 may be configured as or otherwise support a means for selecting the first set of one or more uplink transmissions based on the first TAG associated with the first set of one or more uplink transmissions being smaller than the second TAG associated with the second set of one or more uplink transmissions.

In some examples, to support applying the first transmission rule to obtain the first set of one or more uplink transmissions, the first transmission rule component 1930 may be configured as or otherwise support a means for selecting the first set of one or more uplink transmissions based on the first TAG associated with the first set of one or more uplink transmissions being larger than the second TAG associated with the second set of one or more uplink transmissions.

In some examples, to support applying the first transmission rule to obtain the first set of one or more uplink transmissions, the first transmission rule component 1930 may be configured as or otherwise support a means for selecting the first set of one or more uplink transmissions based on a first TAG index associated with the first set of one or more uplink transmissions being larger than a second TAG index associated with the second set of one or more uplink transmissions.

In some examples, to support applying the first transmission rule to obtain the first set of one or more uplink transmissions, the first transmission rule component 1930 may be configured as or otherwise support a means for selecting the first set of one or more uplink transmissions based on a first TAG index associated with the first set of one or more uplink transmissions being smaller than a second TAG index associated with the second set of one or more uplink transmissions.

In some examples, to support applying the first transmission rule to obtain the first set of one or more uplink transmissions, the first transmission rule component 1930 may be configured as or otherwise support a means for selecting the first set of one or more uplink transmissions based on the first CORESET pool index associated with the first set of one or more uplink transmissions.

In some examples, to support applying the first transmission rule to obtain the first set of one or more uplink transmissions, the first transmission rule component 1930 may be configured as or otherwise support a means for selecting the first set of one or more uplink transmissions based on a closed loop power control index associated with the first set of one or more uplink transmissions.

In some examples, to support applying the second transmission rule to the first set of one or more uplink transmissions, the second transmission rule component 1935 may be configured as or otherwise support a means for identifying, as multiplexed or dropped, uplink transmissions of the first set of one or more uplink transmissions that overlap in the scheduled time domain to obtain the third set of one or more uplink transmissions.

In some examples, the network entity communicates with the UE without carrier aggregation. In some examples, the first transmission rule and the second transmission rule are applied for a single component carrier.

In some examples, the network entity communicates with the UE using carrier aggregation. In some examples, the first transmission rule is applied to the first set of one or more uplink transmissions and the second set of one or more uplink transmissions across a first set of component carriers associated with multiple CORESET pool indices. In some examples, the second transmission rule is applied across a second set of component carriers of an uplink control channel group associated with a same CORESET pool index.

In some examples, the first transmission rule is applied for each component carrier that is associated with the first CORESET pool index and the second CORESET pool index and associated with the first TAG and the second TAG; or for each radio frequency band including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG; or for each uplink control channel group including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG; or for each set of component carriers including at least one component carrier associated with the first CORESET pool index and the second CORESET pool index and associated with the first TAG and the second TAG and including other component carriers associated with at least one of the first CORESET pool index and the second CORESET pool index and at least one of the first TAG and the second TAG.

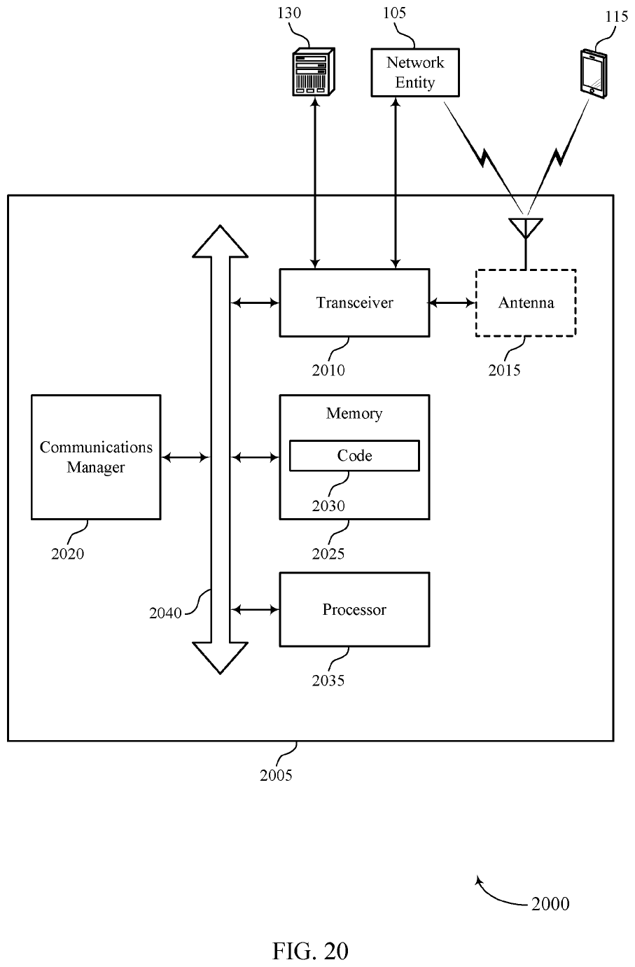

FIG. 20 shows a diagram of a system 2000 including a device 2005 that supports techniques for handling overlapping uplink transmissions associated with different TAGs in accordance with one or more aspects of the present disclosure. The device 2005 may be an example of or include the components of a device 1705, a device 1805, or a network entity 105 as described herein. The device 2005 may communicate with one or more network entities 105, one or more UEs 115, or any combination thereof, which may include communications over one or more wired interfaces, over one or more wireless interfaces, or any combination thereof. The device 2005 may include components that support outputting and obtaining communications, such as a communications manager 2020, a transceiver 2010, an antenna 2015, a memory 2025, code 2030, and a processor 2035. These components may be in electronic communication or otherwise coupled (e.g., operatively, communicatively, functionally, electronically, electrically) via one or more buses (e.g., a bus 2040).

The transceiver 2010 may support bi-directional communications via wired links, wireless links, or both as described herein. In some examples, the transceiver 2010 may include a wired transceiver and may communicate bi-directionally with another wired transceiver. Additionally, or alternatively, in some examples, the transceiver 2010 may include a wireless transceiver and may communicate bi-directionally with another wireless transceiver. In some examples, the device 2005 may include one or more antennas 2015, which may be capable of transmitting or receiving wireless transmissions (e.g., concurrently). The transceiver 2010 may also include a modem to modulate signals, to provide the modulated signals for transmission (e.g., by one or more antennas 2015, by a wired transmitter), to receive modulated signals (e.g., from one or more antennas 2015, from a wired receiver), and to demodulate signals. The transceiver 2010, or the transceiver 2010 and one or more antennas 2015 or wired interfaces, where applicable, may be an example of a transmitter 1715, a transmitter 1815, a receiver 1710, a receiver 1810, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 2025 may include RAM and ROM. The memory 2025 may store computer-readable, computer-executable code 2030 including instructions that, when executed by the processor 2035, cause the device 2005 to perform various functions described herein. The code 2030 may be stored in a non-transitory computer-readable medium such as system memory or another type of memory. In some cases, the code 2030 may not be directly executable by the processor 2035 but may cause a computer (e.g., when compiled and executed) to perform functions described herein. In some cases, the memory 2025 may contain, among other things, a BIOS which may control basic hardware or software operation such as the interaction with peripheral components or devices.

The processor 2035 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 2035 may be configured to operate a memory array using a memory controller. In some other cases, a memory controller may be integrated into the processor 2035. The processor 2035 may be configured to execute computer-readable instructions stored in a memory (e.g., the memory 2025) to cause the device 2005 to perform various functions (e.g., functions or tasks supporting techniques for handling overlapping uplink transmissions associated with different TAGs). For example, the device 2005 or a component of the device 2005 may include a processor 2035 and memory 2025 coupled with the processor 2035, the processor 2035 and memory 2025 configured to perform various functions described herein. The processor 2035 may be an example of a cloud-computing platform (e.g., one or more physical nodes and supporting software such as operating systems, virtual machines, or container instances) that may host the functions (e.g., by executing code 2030) to perform the functions of the device 2005.

In some examples, a bus 2040 may support communications of (e.g., within) a protocol layer of a protocol stack. In some examples, a bus 2040 may support communications associated with a logical channel of a protocol stack (e.g., between protocol layers of a protocol stack), which may include communications performed within a component of the device 2005, or between different components of the device 2005 that may be co-located or located in different locations (e.g., where the device 2005 may refer to a system in which one or more of the communications manager 2020, the transceiver 2010, the memory 2025, the code 2030, and the processor 2035 may be located in one of the different components or divided between different components).

In some examples, the communications manager 2020 may manage aspects of communications with a core network 130 (e.g., via one or more wired or wireless backhaul links). For example, the communications manager 2020 may manage the transfer of data communications for client devices, such as one or more UEs 115. In some examples, the communications manager 2020 may manage communications with other network entities 105, and may include a controller or scheduler for controlling communications with UEs 115 in cooperation with other network entities 105. In some examples, the communications manager 2020 may support an X2 interface within an LTE/LTE-A wireless communications network technology to provide communication between network entities 105.

The communications manager 2020 may support wireless communications at a network entity in accordance with examples as disclosed herein. For example, the communications manager 2020 may be configured as or otherwise support a means for outputting, to a UE via a first component and over a first CORESET associated with a first CORESET pool index of a serving cell, first control signaling scheduling a first set of one or more uplink transmissions associated with a first TAG. The communications manager 2020 may be configured as or otherwise support a means for outputting, to the UE via a second component and over a second CORESET associated with a second CORESET pool index of the serving cell, second control signaling scheduling a second set of one or more uplink transmissions associated with a second TAG. The communications manager 2020 may be configured as or otherwise support a means for applying, to the first set of one or more uplink transmissions and the second set of one or more uplink transmissions in accordance with an overlapping between uplink transmissions of one or both of the first set of one or more uplink transmissions and the second set of one or more uplink transmissions in a scheduled time domain, a first transmission rule to obtain a first uplink transmission in a first scheduled time domain location and a second uplink transmission in a second scheduled time domain location. The communications manager 2020 may be configured as or otherwise support a means for applying a second transmission rule to the first uplink transmission and the second uplink transmission in accordance with an overlapping between the first uplink transmission and the second uplink transmission in an observed time domain, where the observed time domain is associated with the first TAG and the second TAG. The communications manager 2020 may be configured as or otherwise support a means for obtaining, from the UE, one or both of the first uplink transmission and the second uplink transmission in accordance with the second transmission rule.

Additionally, or alternatively, the communications manager 2020 may support wireless communications at a network entity in accordance with examples as disclosed herein. For example, the communications manager 2020 may be configured as or otherwise support a means for outputting, to a UE via a first component and over a first CORESET associated with a first CORESET pool index of a serving cell, first control signaling scheduling a first set of multiple uplink transmissions associated with a first TAG. The communications manager 2020 may be configured as or otherwise support a means for outputting, to the UE via a second component and over a second CORESET associated with a second CORESET pool index of the serving cell, second control signaling scheduling a second set of multiple uplink transmissions associated with a second TAG. The communications manager 2020 may be configured as or otherwise support a means for applying, to obtain a first set of one or more uplink transmissions associated with the first TAG and a second set of one or more uplink transmissions associated with the second TAG, a first transmission rule to each of the first set of multiple uplink transmissions and the second set of multiple uplink transmissions independently and in accordance with an overlapping between uplink transmissions of the first set of multiple uplink transmissions in a scheduled time domain, and between uplink transmissions of the second set of multiple uplink transmissions in the scheduled time domain. The communications manager 2020 may be configured as or otherwise support a means for applying a second transmission rule to the first set of one or more uplink transmissions and the second set of one or more uplink transmissions in accordance with an overlapping between the first set of one or more uplink transmissions and the second set of one or more uplink transmissions in an observed time domain, where the observed time domain is associated with the first TAG and the second TAG. The communications manager 2020 may be configured as or otherwise support a means for obtaining, from the UE, one or more of the first set of one or more uplink transmissions and the second set of one or more uplink transmissions in accordance with the second transmission rule.

Additionally, or alternatively, the communications manager 2020 may support wireless communications at a network entity in accordance with examples as disclosed herein. For example, the communications manager 2020 may be configured as or otherwise support a means for outputting, to a UE via a first component and over a first CORESET associated with a first CORESET pool index of a serving cell, first control signaling scheduling a first set of one or more uplink transmissions associated with a first TAG. The communications manager 2020 may be configured as or otherwise support a means for outputting, to the UE via a second component and over a second CORESET associated with a second CORESET pool index of the serving cell, second control signaling scheduling a second set of one or more uplink transmissions associated with a second TAG. The communications manager 2020 may be configured as or otherwise support a means for applying, to the first set of one or more uplink transmissions and the second set of one or more uplink transmissions in accordance with an overlapping between the first set of one or more uplink transmissions and the second set of one or more uplink transmissions in an observed time domain, a first transmission rule to select the first set of one or more uplink transmissions, where the observed time domain is associated with the first TAG and the second TAG. The communications manager 2020 may be configured as or otherwise support a means for applying a second transmission rule to the first set of one or more uplink transmissions in accordance with an overlapping between uplink transmissions of the first set of one or more uplink transmissions in a scheduled time domain to obtain a third set of one or more uplink transmissions. The communications manager 2020 may be configured as or otherwise support a means for obtaining, from the UE, one or more uplink transmissions of the third set of one or more uplink transmissions in accordance with the second transmission rule.

By including or configuring the communications manager 2020 in accordance with examples as described herein, the device 2005 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 2020 may be configured to perform various operations (e.g., receiving, obtaining, monitoring, outputting, transmitting) using or otherwise in cooperation with the transceiver 2010, the one or more antennas 2015 (e.g., where applicable), or any combination thereof. Although the communications manager 2020 is illustrated as a separate component, in some examples, one or more functions described with reference to the communications manager 2020 may be supported by or performed by the processor 2035, the memory 2025, the code 2030, the transceiver 2010, or any combination thereof. For example, the code 2030 may include instructions executable by the processor 2035 to cause the device 2005 to perform various aspects of techniques for handling overlapping uplink transmissions associated with different TAGs as described herein, or the processor 2035 and the memory 2025 may be otherwise configured to perform or support such operations.

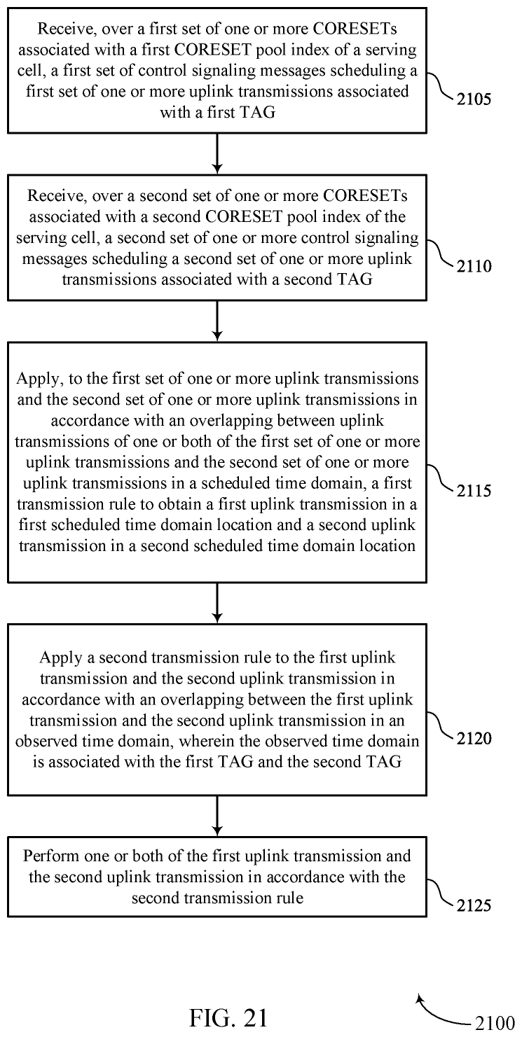

FIG. 21 shows a flowchart illustrating a method 2100 that supports techniques for handling overlapping uplink transmissions associated with different TAGs in accordance with one or more aspects of the present disclosure. The operations of the method 2100 may be implemented by a UE or its components as described herein. For example, the operations of the method 2100 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 2105, the method may include receiving, over a first set of one or more CORESETs associated with a first CORESET pool index of a serving cell, a first set of one or more control signaling messages scheduling a first set of one or more uplink transmissions associated with a first TAG. The operations of 2105 may be performed in accordance with examples as disclosed herein. In some examples, aspects of the operations of 2105 may be performed by a control signaling component 1525 as described with reference to FIG. 15.

At 2110, the method may include receiving, over a second set of one or more CORESETs associated with a second CORESET pool index of the serving cell, a second set of one or more control signaling messages scheduling a second set of one or more uplink transmissions associated with a second TAG. The operations of 2110 may be performed in accordance with examples as disclosed herein. In some examples, aspects of the operations of 2110 may be performed by a control signaling component 1525 as described with reference to FIG. 15.

At 2115, the method may include applying, to the first set of one or more uplink transmissions and the second set of one or more uplink transmissions in accordance with an overlapping between uplink transmissions of one or both of the first set of one or more uplink transmissions and the second set of one or more uplink transmissions in a scheduled time domain, a first transmission rule to obtain a first uplink transmission in a first scheduled time domain location and a second uplink transmission in a second scheduled time domain location. The operations of 2115 may be performed in accordance with examples as disclosed herein. In some examples, aspects of the operations of 2115 may be performed by a first transmission rule component 1530 as described with reference to FIG. 15.

At 2120, the method may include applying a second transmission rule to the first uplink transmission and the second uplink transmission in accordance with an overlapping between the first uplink transmission and the second uplink transmission in an observed time domain, where the observed time domain is associated with the first TAG and the second TAG. The operations of 2120 may be performed in accordance with examples as disclosed herein. In some examples, aspects of the operations of 2120 may be performed by a second transmission rule component 1535 as described with reference to FIG. 15.

At 2125, the method may include performing one or both of the first uplink transmission and the second uplink transmission in accordance with the second transmission rule. The operations of 2125 may be performed in accordance with examples as disclosed herein. In some examples, aspects of the operations of 2125 may be performed by an uplink transmission component 1540 as described with reference to FIG. 15.

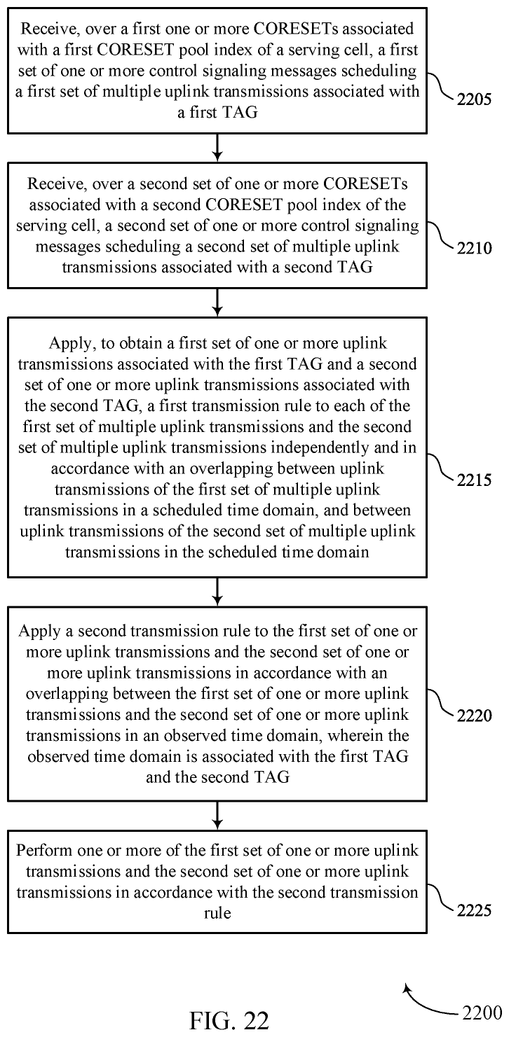

FIG. 22 shows a flowchart illustrating a method 2200 that supports techniques for handling overlapping uplink transmissions associated with different TAGs in accordance with one or more aspects of the present disclosure. The operations of the method 2200 may be implemented by a UE or its components as described herein. For example, the operations of the method 2200 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 2205, the method may include receiving, over a first set of one or more CORESETs associated with a first CORESET pool index of a serving cell, a first set of one or more control signaling messages scheduling a first set of multiple uplink transmissions associated with a first TAG. The operations of 2205 may be performed in accordance with examples as disclosed herein. In some examples, aspects of the operations of 2205 may be performed by a control signaling component 1525 as described with reference to FIG. 15.

At 2210, the method may include receiving, over a second set of one or more CORESETs associated with a second CORESET pool index of the serving cell, a second set of one or more control signaling messages scheduling a second set of multiple uplink transmissions associated with a second TAG. The operations of 2210 may be performed in accordance with examples as disclosed herein. In some examples, aspects of the operations of 2210 may be performed by a control signaling component 1525 as described with reference to FIG. 15.

At 2215, the method may include applying, to obtain a first set of one or more uplink transmissions associated with the first TAG and a second set of one or more uplink transmissions associated with the second TAG, a first transmission rule to each of the first set of multiple uplink transmissions and the second set of multiple uplink transmissions independently and in accordance with an overlapping between uplink transmissions of the first set of multiple uplink transmissions in a scheduled time domain, and between uplink transmissions of the second set of multiple uplink transmissions in the scheduled time domain. The operations of 2215 may be performed in accordance with examples as disclosed herein. In some examples, aspects of the operations of 2215 may be performed by a first transmission rule component 1530 as described with reference to FIG. 15.

At 2220, the method may include applying a second transmission rule to the first set of one or more uplink transmissions and the second set of one or more uplink transmissions in accordance with an overlapping between the first set of one or more uplink transmissions and the second set of one or more uplink transmissions in an observed time domain, where the observed time domain is associated with the first TAG and the second TAG. The operations of 2220 may be performed in accordance with examples as disclosed herein. In some examples, aspects of the operations of 2220 may be performed by a second transmission rule component 1535 as described with reference to FIG. 15.

At 2225, the method may include performing one or more of the first set of one or more uplink transmissions and the second set of one or more uplink transmissions in accordance with the second transmission rule. The operations of 2225 may be performed in accordance with examples as disclosed herein. In some examples, aspects of the operations of 2225 may be performed by an uplink transmission component 1540 as described with reference to FIG. 15.

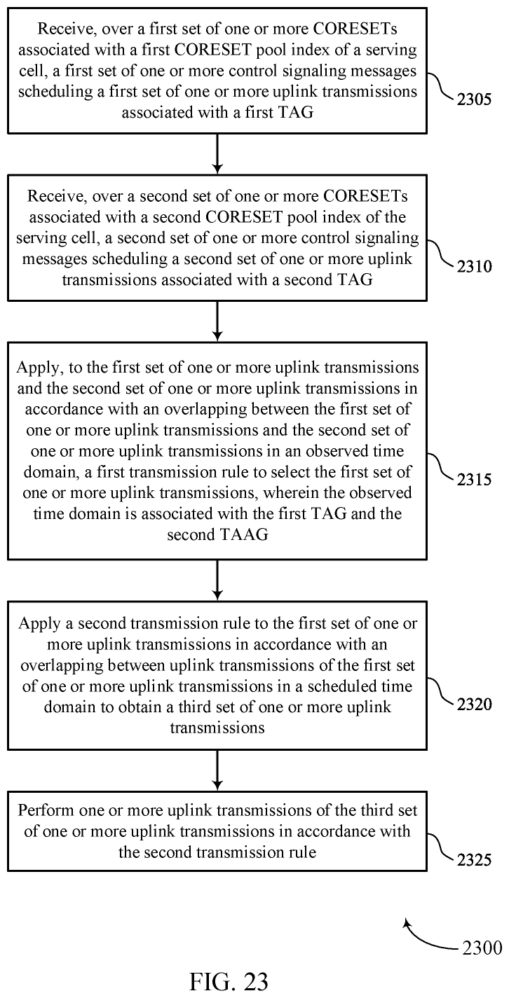

FIG. 23 shows a flowchart illustrating a method 2300 that supports techniques for handling overlapping uplink transmissions associated with different TAGs in accordance with one or more aspects of the present disclosure. The operations of the method 2300 may be implemented by a UE or its components as described herein. For example, the operations of the method 2300 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 2305, the method may include receiving, over a first set of one or more CORESETs associated with a first CORESET pool index of a serving cell, a first set of one or more control signaling messages scheduling a first set of one or more uplink transmissions associated with a first TAG. The operations of 2305 may be performed in accordance with examples as disclosed herein. In some examples, aspects of the operations of 2305 may be performed by a control signaling component 1525 as described with reference to FIG. 15.

At 2310, the method may include receiving, over a second set of one or more CORESETs associated with a second CORESET pool index of the serving cell, a second set of one or more control signaling messages scheduling a second set of one or more uplink transmissions associated with a second TAG. The operations of 2310 may be performed in accordance with examples as disclosed herein. In some examples, aspects of the operations of 2310 may be performed by a control signaling component 1525 as described with reference to FIG. 15.

At 2315, the method may include applying, to the first set of one or more uplink transmissions and the second set of one or more uplink transmissions in accordance with an overlapping between the first set of one or more uplink transmissions and the second set of one or more uplink transmissions in an observed time domain, a first transmission rule to select the first set of one or more uplink transmissions, where the observed time domain is associated with the first TAG and the second TAG. The operations of 2315 may be performed in accordance with examples as disclosed herein. In some examples, aspects of the operations of 2315 may be performed by a first transmission rule component 1530 as described with reference to FIG. 15.

At 2320, the method may include applying a second transmission rule to the first set of one or more uplink transmissions in accordance with an overlapping between uplink transmissions of the first set of one or more uplink transmissions in a scheduled time domain to obtain a third set of one or more uplink transmissions. The operations of 2320 may be performed in accordance with examples as disclosed herein. In some examples, aspects of the operations of 2320 may be performed by a second transmission rule component 1535 as described with reference to FIG. 15.

At 2325, the method may include performing one or more uplink transmissions of the third set of one or more uplink transmissions in accordance with the second transmission rule. The operations of 2325 may be performed in accordance with examples as disclosed herein. In some examples, aspects of the operations of 2325 may be performed by an uplink transmission component 1540 as described with reference to FIG. 15.

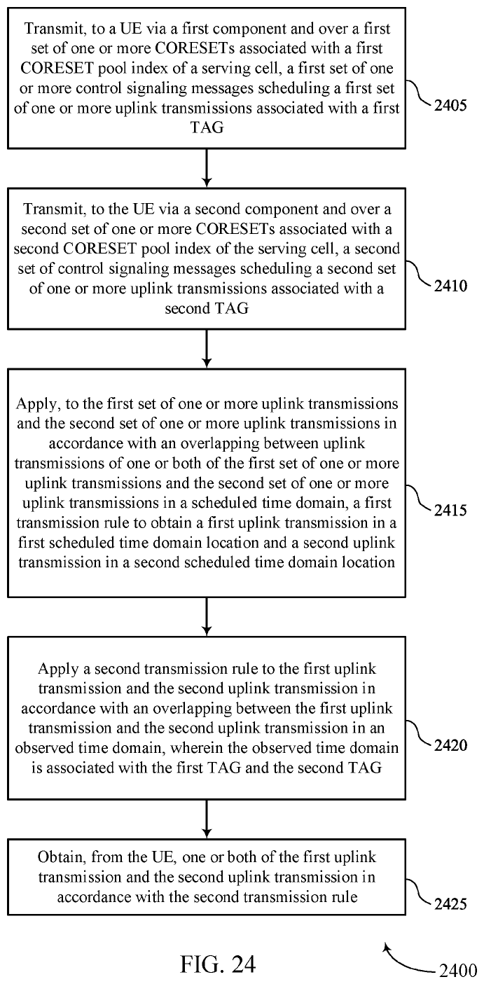

FIG. 24 shows a flowchart illustrating a method 2400 that supports techniques for handling overlapping uplink transmissions associated with different TAGs in accordance with one or more aspects of the present disclosure. The operations of the method 2400 may be implemented by a network entity or its components as described herein. For example, the operations of the method 2400 may be performed by a network entity as described with reference to FIGS. 1 through 12 and 17 through 20. In some examples, a network entity may execute a set of instructions to control the functional elements of the network entity to perform the described functions. Additionally, or alternatively, the network entity may perform aspects of the described functions using special-purpose hardware.

At 2405, the method may include transmitting, to a UE via a first component and over a first set of one or more CORESETs associated with a first CORESET pool index of a serving cell, a first set of one or more control signaling messages scheduling a first set of one or more uplink transmissions associated with a first TAG. The operations of 2405 may be performed in accordance with examples as disclosed herein. In some examples, aspects of the operations of 2405 may be performed by a control signaling component 1925 as described with reference to FIG. 19.

At 2410, the method may include transmitting, to the UE via a second component and over a second set of one or more CORESETs associated with a second CORESET pool index of the serving cell, a second set of one or more control signaling messages scheduling a second set of one or more uplink transmissions associated with a second TAG. The operations of 2410 may be performed in accordance with examples as disclosed herein. In some examples, aspects of the operations of 2410 may be performed by a control signaling component 1925 as described with reference to FIG. 19.

At 2415, the method may include applying, to the first set of one or more uplink transmissions and the second set of one or more uplink transmissions in accordance with an overlapping between uplink transmissions of one or both of the first set of one or more uplink transmissions and the second set of one or more uplink transmissions in a scheduled time domain, a first transmission rule to obtain a first uplink transmission in a first scheduled time domain location and a second uplink transmission in a second scheduled time domain location. The operations of 2415 may be performed in accordance with examples as disclosed herein. In some examples, aspects of the operations of 2415 may be performed by a first transmission rule component 1930 as described with reference to FIG. 19.

At 2420, the method may include applying a second transmission rule to the first uplink transmission and the second uplink transmission in accordance with an overlapping between the first uplink transmission and the second uplink transmission in an observed time domain, where the observed time domain is associated with the first TAG and the second TAG. The operations of 2420 may be performed in accordance with examples as disclosed herein. In some examples, aspects of the operations of 2420 may be performed by a second transmission rule component 1935 as described with reference to FIG. 19.

At 2425, the method may include obtaining, from the UE, one or both of the first uplink transmission and the second uplink transmission in accordance with the second transmission rule. The operations of 2425 may be performed in accordance with examples as disclosed herein. In some examples, aspects of the operations of 2425 may be performed by an uplink transmission component 1940 as described with reference to FIG. 19.

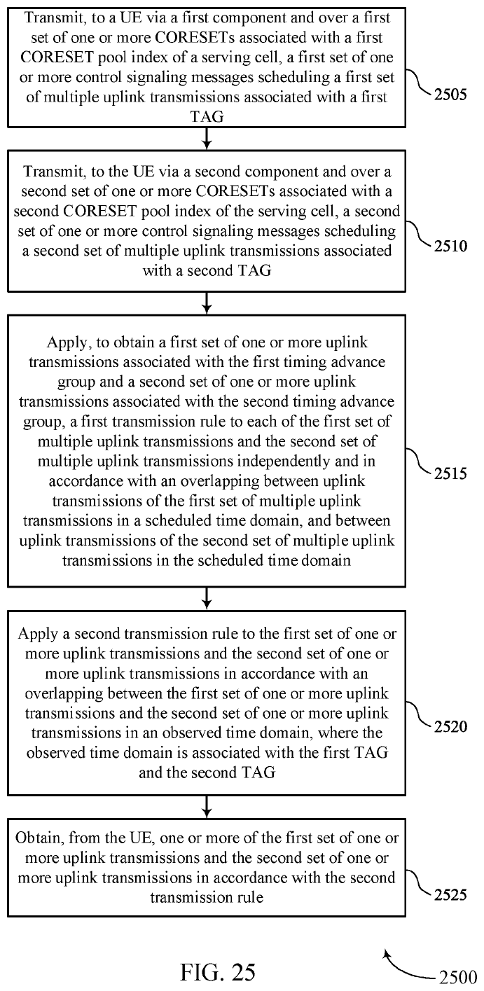

FIG. 25 shows a flowchart illustrating a method 2500 that supports techniques for handling overlapping uplink transmissions associated with different TAGs in accordance with one or more aspects of the present disclosure. The operations of the method 2500 may be implemented by a network entity or its components as described herein. For example, the operations of the method 2500 may be performed by a network entity as described with reference to FIGS. 1 through 12 and 17 through 20. In some examples, a network entity may execute a set of instructions to control the functional elements of the network entity to perform the described functions. Additionally, or alternatively, the network entity may perform aspects of the described functions using special-purpose hardware.

At 2505, the method may include transmitting, to a UE via a first component and over a first set of one or more CORESETs associated with a first CORESET pool index of a serving cell, a first set of one or more control signaling messages scheduling a first set of multiple uplink transmissions associated with a first TAG. The operations of 2505 may be performed in accordance with examples as disclosed herein. In some examples, aspects of the operations of 2505 may be performed by a control signaling component 1925 as described with reference to FIG. 19.

At 2510, the method may include transmitting, to the UE via a second component and over a second set of one or more CORESETs associated with a second CORESET pool index of the serving cell, a second set of one or more control signaling messages scheduling a second set of multiple uplink transmissions associated with a second TAG. The operations of 2510 may be performed in accordance with examples as disclosed herein. In some examples, aspects of the operations of 2510 may be performed by a control signaling component 1925 as described with reference to FIG. 19.

At 2515, the method may include applying, to obtain a first set of one or more uplink transmissions associated with the first TAG and a second set of one or more uplink transmissions associated with the second TAG, a first transmission rule to each of the first set of multiple uplink transmissions and the second set of multiple uplink transmissions independently and in accordance with an overlapping between uplink transmissions of the first set of multiple uplink transmissions in a scheduled time domain, and between uplink transmissions of the second set of multiple uplink transmissions in the scheduled time domain. The operations of 2515 may be performed in accordance with examples as disclosed herein. In some examples, aspects of the operations of 2515 may be performed by a first transmission rule component 1930 as described with reference to FIG. 19.

At 2520, the method may include applying a second transmission rule to the first set of one or more uplink transmissions and the second set of one or more uplink transmissions in accordance with an overlapping between the first set of one or more uplink transmissions and the second set of one or more uplink transmissions in an observed time domain, where the observed time domain is associated with the first TAG and the second TAG. The operations of 2520 may be performed in accordance with examples as disclosed herein. In some examples, aspects of the operations of 2520 may be performed by a second transmission rule component 1935 as described with reference to FIG. 19.

At 2525, the method may include obtaining, from the UE, one or more of the first set of one or more uplink transmissions and the second set of one or more uplink transmissions in accordance with the second transmission rule. The operations of 2525 may be performed in accordance with examples as disclosed herein. In some examples, aspects of the operations of 2525 may be performed by an uplink transmission component 1940 as described with reference to FIG. 19.

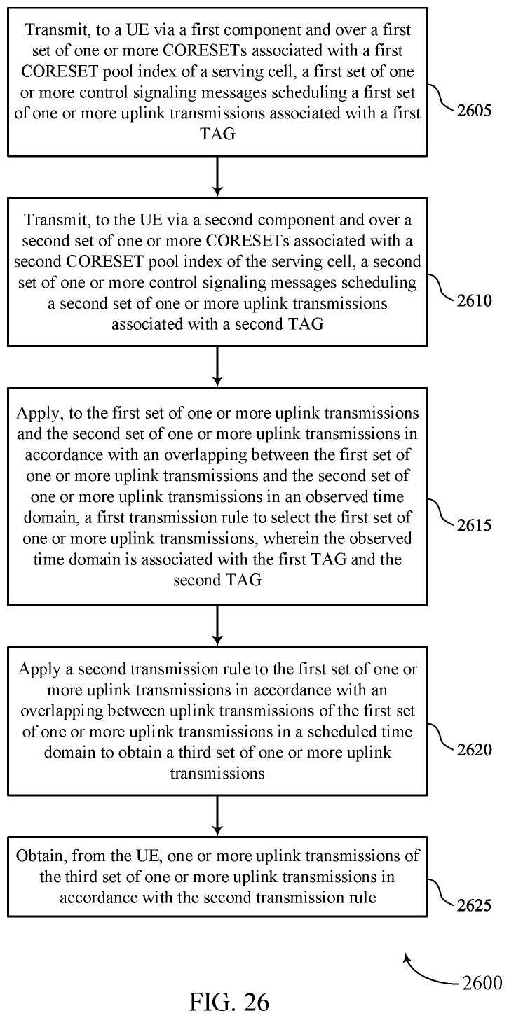

FIG. 26 shows a flowchart illustrating a method 2600 that supports techniques for handling overlapping uplink transmissions associated with different TAGs in accordance with one or more aspects of the present disclosure. The operations of the method 2600 may be implemented by a network entity or its components as described herein. For example, the operations of the method 2600 may be performed by a network entity as described with reference to FIGS. 1 through 12 and 17 through 20. In some examples, a network entity may execute a set of instructions to control the functional elements of the network entity to perform the described functions. Additionally, or alternatively, the network entity may perform aspects of the described functions using special-purpose hardware.

At 2605, the method may include transmitting, to a UE via a first component and over a first set of one or more CORESETs associated with a first CORESET pool index of a serving cell, a first set of one or more control signaling messages scheduling a first set of one or more uplink transmissions associated with a first TAG. The operations of 2605 may be performed in accordance with examples as disclosed herein. In some examples, aspects of the operations of 2605 may be performed by a control signaling component 1925 as described with reference to FIG. 19.

At 2610, the method may include transmitting, to the UE via a second component and over a second set of one or more CORESETs associated with a second CORESET pool index of the serving cell, a second set of one or more control signaling messages scheduling a second set of one or more uplink transmissions associated with a second TAG. The operations of 2610 may be performed in accordance with examples as disclosed herein. In some examples, aspects of the operations of 2610 may be performed by a control signaling component 1925 as described with reference to FIG. 19.

At 2615, the method may include applying, to the first set of one or more uplink transmissions and the second set of one or more uplink transmissions in accordance with an overlapping between the first set of one or more uplink transmissions and the second set of one or more uplink transmissions in an observed time domain, a first transmission rule to select the first set of one or more uplink transmissions, where the observed time domain is associated with the first TAG and the second TAG. The operations of 2615 may be performed in accordance with examples as disclosed herein. In some examples, aspects of the operations of 2615 may be performed by a first transmission rule component 1930 as described with reference to FIG. 19.

At 2620, the method may include applying a second transmission rule to the first set of one or more uplink transmissions in accordance with an overlapping between uplink transmissions of the first set of one or more uplink transmissions in a scheduled time domain to obtain a third set of one or more uplink transmissions. The operations of 2620 may be performed in accordance with examples as disclosed herein. In some examples, aspects of the operations of 2620 may be performed by a second transmission rule component 1935 as described with reference to FIG. 19.

At 2625, the method may include obtaining, from the UE, one or more uplink transmissions of the third set of one or more uplink transmissions in accordance with the second transmission rule. The operations of 2625 may be performed in accordance with examples as disclosed herein. In some examples, aspects of the operations of 2625 may be performed by an uplink transmission component 1940 as described with reference to FIG. 19.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1-98. (canceled)

99. A method for wireless communication at a user equipment (UE), comprising:
receiving, over a first set of one or more control resource sets associated with a first control resource set pool index of a serving cell, a first set of one or more control signaling messages scheduling a first set of one or more uplink transmissions associated with a first timing advance group;
receiving, over a second set of one or more control resource sets associated with a second control resource set pool index of the serving cell, a second set of one or more control signaling messages scheduling a second set of one or more uplink transmissions associated with a second timing advance group;
applying, to the first set of one or more uplink transmissions and the second set of one or more uplink transmissions in accordance with an overlapping between uplink transmissions of one or both of the first set of one or more uplink transmissions and the second set of one or more uplink transmissions in a scheduled time domain, a first transmission rule to obtain a first uplink transmission in a first scheduled time domain location and a second uplink transmission in a second scheduled time domain location;
applying a second transmission rule to the first uplink transmission and the second uplink transmission in accordance with an overlapping between the first uplink transmission and the second uplink transmission in an observed time domain, wherein the observed time domain is associated with the first timing advance group and the second timing advance group; and
performing one or both of the first uplink transmission and the second uplink transmission in accordance with the second transmission rule.

100. The method of claim 99, wherein applying the second transmission rule to the first uplink transmission and the second uplink transmission comprises:
selecting one or both of the first uplink transmission and the second uplink transmission based at least in part on a satisfaction of a condition associated with a capability of the UE.

101. The method of claim 100, wherein the satisfaction of the condition is based at least in part on the first uplink transmission and the second uplink transmission being scheduled for simultaneous transmission by the UE and the capability of the UE supporting multi-panel uplink transmission.

102. The method of claim 100, wherein the satisfaction of the condition is based at least in part on the capability of the UE supporting simultaneous uplink transmission or supporting both multi-panel uplink transmission and simultaneous uplink transmission.

103. The method of claim 100, wherein the satisfaction of the condition is based at least in part on the first uplink transmission and the second uplink transmission being scheduled for simultaneous transmission by the UE, the capability of the UE for supporting multi-panel uplink transmission, and the first uplink transmission and the second uplink transmission being associated with a same channel type.

104. The method of claim 99, wherein the UE selects to perform one of the first uplink transmission and the second uplink transmission based at least in part on failing to satisfy a condition associated with a capability of the UE, and wherein performing one or both of the first uplink transmission and the second uplink transmission comprises:
performing the first uplink transmission based at least in part on the first uplink transmission being scheduled in a first symbol or slot in the observed time domain; and
performing a portion of the second uplink transmission that does not overlap with the first uplink transmission in the observed time domain based at least in part on the second uplink transmission being scheduled in a second symbol or slot in the observed time domain, wherein the first symbol or slot is earlier than the second symbol or slot.

105. The method of claim 99, wherein the UE selects to perform one of the first uplink transmission and the second uplink transmission based at least in part on failing to satisfy a condition associated with a capability of the UE, and wherein performing one or both of the first uplink transmission and the second uplink transmission comprises:
performing the first uplink transmission based at least in part on the first uplink transmission being scheduled in a first symbol or slot in the observed time domain; and
dropping the second uplink transmission based at least in part on the second uplink transmission being scheduled in a second symbol or slot in the observed time domain, wherein the first symbol or slot is earlier than the second symbol or slot.

106. The method of claim 99, further comprising:
selecting one or both of the first uplink transmission and the second uplink transmission in accordance with a slot format, wherein performing one or both of the first uplink transmission and the second uplink transmission is based at least in part on selecting one or both of the first uplink transmission and the second uplink transmission in accordance with the slot format.

107. The method of claim 99, wherein applying the first transmission rule to obtain the first uplink transmission in the first scheduled time domain location and the second uplink transmission in the second scheduled time domain location comprises:
multiplexing or dropping one or more first uplink transmissions of one or both of the first set of one or more uplink transmissions and the second set of one or more uplink transmissions that overlap in the first scheduled time domain location to obtain the first uplink transmission; and
multiplexing or dropping one or more second uplink transmissions of one or both of the first set of one or more uplink transmissions and the second set of one or more uplink transmissions that overlap in the second scheduled time domain location to obtain the second uplink transmission.

108. The method of claim 107, wherein:
dropping the one or more first uplink transmissions that overlap in the first scheduled time domain location or the one or more second uplink transmissions that overlap in the second scheduled time domain location is based at least in part on an error case; and
the error case is associated with the overlapping between the uplink transmissions of at least one of the first set of one or more uplink transmissions and at least one of the second set of one or more uplink transmissions in the scheduled time domain.

109. The method of claim 99, wherein applying the first transmission rule to obtain the first uplink transmission in the first scheduled time domain location and the second uplink transmission in the second scheduled time domain location comprises a first stage and a second stage, and wherein the first stage comprises:
multiplexing or dropping one or more uplink transmissions of the first set of one or more uplink transmissions that overlap in the scheduled time domain to obtain one or both of a first intermediate uplink transmission in the first scheduled time domain location or a second intermediate uplink transmission in the second scheduled time domain location; and
multiplexing or dropping one or more uplink transmissions of the second set of one or more uplink transmissions that overlap in the scheduled time domain to obtain one or both of a third intermediate uplink transmission in the first scheduled time domain location or a fourth intermediate uplink transmission in the second scheduled time domain location.

110. A method for wireless communications at a network entity, comprising:
transmitting, to a user equipment (UE) via a first component and over a first set of one or more control resource sets associated with a first control resource set pool index of a serving cell, a first set of one or more control signaling messages scheduling a first set of one or more uplink transmissions associated with a first timing advance group;
transmitting, to the UE via a second component and over a second set of one or more control resource sets associated with a second control resource set pool index of the serving cell, a second set of one or more control signaling messages scheduling a second set of one or more uplink transmissions associated with a second timing advance group;
applying, to the first set of one or more uplink transmissions and the second set of one or more uplink transmissions in accordance with an overlapping between uplink transmissions of one or both of the first set of one or more uplink transmissions and the second set of one or more uplink transmissions in a scheduled time domain, a first transmission rule to obtain a first uplink transmission in a first scheduled time domain location and a second uplink transmission in a second scheduled time domain location;
applying a second transmission rule to the first uplink transmission and the second uplink transmission in accordance with an overlapping between the first uplink transmission and the second uplink transmission in an observed time domain, wherein the observed time domain is associated with the first timing advance group and the second timing advance group; and
obtaining, from the UE, one or both of the first uplink transmission and the second uplink transmission in accordance with the second transmission rule.

111. The method of claim 110, wherein applying the second transmission rule to the first uplink transmission and the second uplink transmission comprises:
selecting one or both of the first uplink transmission and the second uplink transmission based at least in part on a satisfaction of a condition associated with a capability of the UE.

112. The method of claim 111, wherein the satisfaction of the condition is based at least in part on the first uplink transmission and the second uplink transmission being scheduled for simultaneous transmission by the UE and the capability of the UE for supporting multi-panel uplink transmission.

113. The method of claim 110, wherein the network entity selects to obtain one of the first uplink transmission and the second uplink transmission based at least in part on failing to satisfy a condition associated with a capability of the UE, and wherein obtaining one or both of the first uplink transmission and the second uplink transmission comprises:
obtaining the first uplink transmission based at least in part on the first uplink transmission being scheduled in a first symbol or slot in the observed time domain; and
obtaining a portion of the second uplink transmission that does not overlap with the first uplink transmission in the observed time domain based at least in part on the second uplink transmission being scheduled in a second symbol or slot in the observed time domain, wherein the first symbol or slot is earlier than the second symbol or slot.

114. The method of claim 110, further comprising:
selecting one or both of the first uplink transmission and the second uplink transmission in accordance with a slot format, wherein obtaining one or both of the first uplink transmission and the second uplink transmission is based at least in part on selecting one or both of the first uplink transmission and the second uplink transmission in accordance with the slot format.

115. An apparatus for wireless communication at a user equipment (UE), comprising:
one or more processors; and
one or more memories coupled with the one or more processors and storing instructions executable by the one or more processors to cause the apparatus to:
receive, over a first set of one or more control resource sets associated with a first control resource set pool index of a serving cell, a first set of one or more control signaling messages scheduling a first set of one or more uplink transmissions associated with a first timing advance group;
receive, over a second set of one or more control resource sets associated with a second control resource set pool index of the serving cell, a second set of one or more control signaling messages scheduling a second set of one or more uplink transmissions associated with a second timing advance group;
apply, to the first set of one or more uplink transmissions and the second set of one or more uplink transmissions in accordance with an overlapping between uplink transmissions of one or both of the first set of one or more uplink transmissions and the second set of one or more uplink transmissions in a scheduled time domain, a first transmission rule to obtain a first uplink transmission in a first scheduled time domain location and a second uplink transmission in a second scheduled time domain location;
apply a second transmission rule to the first uplink transmission and the second uplink transmission in accordance with an overlapping between the first uplink transmission and the second uplink transmission in an observed time domain, wherein the observed time domain is associated with the first timing advance group and the second timing advance group; and
perform one or both of the first uplink transmission and the second uplink transmission in accordance with the second transmission rule.

116. The apparatus of claim 115, wherein, to apply the second transmission rule to the first uplink transmission and the second uplink transmission, the instructions are executable by the one or more processors to cause the apparatus to:
select one or both of the first uplink transmission and the second uplink transmission based at least in part on a satisfaction of a condition associated with a capability of the UE.

117. The apparatus of claim 116, wherein the satisfaction of the condition is based at least in part on the first uplink transmission and the second uplink transmission being scheduled for simultaneous transmission by the UE and the capability of the UE supporting multi-panel uplink transmission.

118. The apparatus of claim 116, wherein the satisfaction of the condition is based at least in part on the capability of the UE supporting simultaneous uplink transmission or supporting both multi-panel uplink transmission and simultaneous uplink transmission.

119. The apparatus of claim 116, wherein the satisfaction of the condition is based at least in part on the first uplink transmission and the second uplink transmission being scheduled for simultaneous transmission by the UE, the capability of the UE for supporting multi-panel uplink transmission, and the first uplink transmission and the second uplink transmission being associated with a same channel type.

120. The apparatus of claim 115, wherein the apparatus selects to perform one of the first uplink transmission and the second uplink transmission based at least in part on failing to satisfy a condition associated with a capability of the UE, and wherein, to perform one or both of the first uplink transmission and the second uplink transmission, the instructions are executable by the one or more processors to cause the apparatus to:
perform the first uplink transmission based at least in part on the first uplink transmission being scheduled in a first symbol or slot in the observed time domain; and
perform a portion of the second uplink transmission that does not overlap with the first uplink transmission in the observed time domain based at least in part on the second uplink transmission being scheduled in a second symbol or slot in the observed time domain, wherein the first symbol or slot is earlier than the second symbol or slot.

121. The apparatus of claim 115, wherein the apparatus selects to perform one of the first uplink transmission and the second uplink transmission based at least in part on failing to satisfy a condition associated with a capability of the UE, and wherein, to perform one or both of the first uplink transmission and the second uplink transmission, the instructions are executable by the one or more processors to cause the apparatus to:
perform the first uplink transmission based at least in part on the first uplink transmission being scheduled in a first symbol or slot in the observed time domain; and
drop the second uplink transmission based at least in part on the second uplink transmission being scheduled in a second symbol or slot in the observed time domain, wherein the first symbol or slot is earlier than the second symbol or slot.

122. The apparatus of claim 115, wherein the instructions are executable by the one or more processors to cause the apparatus to:
select one or both of the first uplink transmission and the second uplink transmission in accordance with a slot format, wherein the instructions to perform one or both of the first uplink transmission and the second uplink transmission is based at least in part on the instructions to select one or both of the first uplink transmission and the second uplink transmission in accordance with the slot format.

123. The apparatus of claim 115, wherein, to apply the first transmission rule to obtain the first uplink transmission in the first scheduled time domain location and the second uplink transmission in the second scheduled time domain location, the instructions are executable by the one or more processors to cause the apparatus to:
multiplex or drop one or more first uplink transmissions of one or both of the first set of one or more uplink transmissions and the second set of one or more uplink transmissions that overlap in the first scheduled time domain location to obtain the first uplink transmission; and
multiplex or drop one or more second uplink transmissions of one or both of the first set of one or more uplink transmissions and the second set of one or more uplink transmissions that overlap in the second scheduled time domain location to obtain the second uplink transmission.

124. An apparatus for wireless communications at a network entity, comprising:
one or more processors; and
one or more memories coupled with the one or more processors and storing instructions executable by the one or more processors to cause the apparatus to:
transmit, to a user equipment (UE) via a first component and over a first set of one or more control resource sets associated with a first control resource set pool index of a serving cell, a first set of one or more control signaling messages scheduling a first set of one or more uplink transmissions associated with a first timing advance group;
transmit, to the UE via a second component and over a second set of one or more control resource sets associated with a second control resource set pool index of the serving cell, a second set of one or more control signaling messages scheduling a second set of one or more uplink transmissions associated with a second timing advance group;
apply, to the first set of one or more uplink transmissions and the second set of one or more uplink transmissions in accordance with an overlapping between uplink transmissions of one or both of the first set of one or more uplink transmissions and the second set of one or more uplink transmissions in a scheduled time domain, a first transmission rule to obtain a first uplink transmission in a first scheduled time domain location and a second uplink transmission in a second scheduled time domain location;
apply a second transmission rule to the first uplink transmission and the second uplink transmission in accordance with an overlapping between the first uplink transmission and the second uplink transmission in an observed time domain, wherein the observed time domain is associated with the first timing advance group and the second timing advance group; and
obtain, from the UE, one or both of the first uplink transmission and the second uplink transmission in accordance with the second transmission rule.

125. The apparatus of claim 124, wherein, to apply the second transmission rule to the first uplink transmission and the second uplink transmission, the instructions are executable by the one or more processors to cause the apparatus to:
select one or both of the first uplink transmission and the second uplink transmission based at least in part on a satisfaction of a condition associated with a capability of the UE.

126. The apparatus of claim 125, wherein the satisfaction of the condition is based at least in part on the first uplink transmission and the second uplink transmission being scheduled for simultaneous transmission by the UE and the capability of the UE for supporting multi-panel uplink transmission.

127. The apparatus of claim 124, wherein the apparatus selects to obtain one of the first uplink transmission and the second uplink transmission based at least in part on failing to satisfy a condition associated with a capability of the UE, and wherein, to obtain one or both of the first uplink transmission and the second uplink transmission, the instructions are executable by the one or more processors to cause the apparatus to:
obtain the first uplink transmission based at least in part on the first uplink transmission being scheduled in a first symbol or slot in the observed time domain; and
obtain a portion of the second uplink transmission that does not overlap with the first uplink transmission in the observed time domain based at least in part on the second uplink transmission being scheduled in a second symbol or slot in the observed time domain, wherein the first symbol or slot is earlier than the second symbol or slot.

128. The apparatus of claim 124, wherein the apparatus selects to obtain one of the first uplink transmission and the second uplink transmission based at least in part on failing to satisfy a condition associated with a capability of the UE, and wherein, to obtain one or both of the first uplink transmission and the second uplink transmission, the instructions are executable by the one or more processors to cause the apparatus to:
obtain the first uplink transmission based at least in part on the first uplink transmission being scheduled in a first symbol or slot in the observed time domain; and
identify the second uplink transmission as dropped based at least in part on the second uplink transmission being scheduled in a second symbol or slot in the observed time domain, wherein the first symbol or slot is earlier than the second symbol or slot.
